(19) United States
(12) Patent Application Publication
(10) Pub. No.: US 2025/0280222 A1
(43) Pub. Date: Sep. 4, 2025

(54) Devices, Methods, and Graphical User Interfaces for Interacting with Audio Output Device Cases

(71) Applicant: Apple Inc., Cupertino, CA (US)

(72) Inventors: Taylor G. Carrigan, San Francisco, CA (US); Hugo D. Verweij, Portola Valley, CA (US); Mitchell R. Lerner, San Francisco, CA (US); Charles C. Hoyt, Pacifica, CA (US); Pavel Pivonka, San Francisco, CA (US)

(21) Appl. No.: 19/065,881

(22) Filed: Feb. 27, 2025

Related U.S. Application Data
(60) Provisional application No. 63/656,033, filed on Jun. 4, 2024.
(60) Provisional application No. 63/561,098, filed on Mar. 4, 2024.

(51) Int. Cl. H04R 1/10

(52) U.S. Cl. CPC H04R 1/1041; H04R 1/1025

(57) ABSTRACT

A computer system detects one or more inputs at an accessory case that is in communication with one or more accessories, where the one or more inputs are detected via one or more movement sensors. In response to detecting the one or more inputs via the one or more movement sensors, the computer system causes a respective operation associated with the one or more accessories and/or the accessory case to be performed in accordance with a determination that the one or more inputs are a first type of input. In response to detecting the one or more inputs via the one or more movement sensors, the computer system forgoes causing the respective operation to be performed in accordance with a determination that the one or more inputs are not the first type of input.

### RELATED APPLICATIONS

This application claims priority to U.S. Provisional Patent Application No. 63/656,033, filed Jun. 4, 2024, and U.S. Provisional Patent Application No. 63/561,098, filed Mar. 4, 2024, each of which is hereby incorporated by reference in its entirety.

### TECHNICAL FIELD

This relates generally to electronic accessories such as wearable audio output devices, audio output device cases, and accessory charging cases, including but not limited to detecting and recommending maintenance for the wearable audio output devices and to audio output device cases (or wearable audio output devices) with movement sensors that detect inputs/gestures.

### BACKGROUND

Cases for electronic accessories, including wearable audio output devices (such as headphones, earbuds, and earphones), watches, and styluses, have typically been exclusively configured to charge and store the accessories. Some accessory cases include physical buttons for operations such as volume and/or playback control. But conventional methods of controlling and interacting with such devices are cumbersome, inefficient, and limited. Specifically, such methods may take longer and require more user interaction to operate the electronic accessories, thereby wasting energy. This latter consideration is particularly important in battery operated devices.

In addition, wearable devices typically require occasional user maintenance so that the wearable devices are operating in an optimal configuration. For example, users may need to clean earwax or other debris from the wearable devices. The earwax or other debris may negatively impact the operation of the wearable devices, e.g., by reducing the audio volume or audio quality. Conventional maintenance notifications are either not provided, or are based on a predefined time interval. As a result, conventional recommendations may be provided when there is no need to clean/maintain the wearable device, or are not provided in a timely manner when maintenance is required (and instead are only provided once the predefined time interval is met). As such, conventional methods do not accurately and efficiently alert the user when maintenance is required, thereby either causing unnecessary user action, or poor performance because the device has not been properly maintained.

### SUMMARY

Accordingly, there is a need for electronic accessories (e.g., wearable audio output devices and electronic accessory cases) with improved methods and interfaces for controlling and interacting with, such as detecting battery levels, pairing devices, resetting devices, and providing feedback to aid a user in operating such devices. Such methods and interfaces optionally complement or replace conventional methods for controlling operation of electronic accessories. Such methods and interfaces reduce the number, extent, and/or nature of the inputs from a user and produce a more efficient human-machine interface. For battery-operated systems and devices, such methods and interfaces conserve power and increase the time between battery charges.

The above deficiencies and other problems associated with user interfaces for electronic devices and accessories are reduced or eliminated by the disclosed computer systems and electronic accessories. In some embodiments, the computer system includes a desktop computer. In some embodiments, the computer system is portable (e.g., a notebook computer, tablet computer, or handheld device). In some embodiments, the computer system includes a personal electronic device (e.g., a wearable electronic device, such as a watch). In some embodiments, the computer system includes (and/or is in communication with) the wearable audio output devices (e.g., in-ear earphones, earbuds, over-ear headphones, etc.). In some embodiments, the computer system has (and/or is in communication with) a touch-sensitive surface (also known as a “touchpad”). In some embodiments, the computer system has (and/or is in communication with) a display device, which in some embodiments is a touch-sensitive display (also known as a “touch screen” or “touch-screen display”). In some embodiments, the computer system has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, audio output device pairing and calibration, digital music/audio playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system (e.g., an accessory case, one or more accessories that are in communication with the accessory case, and/or at a device that is configured to receive audio from the one or more accessories). The method includes detecting one or more inputs at an accessory case that is in communication with one or more accessories, where the one or more inputs are detected via one or more movement sensors (e.g., one or more inertial measurement units (IMUs), accelerometers and/or other sensors that detect movement of one or more devices in space) (e.g., one or more movement sensors in the accessory case and/or one or more movement sensors in one or more of the accessories). The method also includes, in response to detecting the one or more inputs via the one or more movement sensors: in accordance with a determination that the one or more inputs are a first type of input, causing a respective operation associated with the one or more accessories and/or the accessory case to be performed in response to detecting the one or more inputs; and, in accordance with a determination that the one or more inputs are not the first type of input, forgoing causing the respective operation to be performed in response to detecting the one or more inputs.

In accordance with some embodiments, a method is at a computer system that is associated with a set of components (e.g., one or more optical or audio output modules) of one or more wearable devices (e.g., a set of earbuds, a set of earcups of a pair of headphones, or a set of optical modules of a head mounted display). The method includes detecting an operational state of a respective component (e.g., an operation state that changes based on a state of physical maintenance of a portion of the respective device) of the set of components. The method further includes, in response to detecting the operational state of the respective component: in accordance with a determination that the operational state of a first component meets one or more criteria without a determination that the operational state of a second component meets the one or more criteria, generating an alert with an indication that maintenance is recommended for the first component without generating an alert with an indication that maintenance is recommended for a second component; and, in accordance with a determination that the operational state of the second component meets the one or more criteria without a determination that the operational state of the first component meets the one or more criteria, generating the alert with an indication that maintenance is recommended for the second component without generating an alert with an indication that maintenance is recommended for the first component.

In accordance with some embodiments, an electronic device (e.g., a multifunction device, an electronic accessory, electronic accessory case (e.g., an audio output device case), or other type of electronic device) includes one or more processors, and memory storing one or more programs; the one or more programs are configured to be executed by the one or more processors and the one or more programs include instructions for performing or causing performance of the operations of any of the methods described herein.

In accordance with some embodiments, a computer readable storage medium has stored therein instructions that, when executed by an electronic device cause the device to perform or cause performance of the operations of any of the methods described herein. In accordance with some embodiments, a graphical user interface on an electronic device with a display, a touch-sensitive surface, a memory, and one or more processors to execute one or more programs stored in the memory includes one or more of the elements displayed in any of the methods described herein, which are updated in response to inputs, as described in any of the methods described herein. In accordance with some embodiments, an electronic device includes means for performing or causing performance of the operations of any of the methods described herein. In accordance with some embodiments, an information processing apparatus, for use in an electronic device includes means for performing or causing performance of the operations of any of the methods described herein.

Thus, electronic devices that include or are in communication with one or more electronic accessories (e.g., wearable audio output devices, electronic accessory cases, and/or other types of electronic accessories) are provided with improved methods and interfaces for controlling operation of the electronic accessories, thereby increasing the effectiveness, efficiency, and user satisfaction with such devices. Such methods and interfaces may complement or replace conventional methods for controlling operation of electronic accessories.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 3H illustrates physical features of an example wearable audio output device in accordance with some embodiments.

FIG. 3I is a block diagram of an example wearable audio output device in accordance with some embodiments.

FIG. 3J illustrates physical features of an example electronic accessory case in accordance with some embodiments.

FIG. 3K is a block diagram of an example electronic accessory case in accordance with some embodiments.

FIG. 3L illustrates example audio control by a wearable audio output device in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5O illustrate example user interfaces and user interactions involving one or more accessories and one or more accessory cases to perform one or more operations in accordance with some embodiments.

FIGS. 6A-6M illustrate example user interfaces and user interactions for recommended maintenance of one or more wearable devices in accordance with some embodiments.

FIGS. 7A-7E illustrate example user interfaces and user interactions for recommended maintenance of one or more wearable devices in accordance with some embodiments.

FIGS. 8A-8C are flow diagrams of a process for interacting with an accessory case to perform one or more operations in accordance with some embodiments.

FIGS. 9A-9B are flow diagrams of a process of a process of providing maintenance recommendations for one or more wearable devices in accordance with some embodiments.

### DESCRIPTION OF EMBODIMENTS

As also noted above, electronic accessory cases (such as for wearable audio output devices) are commonly passive devices used to store and/or charge electronic accessories. Electronic accessory cases do not traditionally include sensors for detecting user inputs on the housing of the accessory cases. Furthermore, electronic accessory cases do not traditionally include means for performing operations responsive to detecting the user inputs. While some electronic accessory cases include physical buttons, electronic accessory cases traditionally do not include means of detecting inputs without physical buttons (e.g., inputs at arbitrary locations on the housing of the electronic accessory cases). Additionally, electronic accessories (e.g., wearable audio output devices) traditionally do not include sensors for detecting an operational state (e.g., whether maintenance is recommended/required) of the electronic accessories. Furthermore, the electronic accessories do not traditionally include means for providing alerts responsive to detecting the operational state. The methods, systems, and user interfaces described herein improve the functionality of electronic accessory cases and electronic accessories. For example, embodiments disclosed herein describe improved ways of interacting with the electronic accessory cases and electronic accessories and providing status information and/or feedback to a user at the electronic accessory case, the electronic accessories, or a companion device.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

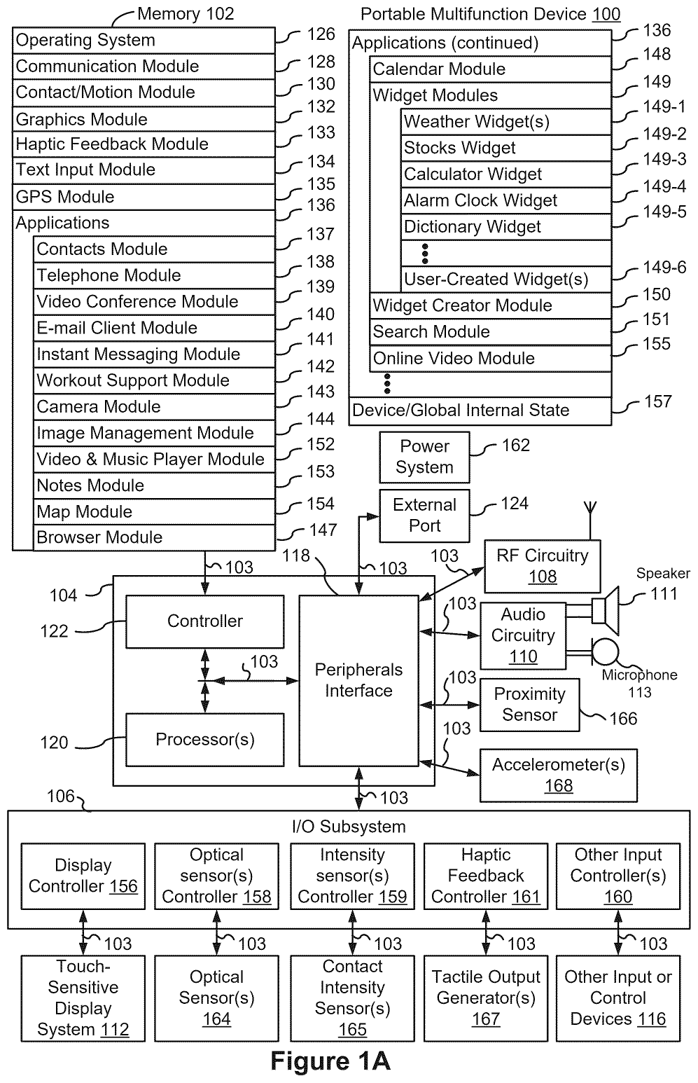

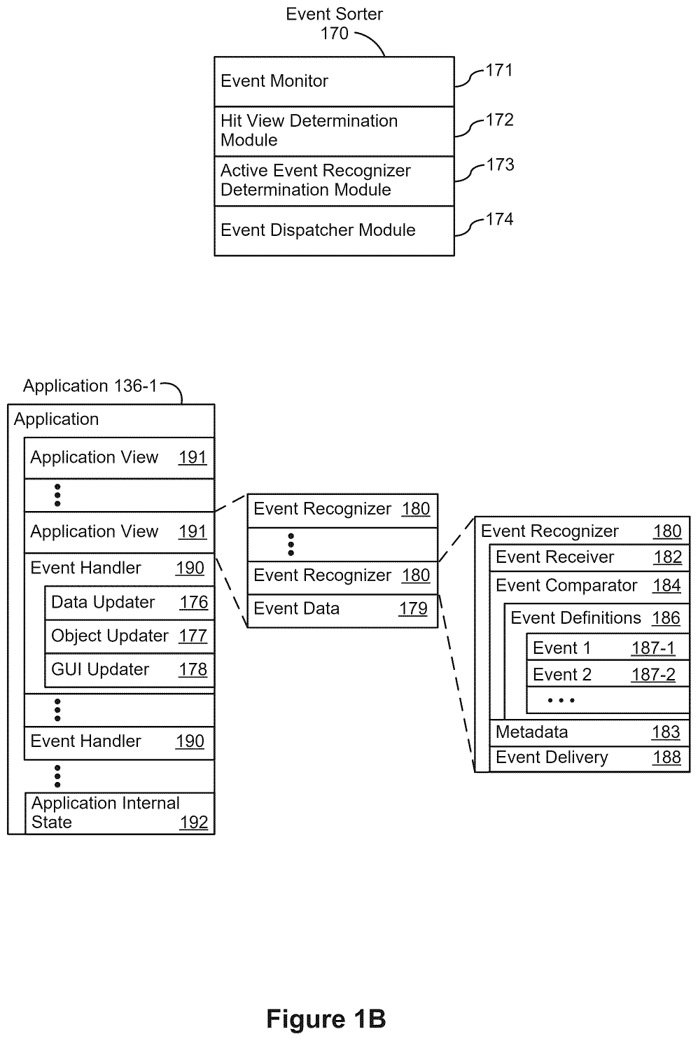

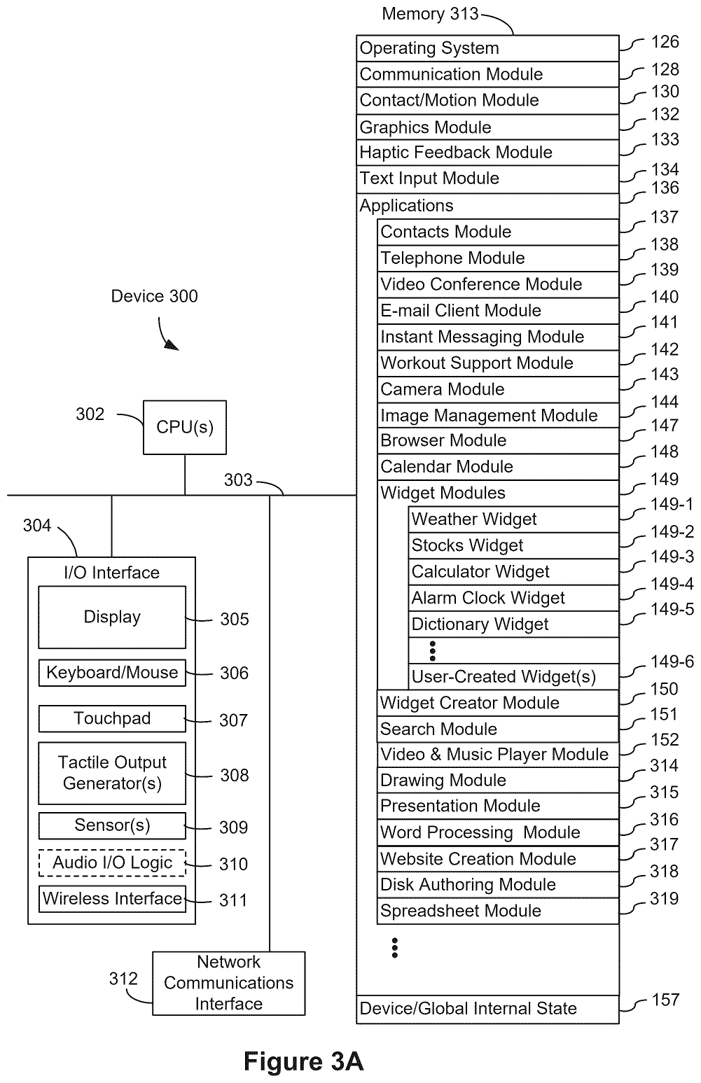

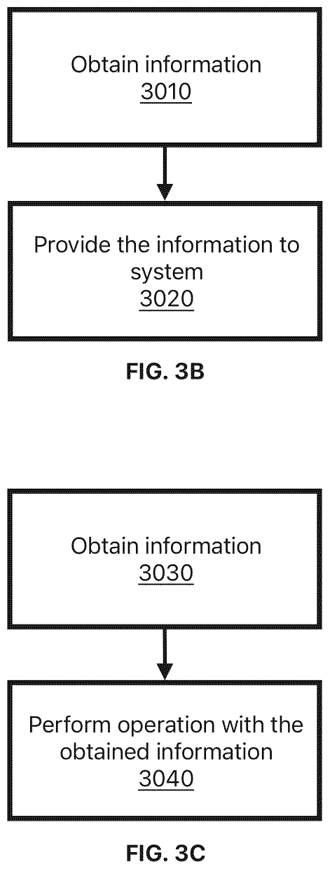

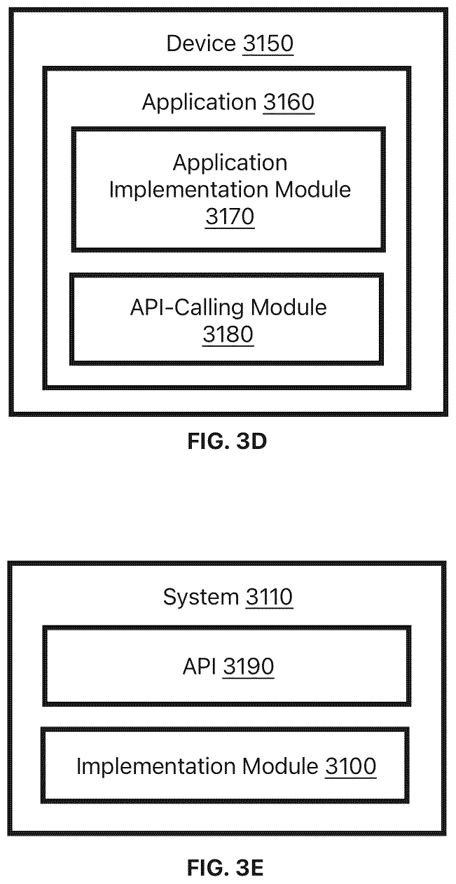

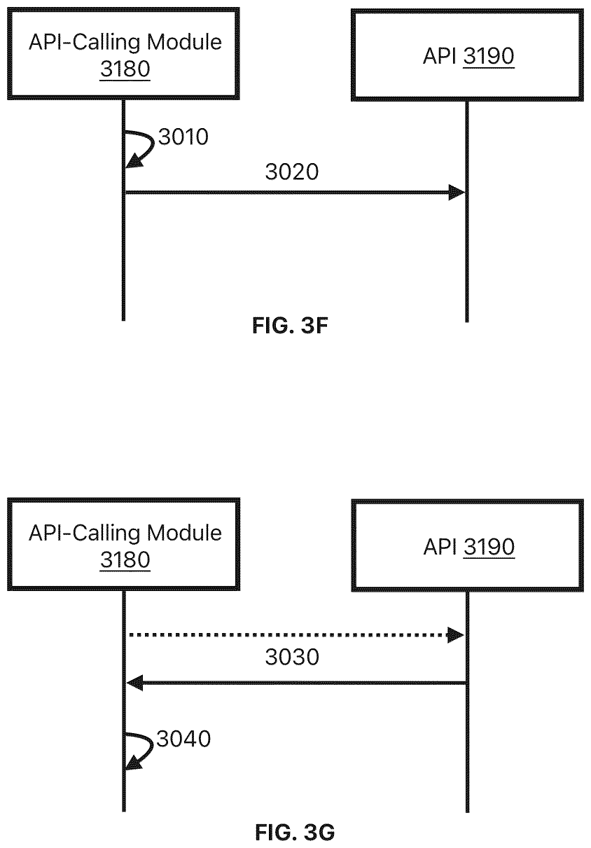

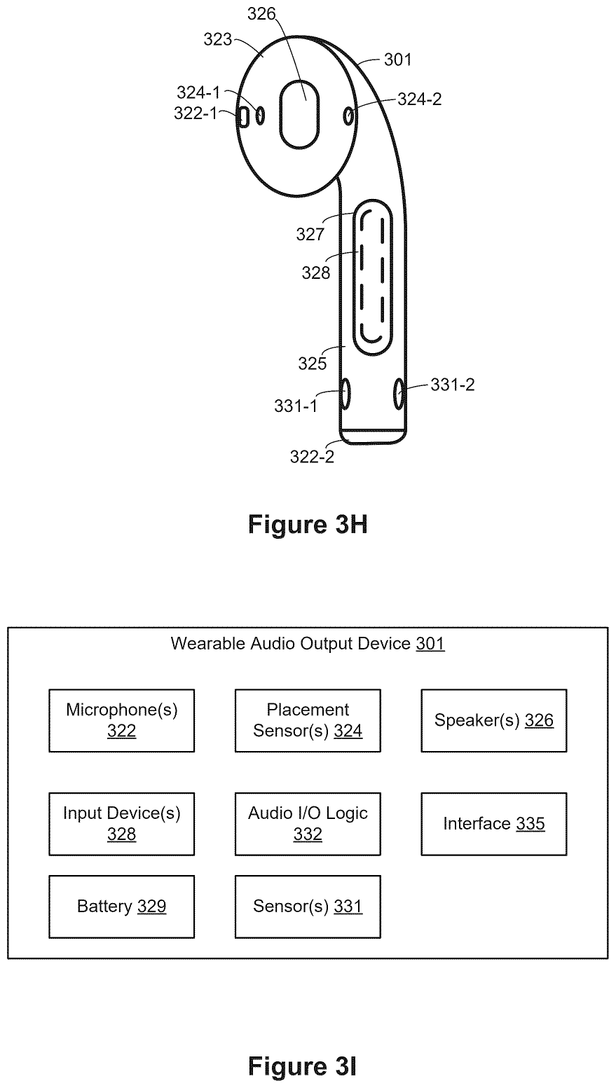

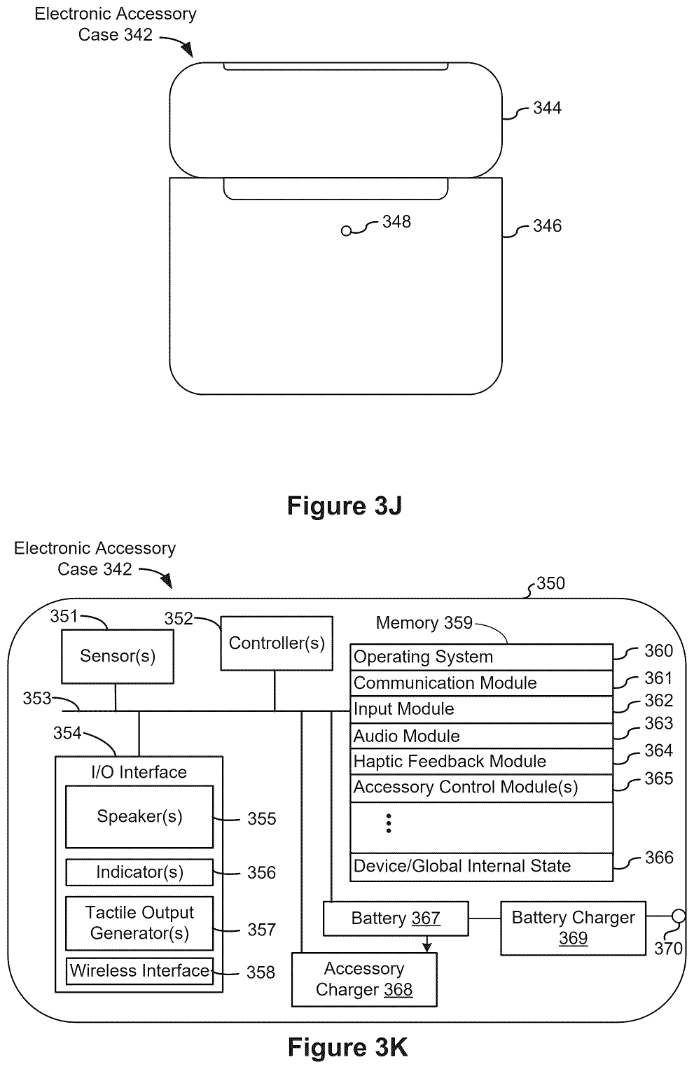

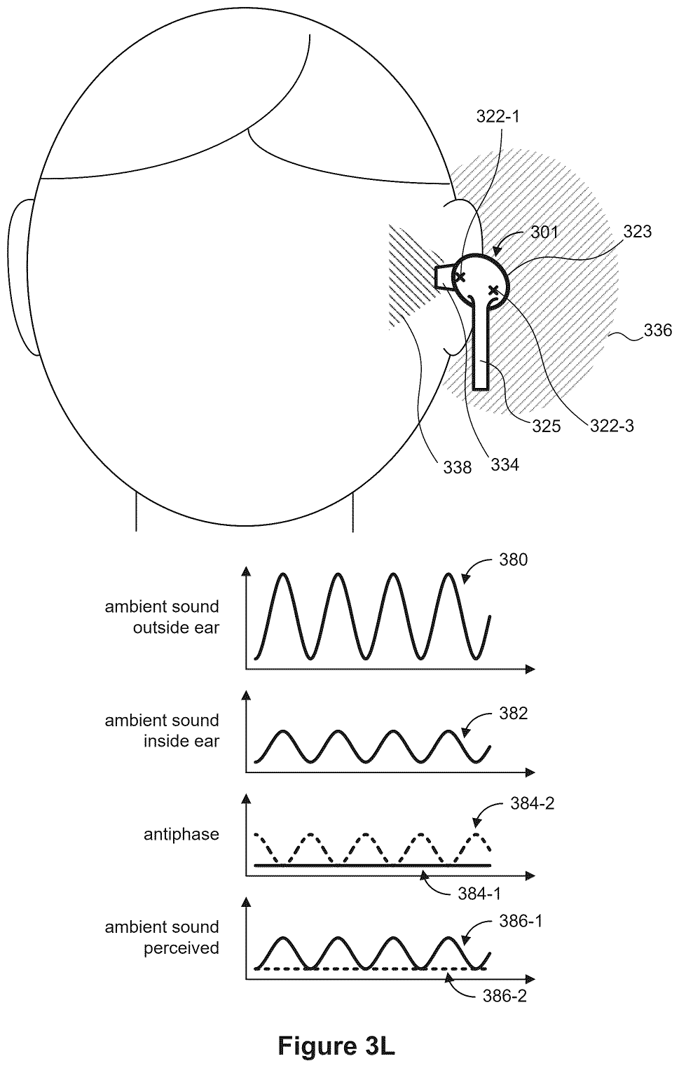

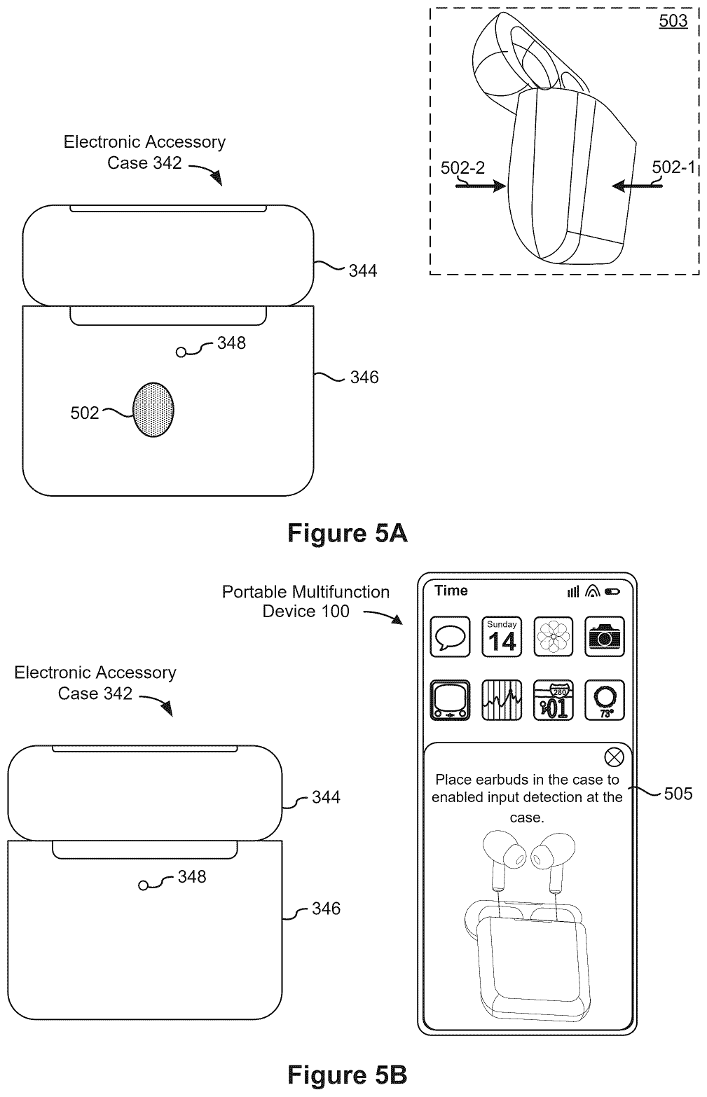

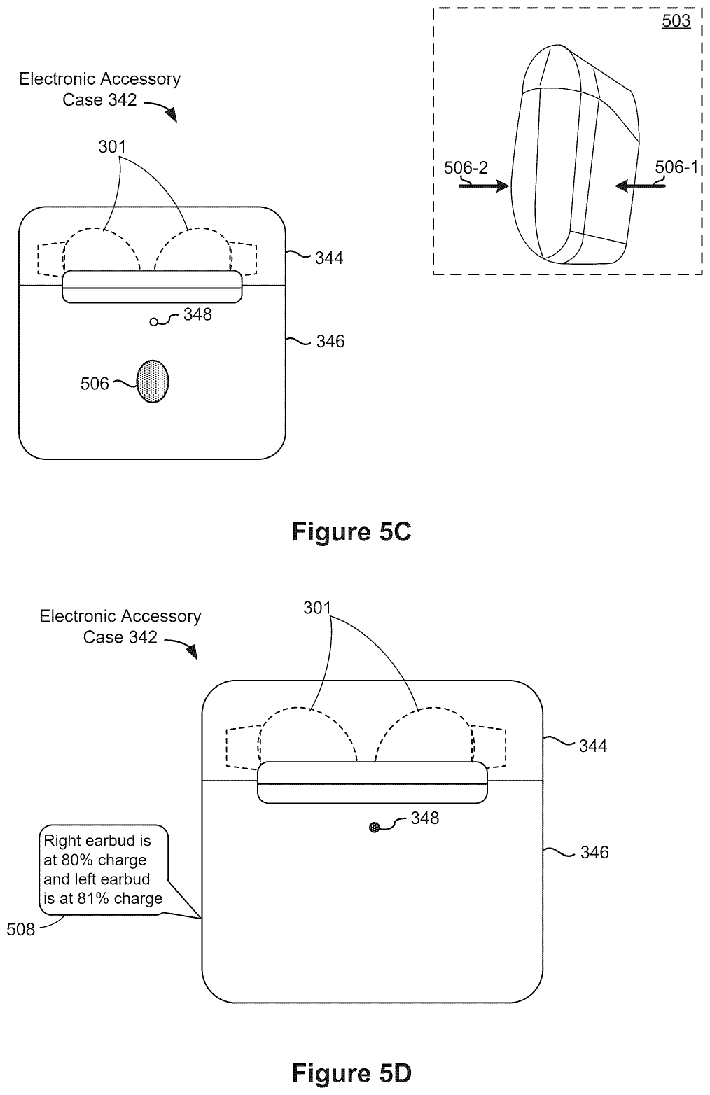

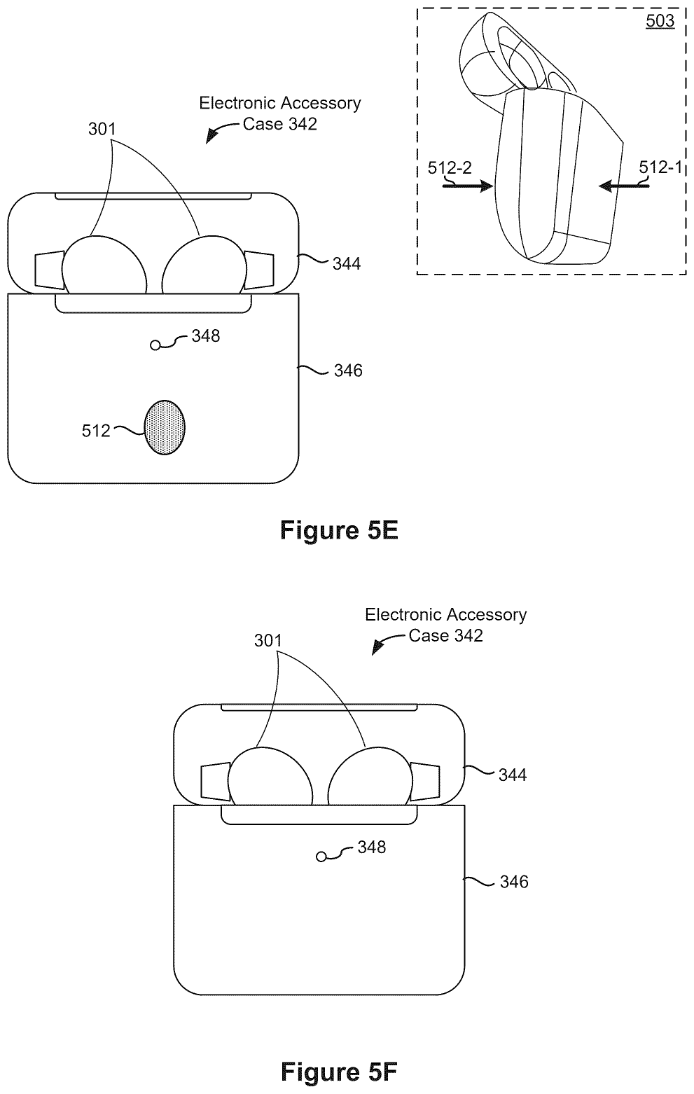

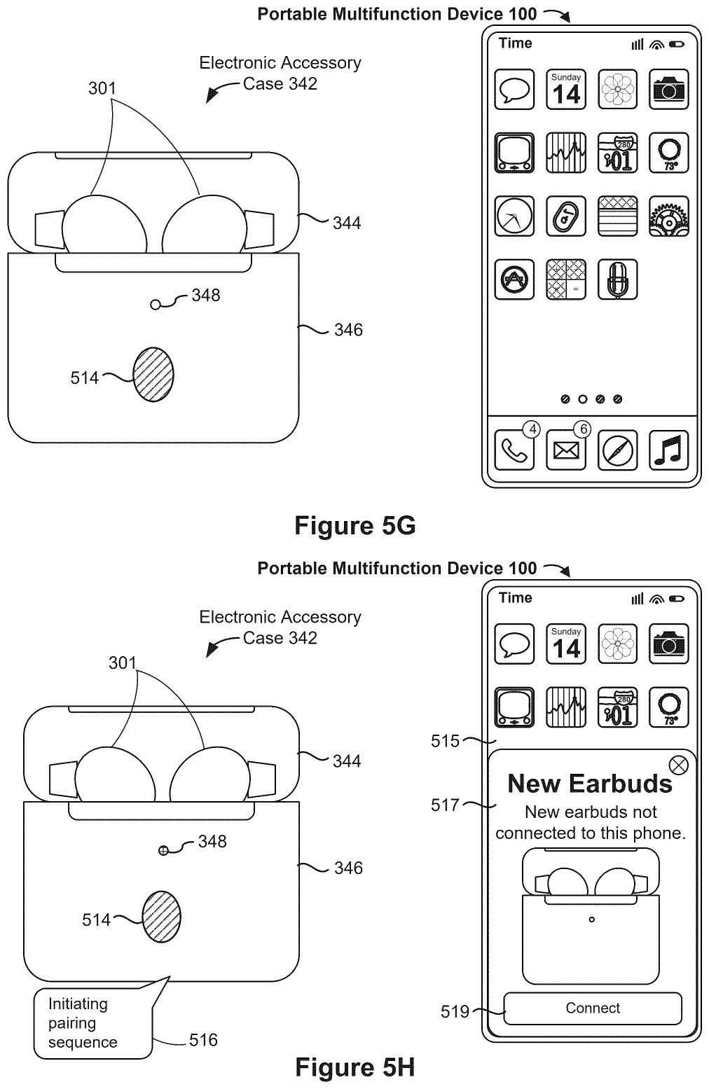

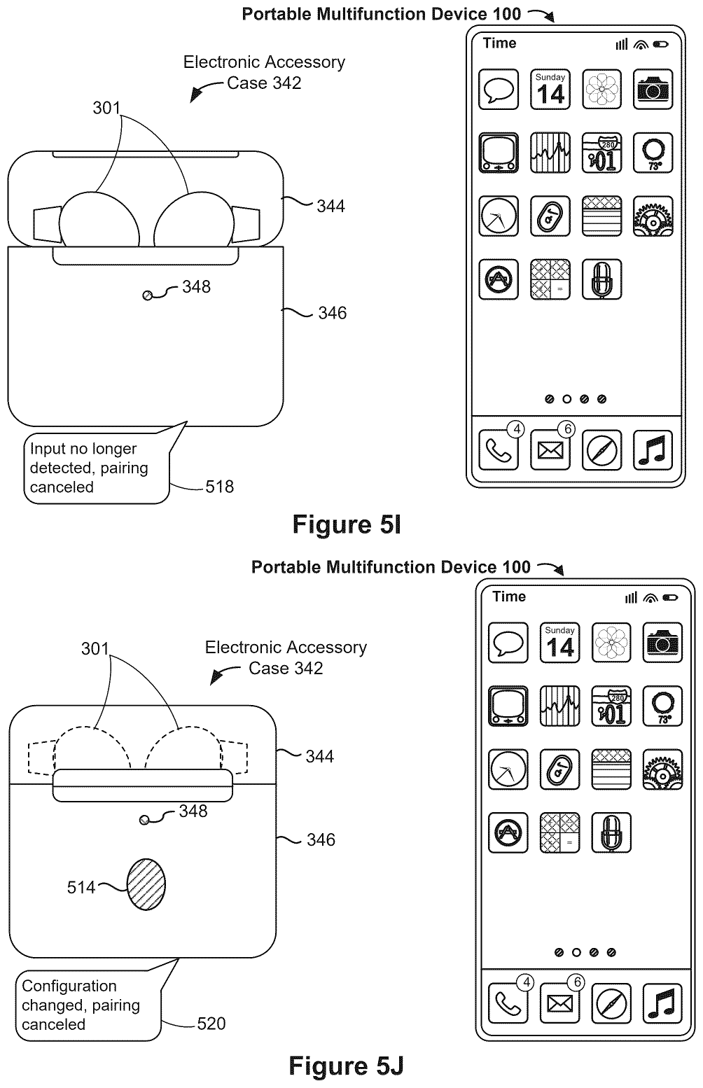

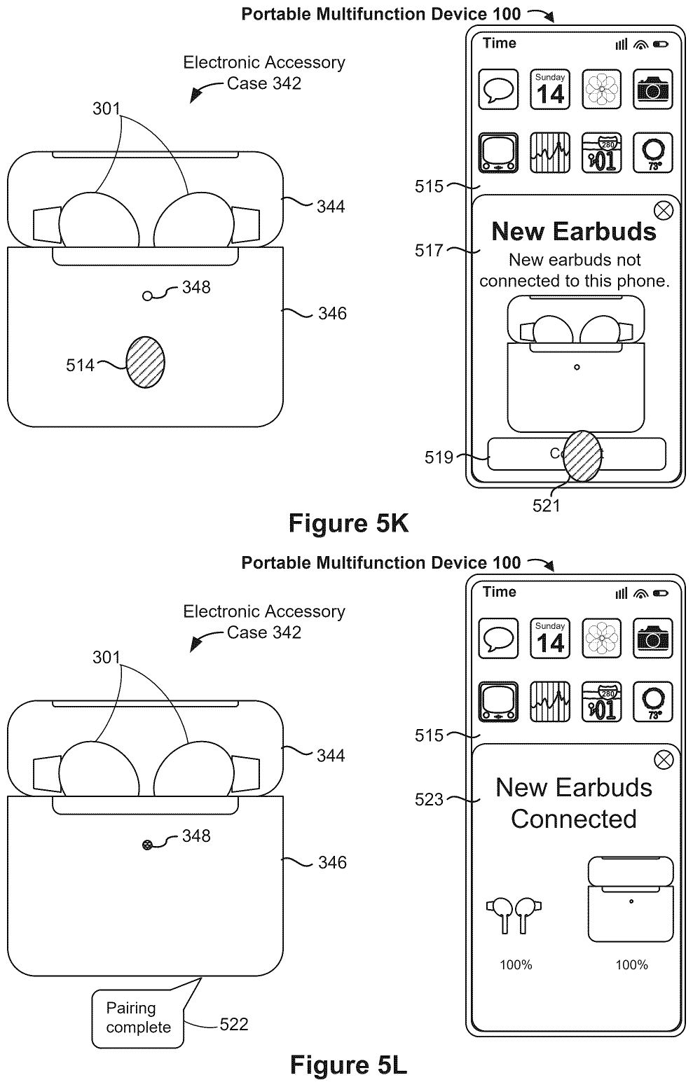

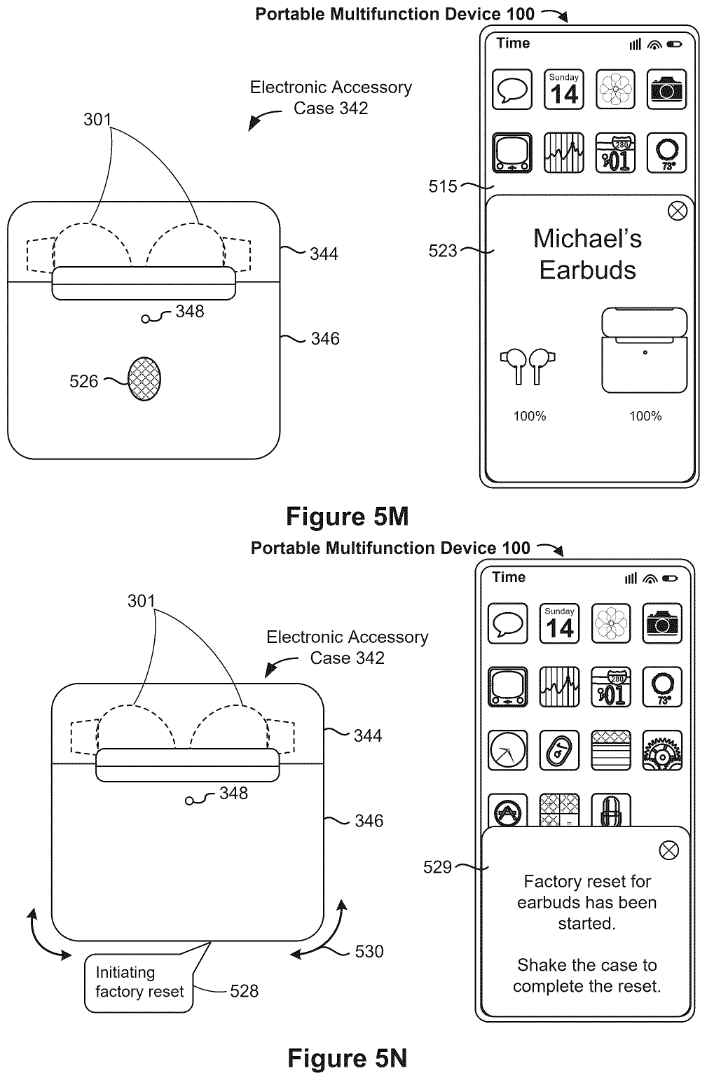

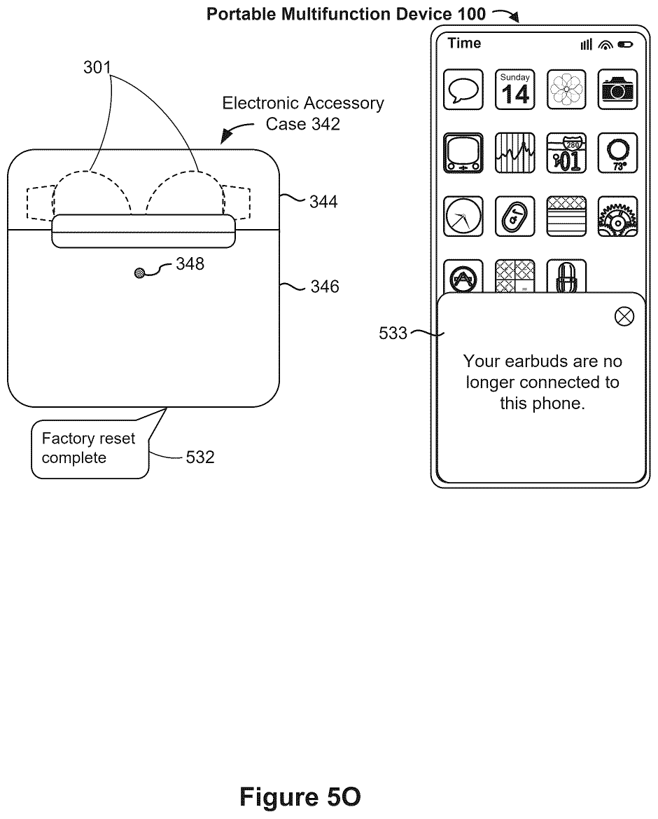

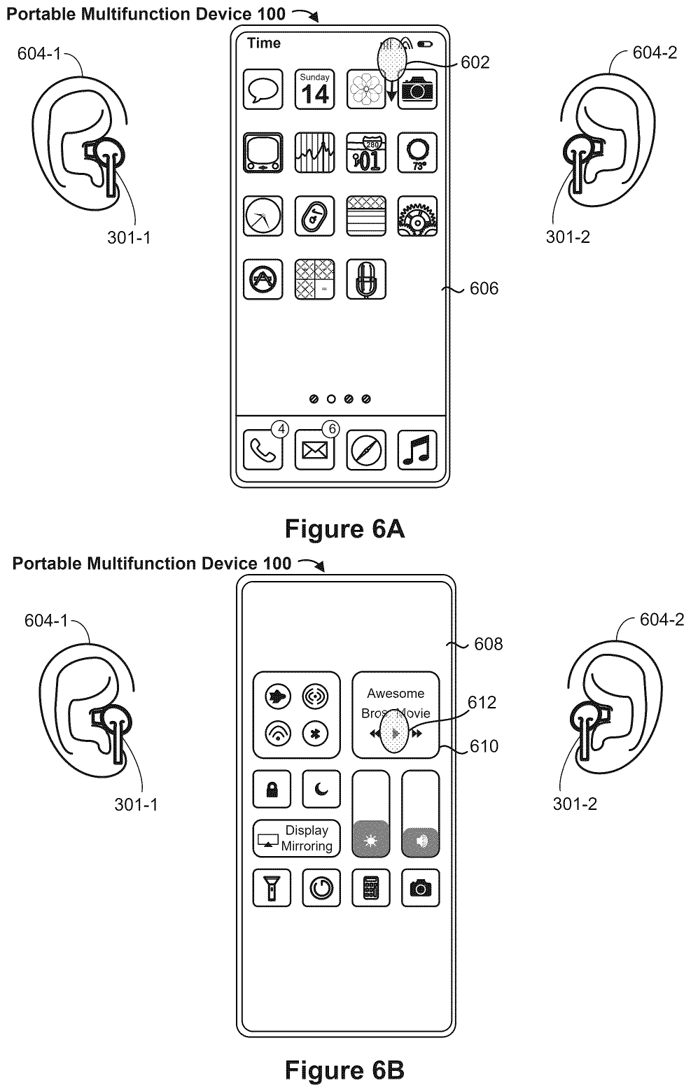

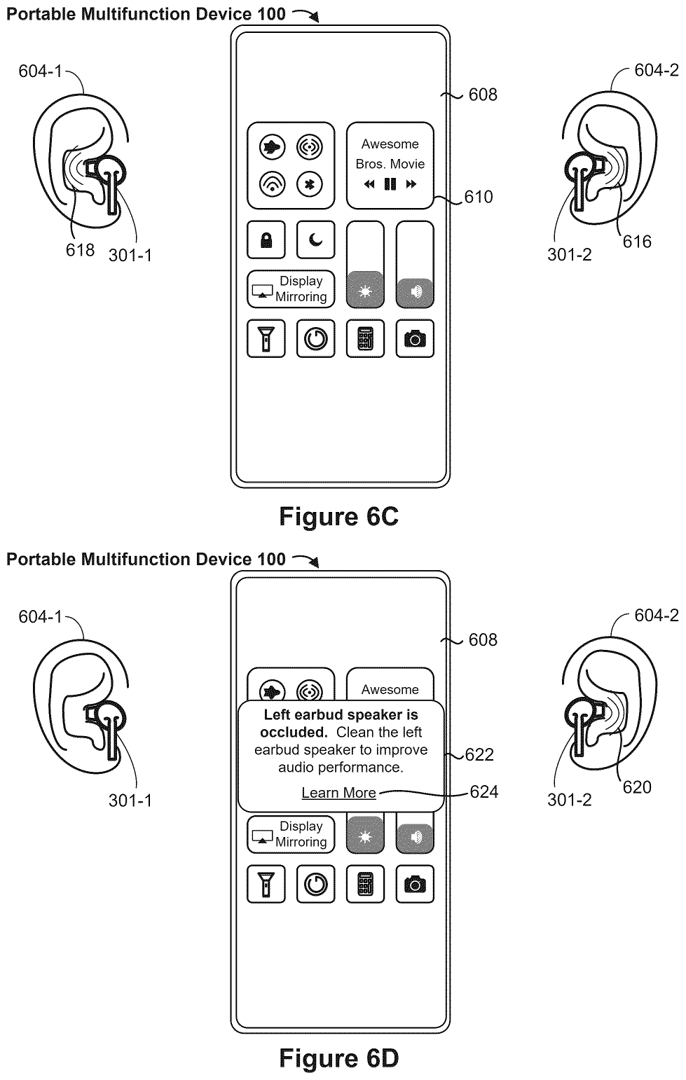

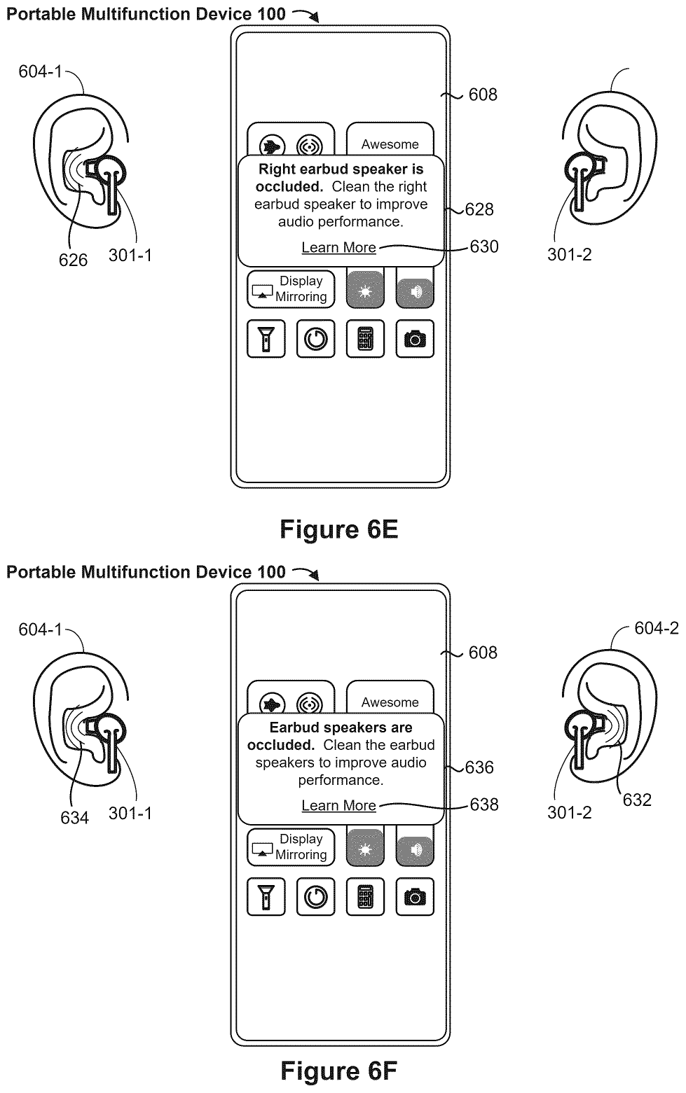

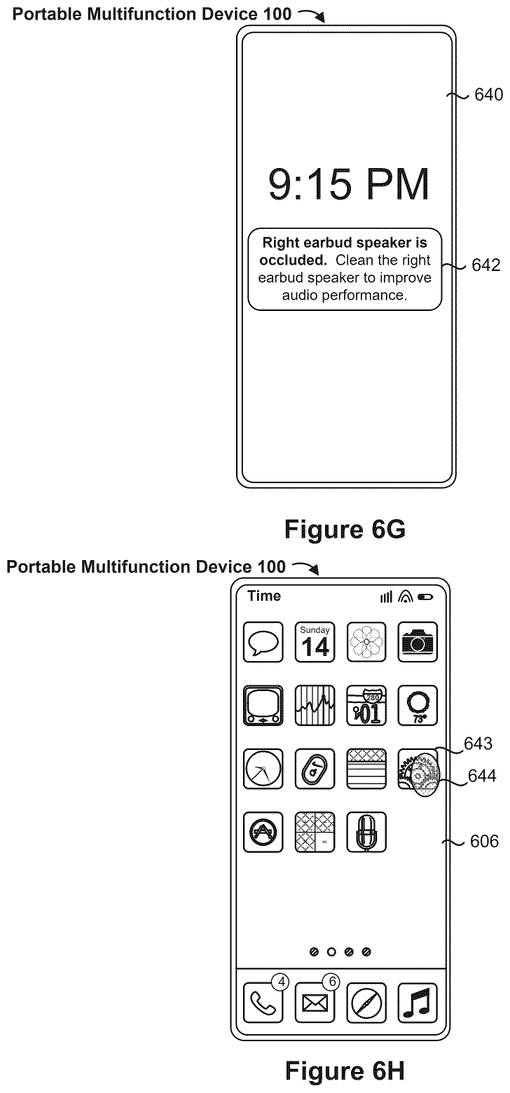

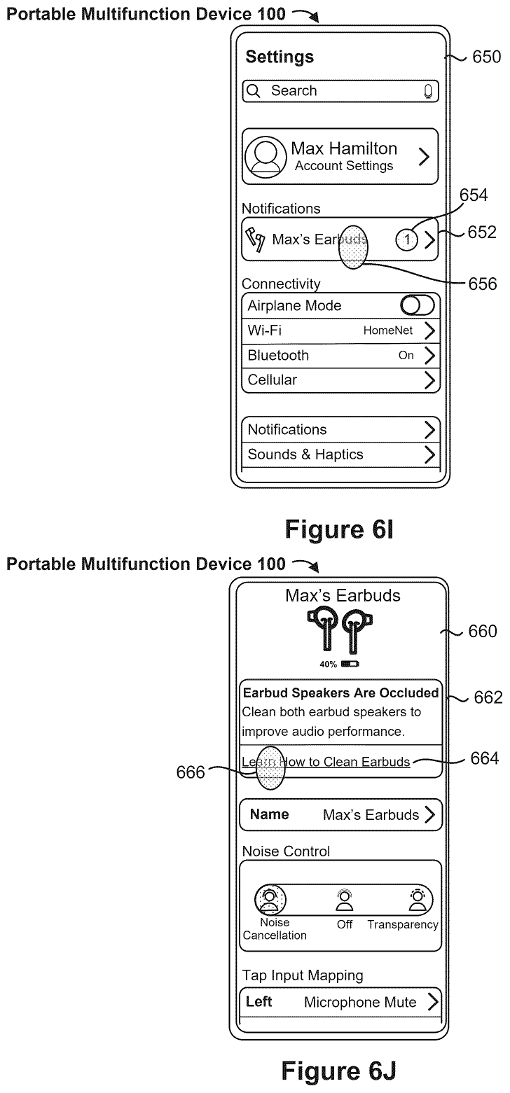

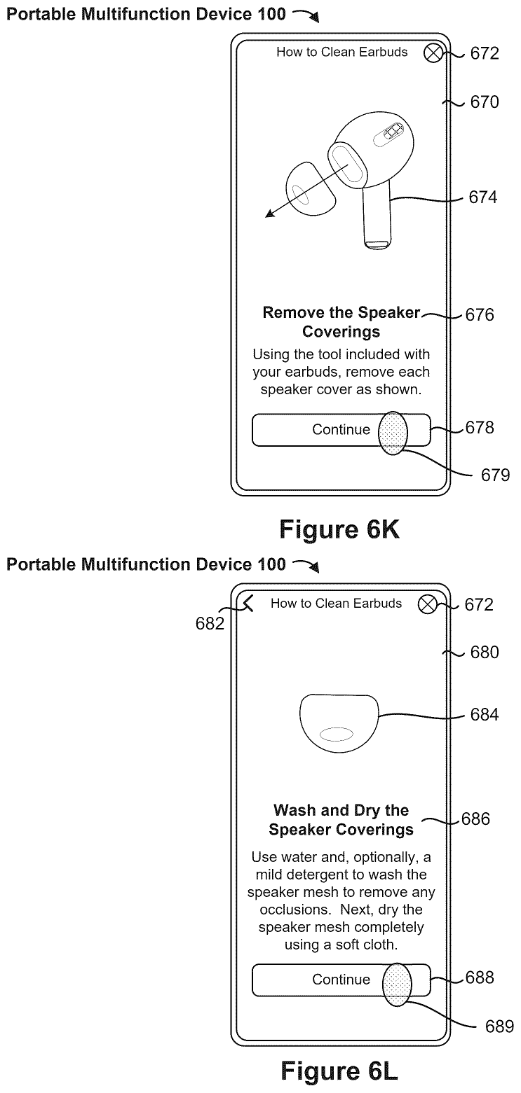

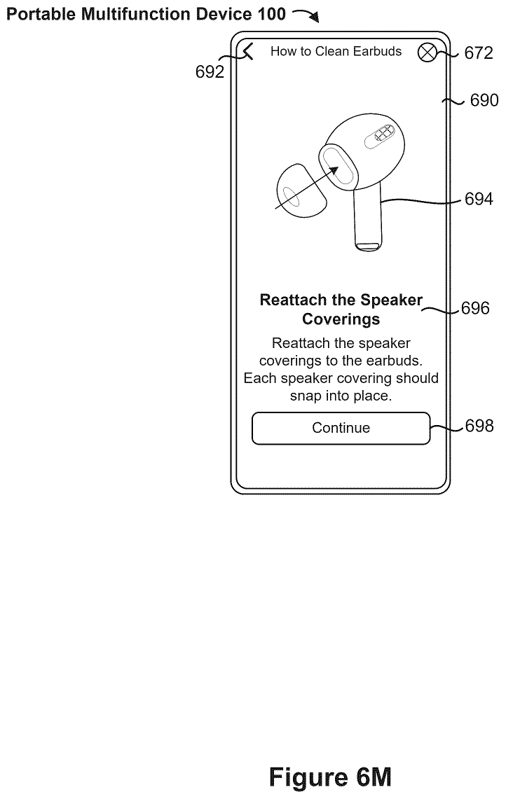

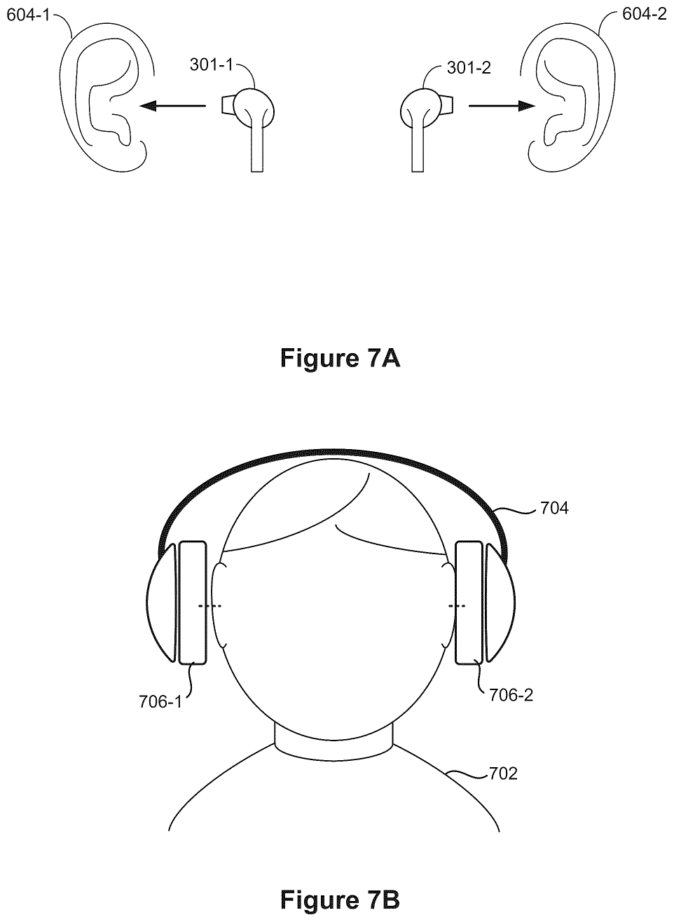

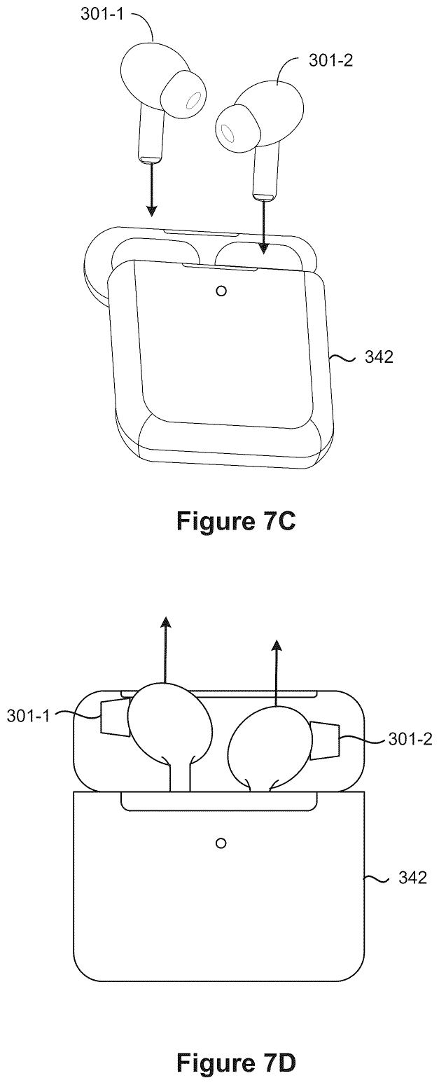

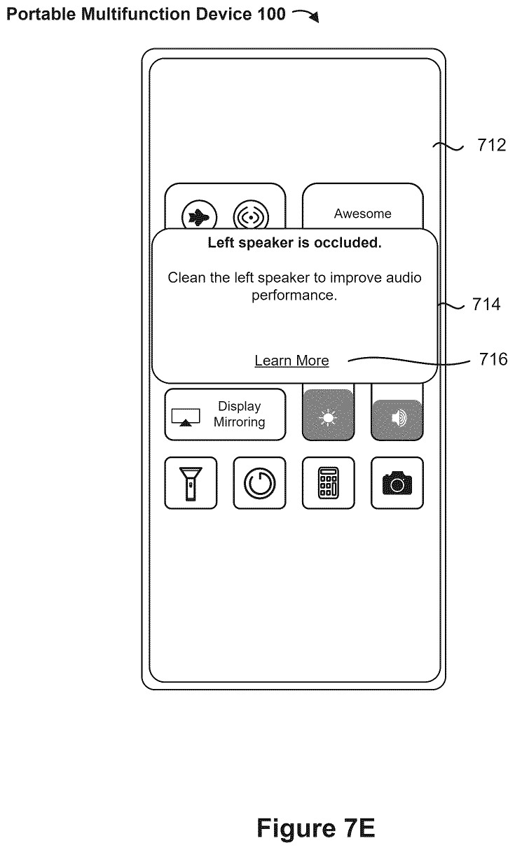

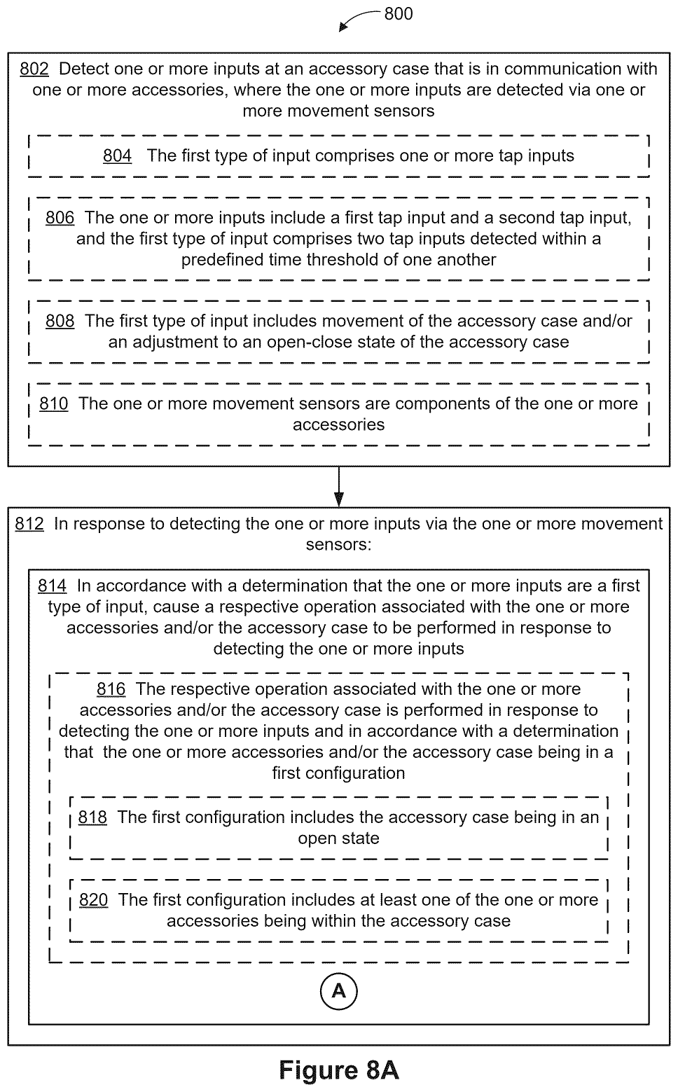

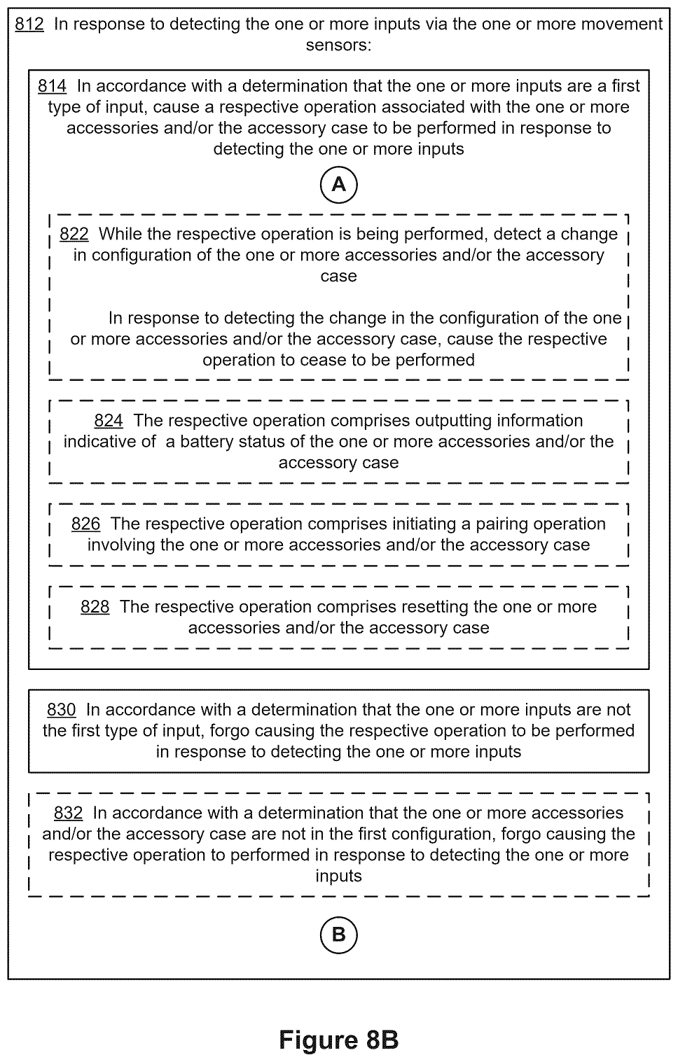

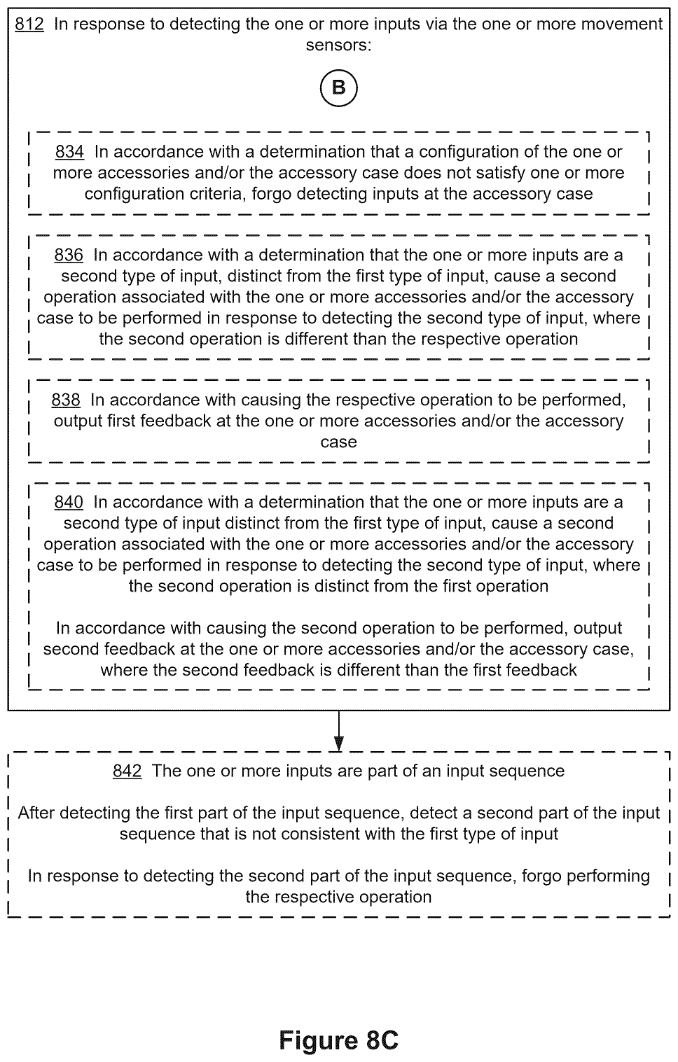

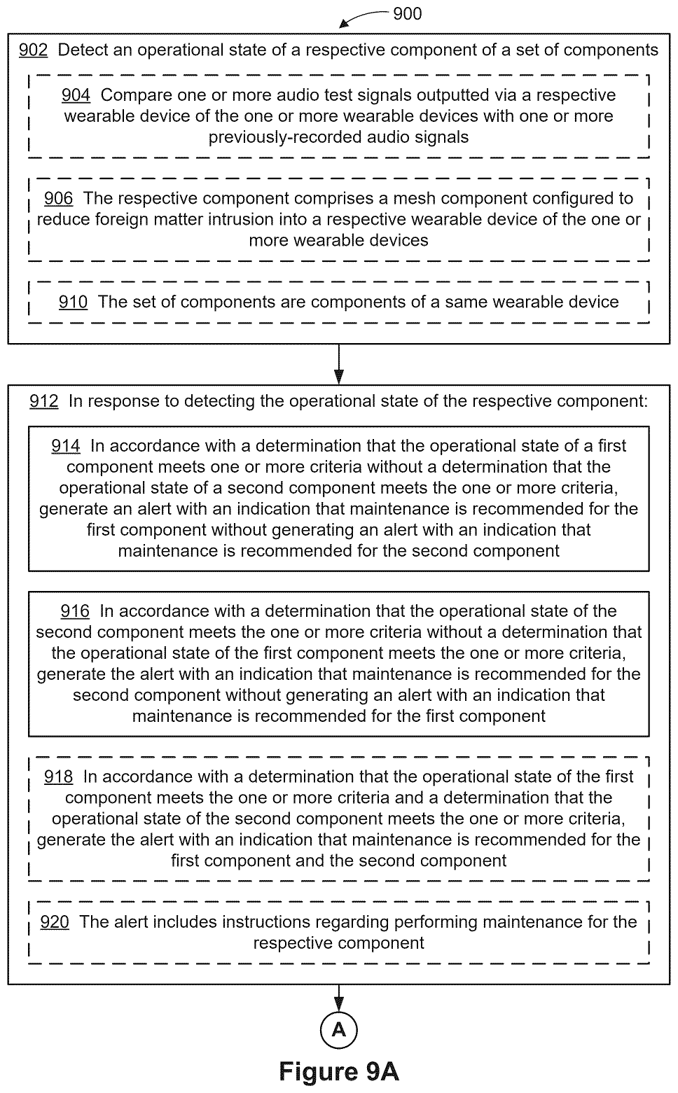

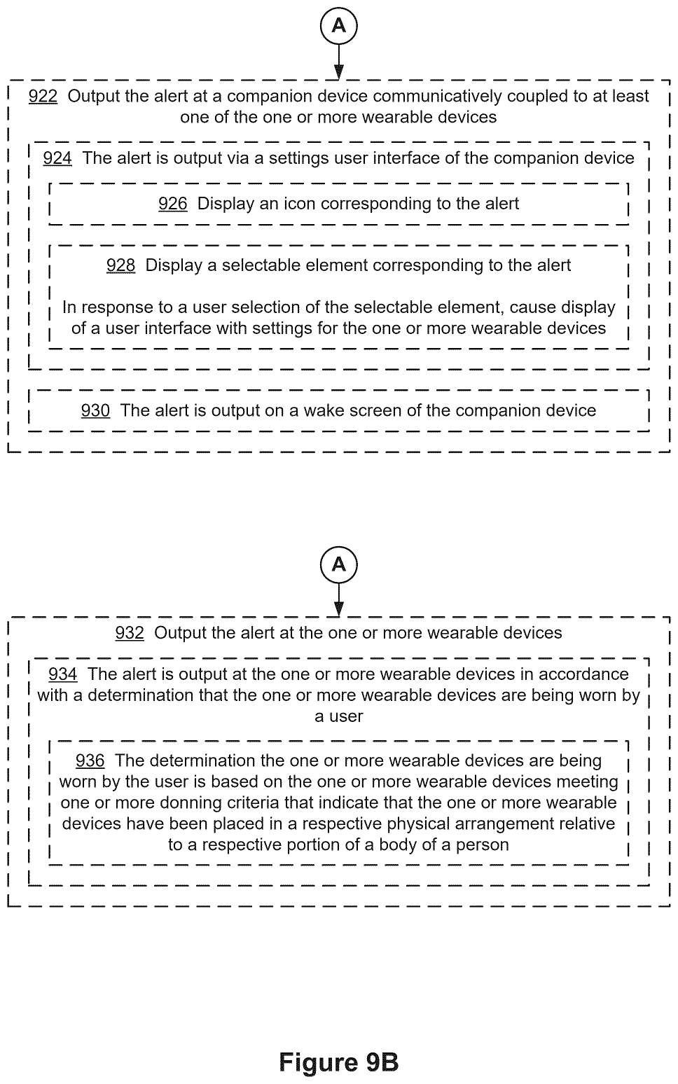

Below, FIGS. 1A-1B, 2, 3A, 3H-3L, and 4A-4B illustrate example devices (e.g., multifunction device 100, device 300, wearable audio output devices 301, and electronic accessory case 342). FIGS. 3B-3G describe the use of Application Programming Interfaces (APIs) to perform operations. FIGS. 5A-5O illustrate example user interfaces and user interactions involving one or more accessories and one or more accessory cases to perform one or more operations. FIGS. 6A-6M illustrate example user interfaces and user interactions for recommended maintenance of one or more wearable devices. FIGS. 7A-7E illustrate example user interfaces and user interactions for recommended maintenance of one or more wearable devices in accordance with some embodiments. FIGS. 8A-8C are flow diagrams of a process for interacting with one or more accessory cases to perform one or more operations. FIGS. 9A-9B are flow diagrams of a process of a process of providing maintenance recommendations for one or more wearable devices. The user interfaces and device interactions in FIGS. 5A-5O, 6A-6M, and 7A-7E are used to illustrate the processes in FIGS. 8A-8C and 9A-9B.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 307 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random-access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

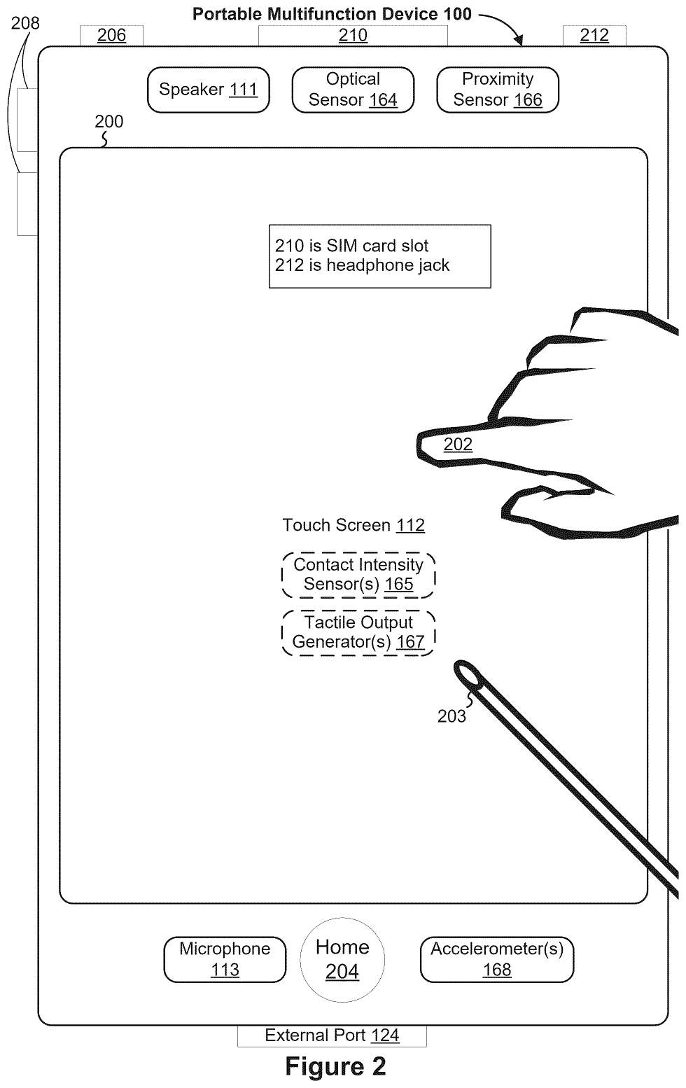

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 313), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 313 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 302, one or more network or other communications interfaces 312, memory 313, and one or more communication buses 303 for interconnecting these components. Communication buses 303 optionally include circuitry (sometimes called a chipset) that interconnects and controls communications between system components. Device 300 includes input/output (I/O) interface 304 comprising display 305, which is typically a touch-screen display. I/O interface 304 also optionally includes a keyboard and/or mouse (or other pointing device) 306 and touchpad 307, tactile output generator 308 for generating tactile outputs on device 300 (e.g., similar to tactile output generator(s) 167 described above with reference to FIG. 1A), sensors 309 (e.g., optical, acceleration, proximity, touch-sensitive, and/or contact intensity sensors similar to contact intensity sensor(s) 165 described above with reference to FIG. 1A), audio I/O logic 310, and/or wireless interface 311.

Memory 313 includes high-speed random-access memory, such as DRAM, SRAM, DDR RAM or other random-access solid-state memory devices; and optionally includes non-volatile memory, such as one or more magnetic disk storage devices, optical disk storage devices, flash memory devices, or other non-volatile solid state storage devices. Memory 313 optionally includes one or more storage devices remotely located from CPU(s) 302. In some embodiments, memory 313 stores programs, modules, and data structures analogous to the programs, modules, and data structures stored in memory 102 of portable multifunction device 100 (FIG. 1A), or a subset thereof. Furthermore, memory 313 optionally stores additional programs, modules, and data structures not present in memory 102 of portable multifunction device 100. For example, memory 313 of device 300 optionally stores drawing module 314, presentation module 315, word processing module 316, website creation module 317, disk authoring module 318, and/or spreadsheet module 319, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 313 optionally stores a subset of the modules and data structures identified above. Furthermore, memory 313 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIGS. 8A-8C) and/or method 900 (FIGS. 9A-9B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 3H illustrates physical features of an example wearable audio output device 301 in accordance with some embodiments. In some embodiments, the wearable audio output device 301 is one or more in-ear earphone(s), earbud(s), over-ear headphone(s), or the like. In the example of FIG. 3H, wearable audio output device 301 is an earbud. In some embodiments, wearable audio output device 301 includes a head portion 323 and a stem portion 325. In some embodiments, head portion 323 is configured to be inserted into a user's ear. In some embodiments, stem portion 325 physically extends from head portion 323 (e.g., is an elongated portion extending from head portion 323). For example, head portion 323 physically extends downward, in front of, and/or past a user's earlobe while head portion 323 is inserted into a user's ear.

In some embodiments, wearable audio output device 301 includes one or more audio speakers 326 (e.g., in head portion 323) for providing audio output (e.g., to a user's ear). In some embodiments, wearable audio output device 301 includes one or more placement sensors 324 (e.g., placement sensors 324-1 and 324-2 in head portion 323) to detect positioning or placement of wearable audio output device 301 relative to a user's ear, such as to detect placement of wearable audio output device 301 in a user's ear.

In some embodiments, wearable audio output device 301 includes one or more microphones 322 for receiving audio input. In some embodiments, one or more microphones 322 are included in head portion 323 (e.g., microphone 322-1). In some embodiments, one or more microphones 322 are included in stem portion 325 (e.g., microphone 322-2). In some embodiments, microphone(s) 322 detect speech from a user wearing wearable audio output device 301 and/or ambient noise around wearable audio output device 301. In some embodiments, multiple microphones of microphones 322 are positioned at different locations on wearable audio output device 301 to measure speech and/or ambient noise at different locations around wearable audio output device 301.

In some embodiments, wearable audio output device 301 includes one or more input devices 328 (e.g., in stem portion 325). In some embodiments, input device(s) 328 includes a pressure-sensitive (e.g., intensity-sensitive) input device. In some embodiments, the pressure-sensitive input device detects inputs from a user in response to the user squeezing the input device (e.g., by pinching stem portion 325 of wearable audio output device 301 between two fingers). In some embodiments, input device(s) 328 include a touch-sensitive surface (e.g., a capacitive sensor) for detecting touch inputs, accelerometer(s), and/or attitude sensor(s) (e.g., for determining an attitude of wearable audio output device 301 relative to a physical environment and/or changes in attitude of the device), and/or other input device by which a user can interact with and provide inputs to wearable audio output device 301. In some embodiments, input device(s) 328 include one or more capacitive sensors, one or more force sensors, one or more motion sensors, and/or one or more orientation sensors. FIG. 3H shows input device(s) 328 at a location in stem portion 325, however in some embodiments one or more of input device(s) 328 are located at other positions within wearable audio output device 301 (e.g., other positions within stem portion 325 and/or head portion 323). In some embodiments, wearable audio output device 301 includes a housing with one or more physically distinguished portions 327 at locations that correspond to input device(s) 328 (e.g., to assist a user in locating and/or interacting with input device(s) 328). In some embodiments, physically distinguished portion(s) 327 include indent(s), raised portion(s), and/or portions with different textures. In some embodiments, physically distinguished portion(s) 327 include a single distinguished portion that spans multiple input devices 328. For example, input devices 328 include a set of touch sensors configured to detect swipe gestures and a single distinguished portion (e.g., a depression or groove) spans the set of touch sensors. In some embodiments, physically distinguished portion(s) 327 include a respective distinguished portion for each input device of input device(s) 328.

In some embodiments, wearable audio output device 301 includes one or more sensors 331 (e.g., sensors 331-1 and 331-2 in stem portion 325). In some embodiments, the one or more sensors 331 include one or more movement sensors (e.g., accelerometers, IMUs, and/or other types of movement sensors). In some embodiments, the one or more sensors 331 include one or more image sensors or cameras. In some embodiments, the sensor(s) 331 include a sensor (e.g., the sensor 331-1) that faces forward while the wearable audio output device 301 is being worn by a user. In some embodiments, the sensor(s) 331 include a sensor (e.g., the sensor 331-2) that faces backwards while the wearable audio output device 301 is being worn by a user. In some embodiments, the sensor(s) 331 consist of one sensor (e.g., with a field of view that is substantially the same as the wearer of the wearable audio output device 301). In some embodiments, the sensor(s) 331 include three or more sensors (e.g., each with a different field of view). In some embodiments, one or more of the sensor(s) 331 are arranged at different positions than shown in FIG. 3H. For example, one of the sensor(s) 331 may be arranged on the head portion 323. As another example, one of the sensor(s) 331 may be arranged near the middle or top of the stem portion 325.

FIG. 3I is a block diagram of an example wearable audio output device 301 in accordance with some embodiments. In some embodiments, wearable audio output device 301 is one or more in-ear earphone(s), earbud(s), over-ear headphone(s), or the like. In some examples, wearable audio output device 301 includes a pair of earphones or earbuds (e.g., one for each of a user's ears). In some examples, wearable audio output device 301 includes over-ear headphones (e.g., headphones with two over-ear earcups to be placed over a user's ears and optionally connected by a headband). In some embodiments, wearable audio output device 301 includes one or more audio speakers 326 for providing audio output (e.g., to a user's ear). In some embodiments, wearable audio output device 301 includes one or more placement sensors 324 to detect positioning or placement of wearable audio output device 301 relative to a user's ear, such as to detect placement of wearable audio output device 301 in a user's ear. In some embodiments, wearable audio output device 301 conditionally outputs audio based on whether wearable audio output device 301 is in or near a user's ear (e.g., wearable audio output device 301 forgoes outputting audio when not in a user's ear, to reduce power usage). In some embodiments where wearable audio output device 301 includes multiple (e.g., a pair) of wearable audio output components (e.g., earphones, earbuds, or earcups), each component includes one or more respective placement sensors, and wearable audio output device 301 conditionally outputs audio based on whether one or both components is in or near a user's ear, as described herein. In some embodiments, wearable audio output device 301 furthermore includes an internal rechargeable battery 329 for providing power to the various components of wearable audio output device 301.

In some embodiments, wearable audio output device 301 includes audio I/O logic 332, which determines the positioning or placement of wearable audio output device 301 relative to a user's ear based on information received from placement sensor(s) 324, and, in some embodiments, audio I/O logic 332 controls the resulting conditional outputting of audio. In some embodiments, wearable audio output device 301 includes an interface 335, e.g., a wireless interface, for communication with one or more multifunction devices, such as device 100 (e.g., as shown in FIG. 1A) or device 300 (e.g., as shown in FIG. 3A). In some embodiments, interface 335 includes a wired interface for connection with a multifunction device, such as device 100 (e.g., as shown in FIG. 1A) or device 300 (e.g., as shown in FIG. 3A) (e.g., via a headphone jack or other audio port). In some embodiments, a user can interact with and provide inputs (e.g., remotely) to wearable audio output device 301 via interface 335. In some embodiments, wearable audio output device 301 is in communication with multiple devices (e.g., multiple multifunction devices, and/or an audio output device case), and audio I/O logic 332 determines, which of the multifunction devices from which to accept instructions for outputting audio.

In some embodiments, wearable audio output device 301 includes one or more microphones 322 for receiving audio input. In some embodiments where wearable audio output device 301 includes multiple (e.g., a pair) of wearable audio output components (e.g., earphones or earbuds), each component includes one or more respective microphones. In some embodiments, audio I/O logic 332 detects or recognizes speech or ambient noise based on information received from microphone(s) 322.

In some embodiments, wearable audio output device 301 includes one or more input devices 328. In some embodiments where wearable audio output device 301 includes multiple (e.g., a pair) of wearable audio output components (e.g., earphones, earbuds, or earcups), each component includes one or more respective input devices. In some embodiments, input device(s) 328 include one or more volume control hardware elements (e.g., an up/down button for volume control, or an up button and a separate down button, as described herein with reference to FIG. 1A) for volume control (e.g., locally) of wearable audio output device 301. In some embodiments, inputs provided via input device(s) 328 are processed by audio I/O logic 332. In some embodiments, audio I/O logic 332 is in communication with a separate device (e.g., device 100, FIG. 1A, or device 300, FIG. 3A) that provides instructions or content for audio output, and that optionally receives and processes inputs (or information about inputs) provided via microphone(s) 322, placement sensor(s) 324, and/or input device(s) 328, or via one or more input devices of the separate device. In some embodiments, audio I/O logic 332 is located in device 100 (e.g., as part of peripherals interface 118, FIG. 1A) or device 300 (e.g., as part of I/O interface 304, FIG. 3A), instead of device 301, or alternatively is located in part in device 100 and in part in device 301, or in part in device 300 and in part in device 301.

FIG. 3J illustrates physical features of an example electronic accessory case 342 in accordance with some embodiments. In some embodiments, electronic accessory case 342 includes a lid 344 and a container 346. In some embodiments, electronic accessory case 342 includes one or more sensors to detect if lid 344 is opened, closed, and/or moving. In some embodiments, electronic accessory case 342 is configured to house and/or charge one or more electronic accessories, such as headphones, a smartwatch, an electronic stylus, a fitness tracker, and/or earbuds. In some embodiments, electronic accessory case 342 includes one or more status indicators 348 (e.g., providing status and/or event information to a user).

FIG. 3K is a block diagram illustrating an electronic accessory case 342 in accordance with some embodiments. In some embodiments, electronic accessory case 342 a headphone case (e.g., a wireless headphone case). In some embodiments, electronic accessory case 342 an accessory charging case configured to charge one or more accessories while the accessories are positioned (e.g., mounted, inserted, and/or attached) to the accessory charging case. Electronic accessory case 342 includes memory 359 (which optionally includes one or more computer readable storage mediums), one or more sensors 351, one or more processing units (controllers) 352, and peripherals interface 354. In some embodiments, peripherals interface 354 includes one or more speakers 355, one or more input devices 356 (e.g., one or more buttons, switches, and/or levers), and one or more communication components 358 (e.g., a wireless interface) for communicating with devices such as one or more wearable audio output devices 301, and one or more electronic devices such as a smart phone, tablet, computer or the like. In some embodiments, peripherals interface 354 includes a set of LEDs and/or display elements capable of displaying icons and/or other visual information. In some embodiments, peripherals interface 354 includes one or more tactile output generators 357 for generating tactile outputs (also called haptic feedback), e.g., via an external case 350 (also called the housing) of the electronic accessory case 342. In some embodiments, the one or more sensors 351 include one or more movement sensors (e.g., accelerometers, IMUs, and/or other types of movement sensors).

In accordance with some embodiments, electronic accessory case 342 includes an internal rechargeable battery 367 for providing power to the various components of electronic accessory case 342, as well as for charging the internal battery 329 (FIG. 3H) of one or more wearable audio output devices 301. In some embodiments, electronic accessory case 342 includes a battery charger 369 for charging internal battery 367 when battery charger 369 is connected to an external power source via a power connect port 370. In some embodiments, the internal battery 367 and/or battery charger 369 are configured to charge the internal battery 329 (FIG. 3H) of an audio output device (e.g., headphone or earbud) when the audio output device is connected to (e.g., properly positioned in) an accessory charger 368. These components optionally communicate over one or more communication buses or signal lines 353.

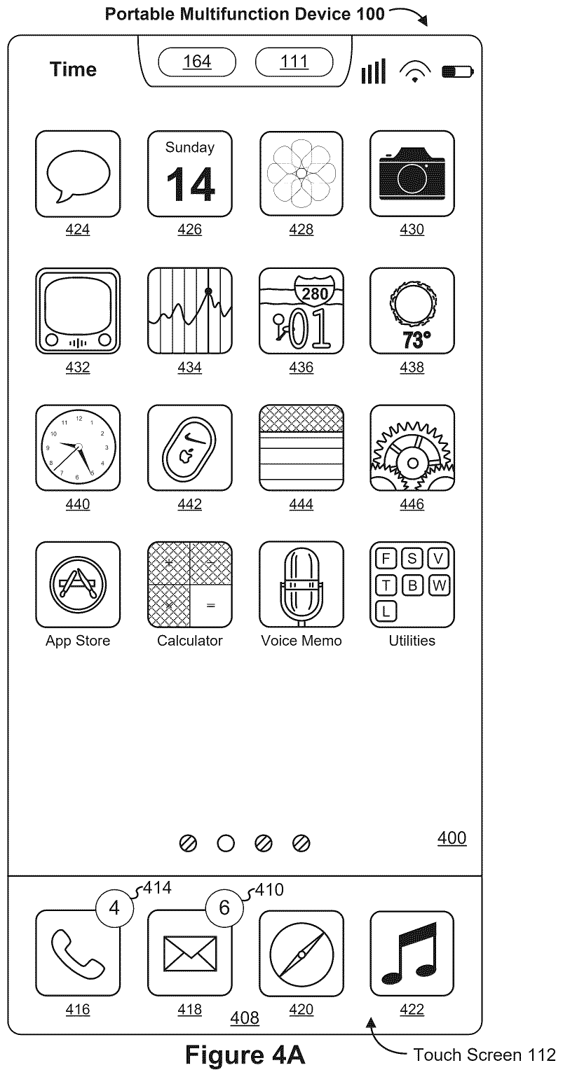

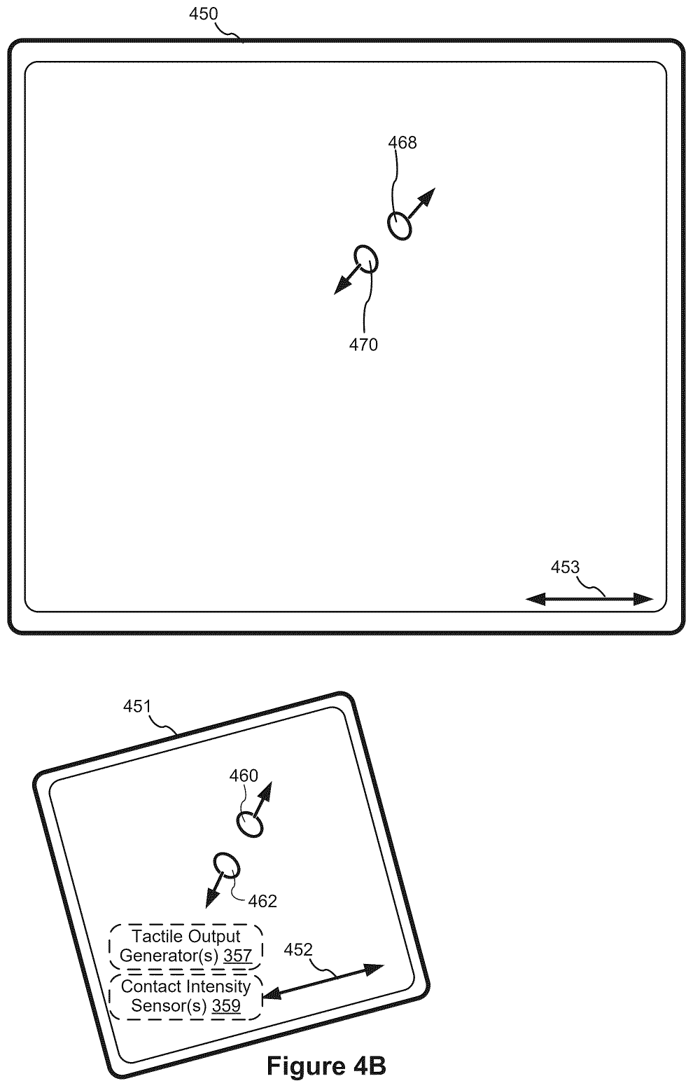

In some embodiments, external case 350, when closed (e.g., see FIG. 4C), has an extent (e.g., width or height) in a first dimension of between 1.5 and 3 inches, an extent (e.g., height or width) in a second dimension of between 1 and 2.5 inches, and an extent in a third dimension (e.g., depth) of between 0.5 and 1 inch.

In some embodiments, the software components stored in memory 359 include operating system 360 (or a BIOS), communication module (or set of instructions) 361, an input module (or set of instructions) 362, audio module (or set of instructions) 363, haptic feedback module (or set of instructions) 364, and accessory control module(s) 365. Furthermore, in some embodiments, memory 359 stores a device/global internal state 366, which includes one or more of: active application state, indicating which applications, if any, are currently active; and sensor state, including information obtained from the device's various sensors and other input devices 356.

FIG. 3L illustrates example audio control by a wearable audio output device 301 in accordance with some embodiments. While the following example is explained with respect to implementations that include a wearable audio output device having earbuds to which interchangeable eartips (sometimes called silicon eartips or silicon seals) are attached, the methods, devices and user interfaces described herein are equally applicable to implementations in which the wearable audio output devices do not have eartips, and instead each have a portion of the main body shaped for insertion in the user's ears. In some embodiments in which a wearable audio output device has earbuds to which interchangeable eartips may be attached are worn in a user's ears, the earbuds and eartips together act as physical barriers that block at least some ambient sound from the surrounding physical environment from reaching the user's ear. For example, in FIG. 3L, wearable audio output device 301 is worn by a user such that head portion 323 and eartip 334 are in the user's left ear. Eartip 334 extends at least partially into the user's ear canal. Preferably, when head portion 323 and eartip 334 are inserted into the user's ear, a seal is formed between eartip 334 and the user's ear so as to isolate the user's ear canal from the surrounding physical environment. However, in some circumstances, head portion 323 and eartip 334 together block some, but not necessarily all, of the ambient sound in the surrounding physical environment from reaching the user's ear. Accordingly, in some embodiments, a first microphone (or, in some embodiments, a first set of one or more microphones) 322-1 (and optionally a third microphone 322-3) is located on wearable audio output device 301 so as to detect ambient sound, represented by waveform 380, in region 336 of a physical environment surrounding (e.g., outside of) head portion 323. In some embodiments, a second microphone (or, in some embodiments, a second set of one or more microphones) 322-2 (e.g., of microphones 322, FIG. 3I) is located on wearable audio output device 301 so as to detect any ambient sound, represented by waveform 382, that is not completely blocked by head portion 323 and eartip 334 and that can be heard in region 338 inside the user's ear canal. Accordingly, in some circumstances in which wearable audio output device 301 is not producing a noise-cancelling (also called “antiphase”) audio signal to cancel (e.g., attenuate) ambient sound from the surrounding physical environment, as indicated by waveform 384-1, ambient sound waveform 382 is perceivable by the user, as indicated by waveform 386-1. In some circumstances in which wearable audio output device 301 is producing an antiphase audio signal to cancel ambient sound, as indicated by waveform 384-2, ambient sound waveform 382 is not perceivable by the user, as indicated by waveform 386-2.

In some embodiments, ambient sound waveform 380 is compared to attenuated ambient sound waveform 382 (e.g., by wearable audio output device 301 or a component of wearable audio output device 301, such as audio I/O logic 332, or by an electronic device that is in communication with wearable audio output device 301) to determine the passive attenuation provided by wearable audio output device 301. In some embodiments, the amount of passive attenuation provided by wearable audio output device 301 is taken into account when providing the antiphase audio signal to cancel ambient sound from the surrounding physical environment. For example, antiphase audio signal waveform 384-2 is configured to cancel attenuated ambient sound waveform 382 rather than unattenuated ambient sound waveform 380.

In some embodiments, wearable audio output device 301 is configured to operate in one of a plurality of available audio output modes, such as an active noise control audio output mode, an active pass-through audio output mode, and a bypass audio output mode (also sometimes called a noise control off audio output mode). In the active noise control mode (also called “ANC”), wearable audio output device 301 outputs one or more audio-cancelling audio components (e.g., one or more antiphase audio signals, also called “audio-cancelation audio components”) to at least partially cancel ambient sound from the surrounding physical environment that would otherwise be perceivable to the user. In the active pass-through audio output mode, wearable audio output device 301 outputs one or more pass-through audio components (e.g., plays at least a portion of the ambient sound from outside the user's ear, received by microphone 322-1, for example) so that the user can hear a greater amount of ambient sound from the surrounding physical environment than would otherwise be perceivable to the user (e.g., a greater amount of ambient sound than would be audible with the passive attenuation of wearable audio output device 301 placed in the user's ear). In the bypass mode, active noise management is turned off, such that wearable audio output device 301 outputs neither any audio-cancelling audio components nor any pass-through audio components (e.g., such that any amount of ambient sound that the user perceives is due to physical attenuation by wearable audio output device 301).

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, the user interface includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 307, FIG. 3A) that is separate from the display 450. Although many of the examples that follow will be given with reference to inputs on touch screen displays (e.g., touch screen display 112) (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse-based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used in the specification and claims, the term “intensity” of a contact on a touch-sensitive surface refers to the force or pressure (force per unit area) of a contact (e.g., a finger contact or a stylus contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average or a sum) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be readily accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, a value produced by low-pass filtering the intensity of the contact over a predefined period or starting at a predefined time, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds may include a first intensity threshold and a second intensity threshold. In this example, a contact with a characteristic intensity that does not exceed the first intensity threshold results in a first operation, a contact with a characteristic intensity that exceeds the first intensity threshold and does not exceed the second intensity threshold results in a second operation, and a contact with a characteristic intensity that exceeds the second intensity threshold results in a third operation. In some embodiments, a comparison between the characteristic intensity and one or more intensity thresholds is used to determine whether or not to perform one or more operations (e.g., whether to perform a respective option or forgo performing the respective operation) rather than being used to determine whether to perform a first operation or a second operation.

In some embodiments, a portion of a gesture is identified for purposes of determining a characteristic intensity. For example, a touch-sensitive surface may receive a continuous swipe contact transitioning from a start location and reaching an end location (e.g., a drag gesture), at which point the intensity of the contact increases. In this example, the characteristic intensity of the contact at the end location may be based on only a portion of the continuous swipe contact, and not the entire swipe contact (e.g., only the portion of the swipe contact at the end location). In some embodiments, a smoothing algorithm may be applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

### User Interfaces and Associated Processes

Attention is now directed towards embodiments of user interfaces (“UI”) and associated processes that may be implemented on an electronic device, such as portable multifunction device 100, device 300, wearable audio output devices 301, and/or electronic accessory case 342.

FIGS. 5A-5O illustrate example user interfaces and user interactions for detecting and responding to inputs at an accessory case that is in communication with one or more accessories in accordance with some embodiments. FIGS. 6A-6M and 7A-7E illustrate example user interfaces and user interactions for detecting and responding to operational states of components of wearable devices in accordance with some embodiments. The user interfaces and user interactions in these figures are used to illustrate the processes described below, including the processes in FIGS. 8A-8C and 9A-9B.

FIGS. 5A-5O illustrate example user interfaces and user interactions for detecting and responding to inputs at an accessory case that is in communication with one or more accessories in accordance with some embodiments.

FIG. 5A shows one or more inputs 502 directed to (e.g., received at and/or detected at) the electronic accessory case 342 while the electronic accessory case 342 is not in one or more respective configurations. For example, in some embodiments, the one or more inputs 502 are received (e.g., detected by one or more movement sensors) when the electronic accessory case 342 is configured in an open state (e.g., the electronic accessory case 342 is configured such that a user may view, remove, and/or insert the one or more electronic accessories) and while one or more electronic accessories are not within the electronic accessory case 342. In some embodiments, the one or more respective configurations include at least the electronic accessory case 342 in the open state while the one or more electronic accessories are within the electronic accessory case 342. The one or more respective configurations and/or configurations other than the one or more respective configurations optionally change the operation of the electronic accessory case 342 (e.g., performing or forgoing monitoring the one or more inputs 502, detecting the one or more inputs 502, processing the one or more inputs 502, and/or operations associated with the one or more inputs 502). In some embodiments, the one or more inputs 502 include one or more tap inputs. The one or more tap inputs are optionally directed to any region of the electronic accessory case 342. For example, the one or more tap inputs are optionally directed to an exterior of the electronic accessory case 342. Optionally, the one or more tap inputs are directed to an exterior of the electronic accessory case 342 near the status indicator 348.

In some embodiments, as shown in section 503, the one or more inputs 502 include one or more squeeze inputs (e.g., a first portion of a squeeze input 502-1 and a second portion of a squeeze input 502-2). Like the one or more tap inputs, the one or more squeeze inputs are optionally directed to any region of the electronic accessory case 342. In some embodiments, the one or more inputs 502 are detected via one or more movement sensors associated with the electronic accessory case 342 and/or with one or more electronic accessories (e.g., the wearable audio output devices 301). For example, the one or more movement sensors are optionally components of the electronic accessory case 342. In some embodiments, the movement sensors are included in the one or more electronic accessories, and the one or more electronic accessories are communicatively coupled with the electronic accessory case 342 such that the one or more inputs 502 that are detected via the one or more movement sensors associated with the one or more electronic accessories are communicated to the electronic accessory case 342. In some embodiments, the one or more inputs 502 are associated with (e.g., are mapped to) one or more operations for controlling and/or interacting with the one or more electronic accessories and/or the electronic accessory case 342.

FIG. 5B illustrates a transition from FIG. 5B (e.g., in response to the one or more inputs 502). In the example of FIG. 5B, the one or more inputs 502 do not cause an operation to be performed at the electronic accessory case 342. For example, the one or more inputs 502 are not detected, or are ignored, while the electronic accessory case 342 and/or the one or more electronic accessories are not in a respective configuration. For example, the one or more inputs 502 are optionally ignored while the one or more electronic accessories are not mounted to the electronic accessory case 342. In some embodiments, while the electronic accessory case 342 is in one or more respective configurations, the electronic accessory case 342 monitors for the one or more inputs 502, detects the one or more inputs 502, and/or perform operations corresponding to the one or more inputs 502. In some embodiments, while the electronic accessory case 342 is in a configuration other than the one or more respective configurations, the electronic accessory case 342 forgoes monitoring for the one or more inputs 502, forgoes detecting the one or more inputs 502, and/or forgoes performing operations associated with the one or more inputs 502. For example, because the electronic accessory case 342 is not in at least one of the one or more respective configurations, the electronic accessory case forgoes performing an operation associated with the one or more inputs 502 (as shown in FIG. 5A).

In some embodiments, in response to the one or more user inputs 502 shown in FIG. 5A, a configuration instruction interface 505 is displayed. In some embodiments, the configuration instruction interface 505 is displayed in response to a pairing operation and/or in response to a user input at the portable multifunction device 100. The configuration instruction interface 505 optionally provides instructions to configure the electronic accessory case 342 such that it is in the one or more respective configurations (e.g., the one or more electronic accessories are placed within the electronic accessory case 342 and/or the electronic accessory case 342 is in an open state). For example, the configuration instruction interface 505 optionally provides instructions for placing one or more wearable audio output devices 301 within the electronic accessory case 342 to enable input detection (e.g., detection of the one or more inputs 502) at the electronic accessory case 342.

In some embodiments, the configuration instruction interface 505 is displayed over a home screen user interface (e.g., a user interface with one or more application icons to launch one or more applications), over a lock screen user interface (e.g., a user interface when the device is in a locked state), and/or over an application screen user interface (e.g., a user interface associated with a respective application). In some embodiments, a respective interface (such as the configuration instruction interface 505, the pairing interface 517, the connection interface 523, or the factory reset interface 533) is displayed over whichever user interface was displayed just prior to the display of the respective interface.

As used herein, a home screen user interface includes icons for navigating to a plurality of applications that are executed by the device 100. In some embodiments, the device 100 detects and responds to interaction with the home screen user interface using one or more gestures, including touch inputs. For example, a tap input or other selection input on a respective application icon causes the respective application to launch, or otherwise open a user interface for the respective application, on the display area of device 100. In some embodiments, a plurality of views for the home screen user interface is available. For example, the device detects and responds to user inputs such as swipe gestures or other inputs (e.g., inputs directed to the currently displayed view of the home screen user interface) that correspond to requests to navigate between the plurality of views, wherein each view of the home screen user interface includes different application icons for different applications. In some embodiments, the application icons are different sizes, such as an application widget that displays information for the respective application, wherein the application widget is larger than the application icons.

FIG. 5C shows one or more inputs 506 directed to the electronic accessory case 342 while the electronic accessory case 342 is in a first configuration of the one or more respective configurations. For example, the first configuration includes the wearable audio output devices 301 mounted in the electronic accessory case 342 and the lid of the electronic accessory case 342 in a closed state. In some embodiments, the one or more inputs 506 are detected while the electronic accessory case is in a closed state (e.g., the electronic accessory case 342 is configured such that a user may not view, remove, and/or insert the one or more electronic accessories) with the one or more electronic accessories being within the electronic accessory case 342.

In some embodiments, the one or more inputs 506 include one or more tap inputs. The one or more tap inputs are optionally directed to any region of the electronic accessory case 342. For example, the one or more tap inputs may be directed to an exterior of the electronic accessory case 342. Optionally, the one or more tap inputs may be directed to an exterior of the electronic accessory case 342 near the status indicator 348. In some embodiments, the one or more inputs 506 are the same type of input as the one or more inputs 502. In some embodiments, as shown in section 503, the one or more inputs 506 include one or more squeeze inputs (e.g., a first portion of a squeeze input 506-1 and a second portion of a squeeze input 506-2). Like the one or more tap inputs, the one or more squeeze inputs may be directed to any region of the electronic accessory case 342.

In some embodiments, the one or more inputs 506 are detected via one or more movement sensors of the electronic accessory case 342 and/or the one or more electronic accessories (e.g., the wearable audio output device 301). For example, the one or more movement sensors are optionally components of the electronic accessory case 342. In some embodiments, the movement sensors are included in the one or more electronic accessories, and the one or more electronic accessories are communicatively coupled with the electronic accessory case 342 such that the one or more inputs 506 that are detected via the one or more movement sensors associated with the one or more electronic accessories are communicated to the electronic accessory case 342.

FIG. 5D illustrates a transition from FIG. 5C in response to the one or more inputs 506. In response to the one or more inputs 506 (as shown in FIG. 5C), the electronic accessory case 342 performs one or more operations associated with the one or more inputs 506, such as determining a current battery charge for the electronic accessory case 342 and/or the wearable audio output devices 301. In the example of FIG. 5D, the one or more operations include providing audio output 508 indicating the battery level of the wearable audio output devices 301 and a change in the state of status indicator 348.

In some embodiments, the one or more respective operations include illuminating the status indicator 348 based on the battery charge of the one or more electronic accessories and/or the electronic accessory case 342. In this example, the status indicator is optionally illuminated green when the one or more electronic accessories and/or the electronic accessory case 342 are fully charged, yellow when the one or more electronic accessories and/or the electronic accessory case 342 are mostly charged (e.g., a battery charge between 50% to 80%, 85%, 95%, 97%, 99% or other fully charged battery threshold), orange when the one or more electronic accessories and/or the electronic accessory case 342 are somewhat charged (e.g., a battery charge between 1%, 2,%, 5%, 10%, 15%, 20%, or other low battery threshold and 49%), or red when the one or more electronic accessories and/or the electronic accessory case 342 need to be charged (e.g., a battery charge of less than 1%, 2,%, 5%, 10%, 15%, 20%, or other low battery threshold).

In some embodiments, the operation associated with the one or more inputs 506 ceases in response to the electronic accessory case 342 no longer being in the first configuration. As an example, the operation may be ceased while the operation is ongoing. For example, the audio output 508 regarding the battery charge of the one or more electronic accessories may cease mid-sentence in response to the electronic accessory case 342 no longer being in the first configuration (e.g., in response to the lid 344 of the electronic accessory case 342 being opened).

In some embodiments, even when the electronic accessory case 342 is no longer in the one or more respective configurations (e.g., taken out of the first configuration), the current operation is allowed to complete. After the current operation has completed, the electronic accessory case 342 optionally forgoes performing subsequent operations (e.g., subsequent operations of the same type) until the electronic accessory case 342 is restored to the first configuration.

In some embodiments, one or more operations include a plurality of sub-operations (e.g., a plurality of portions of the operations), and, in response to the electronic accessory case 342 no longer being in the first configuration, only the current sub-operation is completed while the remaining sub-operations are forgone, cancelled, and/or suspended until the electronic accessory case 342 is returned to the first configuration. For example, the audio output 508 regarding the battery charge of the one or more electronic accessories may include two portions, a first portion regarding the battery charge of a first wearable audio output device (e.g., right earbud) and a second portion regarding the battery charge of a second wearable audio output device (e.g., left earbud). In this example, in response to the electronic accessory case 342 no longer being in the first configuration (e.g., the electronic accessory case 342 is reconfigured from the closed state to the open state), the first portion regarding the battery charge of the right earbud is allowed to continue to completion, while the second portion regarding the battery charge of the left earbud is forgone (e.g., not output).

FIG. 5E shows one or more inputs 512 directed to the electronic accessory case 342 while the electronic accessory case 342 is in a configuration other than the one or more respective configurations (e.g., a configuration with the lid 344 in an open state). For example, the one or more inputs 512 are detected while the electronic accessory case lid 344 is in an open state (e.g., the electronic accessory case 342 is configured such that a user may view, remove, and/or insert the one or more electronic accessories) while the one or more electronic accessories are within the electronic accessory case 342. In some embodiments, the electronic accessory case 342 is configured to detect and response to certain types of inputs only while in certain configurations. In some embodiments, the one or more inputs 512 include one or more tap inputs. As an example, the one or more tap inputs are optionally directed to any region of the electronic accessory case 342 (e.g., detected at an arbitrary portion of the housing of the electronic accessory case 342). For example, the one or more tap inputs are optionally directed to an exterior of the electronic accessory case 342. Optionally, the one or more tap inputs are directed to an exterior of the electronic accessory case 342 near the status indicator 348. In some embodiments, the one or more inputs 512 are the same as type of input as the one or more inputs 502 (as shown in FIGS. 5A-5B) and/or the one or more inputs 506 (as shown in FIGS. 5C-5D). In some embodiments, as shown in section 503, the one or more inputs 512 include one or more squeeze inputs (e.g., a first portion of a squeeze input 512-1 and a second portion of a squeeze input 512-2). Like the one or more tap inputs, the one or more squeeze inputs are optionally directed to any region of the electronic accessory case 342. In some embodiments, the one or more squeeze inputs are detectable at (e.g., only detectable at) portions of the exterior of electronic accessory case 342 that are capable of moving (e.g., bending, flexing, or otherwise moving) in response to the one or more squeeze inputs. For example, edges and/or corners of the electronic accessory case 342 may not be responsive to squeeze inputs, whereas non-edge regions (e.g., central regions of the exterior) may be responsive. In some embodiments, non-edge regions of the electronic accessory case 342 are configured to move in response to the one or more squeeze inputs (e.g., move a sufficient amount to be detected by one or more sensors). In some embodiments, sensors (e.g., of the electronic accessory case 342 and/or the electronic accessories) are configured to detect movement of an exterior of the electronic accessory case 342 caused by squeeze inputs (e.g., squeeze inputs at central regions of the exterior).

In some embodiments, the one or more inputs 512 are detected via one or more movement sensors of the electronic accessory case 342 and/or the one or more electronic accessories (e.g., the wearable audio output devices 301). For example, the one or more movement sensors are optionally a component of the electronic accessory case 342. In some embodiments, the movement sensors are included in the one or more electronic accessories, and the one or more electronic accessories are communicatively coupled with the electronic accessory case 342 such that the one or more inputs 512 that are detected via the one or more movement sensors associated with the one or more electronic accessories are communicated to the electronic accessory case 342.

FIG. 5F illustrates an absence of a response from electronic accessory case 342 to the one or more inputs 512 of FIG. 5E. In some embodiments, because the electronic accessory case 342 is not in the one or more respective configurations, the electronic accessory case 342 forgoes monitoring for the one or more inputs 512, detecting the one or more inputs 512, processing the one or more inputs 512, and/or performing operations associated with the one or more inputs 512. In some embodiments, forgoing monitoring for and/or detecting the one or more inputs 512 includes operating the one or more movement sensors into a low-powered state (e.g., a sleep mode and/or an idle mode). For example, movement sensors coupled with the electronic accessory case 342 and/or the one or more electronic accessories are optionally maintained in a low-powered state while the electronic accessory case 342 is not in one of the one or more respective configurations. In some embodiments, the movement sensors are operated in an active state (e.g., a state for monitoring and/or detecting the one or more inputs 502, and/or a higher-powered state as compared to the low-powered state) while the electronic accessory case 342 is (e.g., in response to the electronic accessory case 342 being) reconfigured to a configuration of the one or more respective configurations (e.g., the first configuration). For example, the electronic accessory case 342 optionally ignores any and/or all of the one or more inputs 512 while the electronic accessory case 342 is not in the one or more respective configurations.

In some embodiments, forgoing processing the one or more inputs 512 includes forgoing determining whether the one or more inputs 512 are associated with (e.g., correspond to and/or mapped to) an operation. In some embodiments, the processing of the one or more inputs 512 is performed at the electronic accessory case 342 and/or at the portable multifunction device 100. In one example, information associated with the one or more inputs 512 is optionally received and/or detected at the electronic accessory case 342 while the electronic accessory case 342 is not in the one or more respective configurations. In this example, processing of the one or more inputs 512 is forgone (e.g., not processed at the electronic accessory case, information associated with the one or more inputs 512 is not communicated from the electronic accessory case 342 to the portable multifunction device 100, and/or not processed at the portable multifunction device 100).

In some embodiments, forgoing operations associated with the one or more inputs 512 includes not performing operations associated with the electronic accessory case 342 and/or the one or more electronic accessories. For example, if the one or more inputs 512 are associated with an operation (e.g., pausing media), the operation is note performed because the electronic accessory case 342 is not in the one or more respective configurations.

FIG. 5G shows an input 514 directed to the electronic accessory case 342 while the electronic accessory case 342 is in a second configuration of the one or more respective configurations. In some embodiments, the input 514 is an input 514 (e.g., a long press input). In some embodiments, the input 514 is a held squeeze gesture. For example, in some embodiments, the input 514 is received while the lid 344 of the electronic accessory case 342 is in an open state while the one or more electronic accessories are within the electronic accessory case 342. In some embodiments, the input 514 is directed to an arbitrary region of the electronic accessory case 342. For example, the input 514 is optionally detected at an exterior (e.g., housing) of the electronic accessory case 342. In some embodiments, the input 514 is detected via one or more of the movement sensors described herein.

FIG. 5H illustrates a transition from FIG. 5G in response to detecting the input 514. FIG. 5G shows the electronic accessory case 342 in communication with the portable multifunction device 100 while the electronic accessory case 342 is in the second configuration of the one or more respective configurations. In response to the input 514 (as shown in FIG. 5G) (e.g., and because the electronic accessory case 342 is in one of the one or more respective configurations), the electronic accessory case 342 (and/or the electronic accessories) performs one or more operations associated with the one or more inputs 514 (e.g., pairing operations). In some embodiments, in response to the input 514, the electronic case 342 initiates a pairing operation by communicating a pairing request to the electronic accessories (e.g., and the electronic accessories subsequently complete the pairing operation with the device 100 without further involvement from the electronic case 342). In some embodiments, the input 514 is detected via sensors of the electronic accessories and the electronic accessories subsequently complete the pairing operation with the device 100 without involvement from the electronic case 342. In FIG. 5H, the one or more operations include providing audio output 516. For example, in response to the input 514 while the electronic accessory case 342 is in the second configuration, audio output 516 is provided and indicates a pairing state for the electronic accessory case 342 (e.g., initiating pairing of the electronic accessory case 342 and/or the one or more electronic accessories with the portable multifunction device 100).

In some embodiments, the one or more operations include illuminating the status indicator 348 in response to the input 514 (FIG. 5G) and/or based on the status of the pairing sequence between the electronic accessory case 342 and/or the one or more electronic accessories with the portable multifunction device 100. For example, the status indicator 348 optionally illuminates with a predefined sequence based on the status of the pairing sequence. For example, the status indicator 348 optionally illuminates with a first predefined sequence (e.g., slowly pulsing on and off) while the electronic accessory case 342 and/or the one or more electronic accessories are detected as available to pair (e.g., with the portable multifunction device 100). In some embodiments, the status indicator 348 illuminates with a second predefined sequence (e.g., quick flashing) when or while the electronic accessory case 342 and/or the one or more electronic accessories are pairing with the portable multifunction device 100. In some embodiments, the status indicator 348 illuminates with a third predefined sequence (e.g., solid illumination) when (e.g., in response to) the electronic accessory case 342 and/or the one or more electronic accessories have successfully paired with the portable multifunction device.

In some embodiments, in response to the input 514 shown in FIG. 5G, a pairing interface 517 is displayed as shown on portable multifunction device 100 in FIG. 5H. As an example, the pairing interface 517 optionally provides information indicating that the electronic accessory case 342 and/or the electronic accessories are not currently paired with the portable multifunction device 100 (and are available to pair with the portable multifunction device 100). The pairing interface 517 optionally provide an affordance 519 to allow pairing between the electronic accessory case 342 and/or the electronic accessories with the portable multifunction device 100. In various embodiments, the pairing interface 517 is displayed over a home screen user interface 515 (e.g., a user interface with one or more application icons to launch one or more applications), over a lock screen user interface (e.g., a user interface displayed when the device is in a locked state), and/or over an application screen user interface (e.g., a user interface associated with a respective application).

FIG. 5I shows a transition from FIG. 5H in response to ceasing to detect the input 514 (e.g., detecting that the input 514 has ended) prior to the completion of the respective operation (e.g., pairing of the electronic accessory case 342 and/or the one or more electronic accessories with the portable multifunction device 100). Detecting the end of the input 514 optionally includes no longer detecting any input, including the input 514, or detecting a lift-off associated with the input 514. In some embodiments, ceasing to detect the input 514 includes detecting a new input that is different from the input 514 (e.g., detecting an input other than the input 514). In some embodiments, the input 514 ceases to be detected while the electronic accessory case 342 remains in the second configuration of the one or more respective configurations.

In some embodiments, in response to ceasing to detect the input 514 prior to the completion of the respective operation, the respective operation associated with the input 514 terminates. For example, the respective operation optionally terminates while the respective operation is ongoing (e.g., has not completed). The pairing sequence (as described with respect to FIG. 5H) terminates in response to ceasing to detect the input 514. In some embodiments, the respective operation terminates without completion in response to ceasing to detect the input 514. For example, the pairing sequence optionally terminates prior to successfully pairing the electronic accessory case 342 and/or the one or more electronic accessories.

In some embodiments, termination of the respective operation causes one or more outputs to be provided as feedback to the user. For example, the one or more outputs optionally include an audio output 518. In the example of FIG. 5I, the audio output 518 indicates that the reason for the termination of the respective operation is that the input is no longer detected. In accordance with some embodiments, in response to the termination of the respective operation, the electronic accessory case 342 outputs audio output 518 regarding the cancellation (e.g., termination) of the pairing sequence. In some embodiments, the one or more outputs include the status indicator 348 illuminating (e.g., illuminating red, orange, or another color) to indicate that the pairing sequence has been terminated. In some embodiments, the one or more outputs include ceasing to display the pairing interface 517 over the home screen 515 (as shown in FIG. 5H).

FIG. 5J shows a transition from FIG. 5H (e.g., an alternative to the transition to FIG. 5I) in response to the electronic accessory case 342 transitioning from the second configuration prior to the completion of the respective operation (e.g., pairing of the electronic accessory case 342 and/or the one or more electronic accessories with the portable multifunction device 100). For example, the electronic accessory case 342 in FIG. 5J is no longer in the second configuration because the lid 344 of the electronic accessory case 342 has been closed, causing the electronic accessory case 342 to be in the closed state (FIG. 5J) and/or because the one or more electronic accessories are no longer placed within (e.g., are removed from) the electronic accessory case 342 prior to the completion of the pairing operation. In some embodiments, the change in configuration such that the electronic accessory case 342 is no longer in the second configuration occurs while the input 514 is still detected. For example, the pairing operation terminates in response to the electronic accessory case 342 transitioning from the second configuration without regard to whether the input 514 is maintained. In some embodiments, the respective operation terminates without completion in response to the electronic accessory case 342 transitioning from the second configuration.

In some embodiments, termination of the respective operation causes one or more outputs to provide feedback to the user. For example, the one or more outputs optionally include an audio output 520. In the example of FIG. 5J, the audio output 520 indicates that the reason for the termination of the respective operation is that the electronic accessory case 342 is no longer in the second configuration. For example, in response to the termination of the respective operation, the electronic accessory case 342 optionally provides audio output 520 indicating the cancellation (e.g., termination) of the pairing sequence. In some embodiments, the one or more outputs include the status indicator 348 illuminating to indicate that the pairing sequence has been terminated. In some embodiments, the one or more outputs include ceasing to display the pairing interface 517 over the home screen 515 (as shown in FIG. 5H).

FIG. 5K shows a transition from FIG. 5H (e.g., an alternate transition to FIG. 5I or 5J) in which an input 521 is detected at the affordance 519 in the pairing interface 517 on the portable multifunction device 100 to confirm pairing between the electronic accessory case 342 and/or the electronic accessories with the portable multifunction device 100. In FIG. 5K, the input 514 is maintained while the input 521 is directed to (e.g., detected at and/or received at) the affordance 519 to confirm the pairing. For example, the input 514 is maintained until after the input 521 is received at the affordance 519 to initiate pairing. After pairing has been completed, the input 514 may end without causing the pairing operation to terminate.

In some embodiments, the input 514 is required to be maintained throughout the pairing operation. For example, the input 514 is maintained while the input 521 is received at the affordance 519 to confirm pairing, and is maintained after the input 521 has been received and a pairing operation is being performed until the pairing operation is complete (e.g., the electronic accessory case 342 and the one or more electronic accessories are paired with the portable multifunction device 100). In some embodiments, the input 514 is required to be maintained until the pairing interface 517 is displayed. For example, the input 514 is maintained until the pairing interface 517 is displayed, after which the input 514 may end without causing the pairing interface 517 to cease to be displayed and without causing the pairing operation to terminate. In some embodiments, a second input (e.g., distinct from the input 514) is directed to (e.g., detected at and/or received at) the electronic accessory case 342 to confirm the pairing operation. For example, a tap input (or any other type of input) is optionally received at the electronic accessory case 342 to confirm the pairing operation, optionally while the pairing interface 517 is displayed on the portable multifunction device 100.

FIG. 5L shows a transition from FIG. 5K in which the pairing operation between the electronic accessory case 342 and/or the one or more electronic accessories with the portable multifunction device 100 has been completed. In some embodiments, completion of the respective operation (e.g., the pairing operation) results in one or more outputs to provide feedback to the user. For example, the one or more outputs optionally include an audio output 522. In the example of FIG. 5L, the audio output 522 indicates that the pairing operation has been performed successfully. In some embodiments, the one or more outputs include the status indicator 348 illuminating (e.g., illuminating green, blue, or another color) to indicate that the pairing sequence has been performed successfully. In some embodiments, the one or more outputs include displaying connection interface 523 to indicate that the electronic accessory case 342 and the one or more electronic accessories have been connected to (e.g., paired with) the portable multifunction device 100.

In some embodiments, the connection interface 523 includes information regarding the electronic accessory case 342 and/or the one or more electronic accessories. For example, the information optionally include a battery status of the electronic accessory case 342 and/or the one or more electronic accessories. Optionally, the information includes a state of the electronic accessory case 342 and/or the one or more electronic accessories, such as whether the electronic accessory case 342 is in an open or closed configuration.

In some embodiments, the connection interface 523 is displayed over the home screen user interface 515 (e.g., a user interface with one or more application icons to launch one or more applications), over the lock screen user interface (e.g., a user interface when the device is in a locked state), and/or over the application screen user interface (e.g., a user interface associated with a respective application).

FIG. 5M shows the electronic accessory case 342 and/or the one or more electronic accessories in communication with, and paired with, the portable multifunction device 100 while the electronic accessory case 342 is in the first configuration of the one or more respective configurations (e.g., with the lid 344 closed and the one or more electronic accessories within the electronic accessory case 342).

In FIG. 5M, an input 526 is detected at the electronic accessory case 342. For example, the input 526 includes a tap input, a tap-and-hold input, a squeeze input, and/or other type of input. As an example, the input 526 optionally includes a single tap (e.g., the tap input) followed by a second tap with a hold (e.g., a tap-and-hold input). In some embodiments, the input 526 includes a multi-tap input, such as a double-tap input or a triple-tap input. In some embodiments, the input 526 is detected at an arbitrary region of the electronic accessory case 342. For example, the input 526 is optionally detected at an exterior of the electronic accessory case 342. In some embodiments, different portions of the input 526 are detected at different locations on the electronic accessory case 342. For example, a first portion of the input (such as a first tap input) is optionally directed to a first portion of the electronic accessory case 342, and a second portion of the input (such as a second tap input) is optionally directed to a second portion of the electronic accessory case 342, distinct from the first portion of the electronic accessory case. In some embodiments, the different portions of the input 526 are directed to a same portion of the electronic accessory case 342. In the example of FIGS. 5M-5O, the input 526 corresponds to a factory reset operation.

FIG. 5N shows a transition from FIG. 5M in response to detecting the input 526 (e.g., in accordance with a factory reset operation being initiated for the electronic accessory case 342 and/or the one or more electronic accessories). FIG. 5N further shows an audio output 528 being provided in response to detecting the input 526. In some embodiments, an audio output 528 is provided (e.g., via the electronic accessory case 342 and/or via portable multifunction device 100) to indicate that a respective operation has been performed (e.g., a factory reset operation has been initiated) in response to detection of the input 526. In some embodiments, a confirmation interface 529 is displayed (e.g., via the portable multifunction device 100) in response to the input 526 being detected. The confirmation interface 529 optionally provide instructions to confirm the respective operation. For example, the confirmation interface 529 includes instructions to shake the case to complete the factory reset operation that was initiated by the input 526. In some embodiments, a confirmation input (e.g., a shake input) is required to confirm the initiated operation. For example, FIG. 5N shows a shake input 530 being detected at the electronic accessory case 342 to continue the factory reset operation once the factory reset operation has been initiated.

FIG. 5O shows a transition from FIG. 5N in response to the factory reset operation of the electronic accessory case 342 and/or the one or more electronic accessories being completed. In some embodiments, completion of the respective operation (e.g., the factory reset operation) results in one or more outputs to provide feedback to the user. For example, the one or more outputs optionally include an audio output 532. In this example, the audio output 532 indicates that the factory reset operation has been performed successfully. In some embodiments, the one or more outputs include the status indicator 348 illuminating (e.g., illuminating white, blue, or another color) to indicate that the factory reset operation has been performed successfully. In some embodiments, the one or more outputs include displaying factory reset interface 533 to indicate that the electronic accessory case 342 and/or the one or more electronic accessories have been factory reset (e.g., reset to factory default settings, such as to the state of the electronic accessory case 342 and/or the one or more electronic accessories prior to any user setup). For example, the factory reset interface 533 indicates that the one or more electronic accessories are no longer connected and/or paired with the portable multifunction device 100.

In some embodiments, the factory reset interface 533 is displayed over the home screen user interface 515 (e.g., a user interface with one or more application icons to launch one or more applications), over the lock screen user interface (e.g., a user interface when the device is in a locked state), and/or over the application screen user interface (e.g., a user interface associated with a respective application).

FIGS. 6A-6M and 7A-7E illustrate example user interfaces and user interactions for detecting and responding to operational states of components of wearable devices in accordance with some embodiments.

FIG. 6A shows a home screen user interface 606 (also referred to interchangeably as “home screen” and optionally analogous to home screen user interface 515 illustrated throughout FIGS. 5A-5O) of the portable multifunction device 100. FIG. 6A further shows an input 602 (e.g., a swipe down gesture) detected at the portable multifunction device 100. In some embodiments, an input 602 is received at the home screen user interface 606 and corresponds to an operation to display a control center user interface (discussed below with respect to FIGS. 6B and 6C). In some embodiments, the home screen 606 includes one or more application icons for launching one or more respective applications. In some embodiments, the home screen 606 is accessible while the device is in an authenticated state.

In some embodiments, one or more electronic accessories (e.g., right wearable audio output device 301-1 and left wearable audio output device 301-2) are configured to be worn (e.g., donned) by a user. For example, wearable audio output device 301-1 (sometimes called a right electronic device or a right wearable device) is configured to be worn in a right ear 604-1 of a user, and wearable audio output device 301-2 (sometimes called a left electronic device or a left wearable device) is configured to be worn in a left ear 604-2 of the user. In some embodiments, the one or more electronic accessories are a pair of headphones. In this example, a left portion of the headphones (e.g., a left earcup or earphone) is configured to be worn over a user's left ear, and a right portion of the headphones (e.g., a right earcup or earphone) is configured to be worn over a user's right ear. In some embodiments, the one or more electronic accessories are configured to output audio to the user. For example, the audio may be associated with media, one or more notifications, a virtual assistant, an environment, and/or other sources of audio that can be output at the one or more electronic accessories.

FIG. 6B shows a transition from FIG. 6A in response to detection of the input 602 and shows the control center user interface 608. In some embodiments, the control center user interface 608 (also referred to interchangeably as “control center”) includes at least media control module 610 (e.g., a user interface element corresponding to a media application), which controls media playback. For example, the media control module 610 optionally includes a set of media controls that for playing, pausing, fast forwarding, rewinding, moving to a next media item, and/or moving to a previous media item. In FIG. 6B, an input 612 is received at the media controls to initiate and/or continue playback of a media item. In response, the one or more electronic accessories begin outputting audio associated with the media item (as shown in FIG. 6C).

FIG. 6C shows a transition from FIG. 6B in response to the input 612 at the media control module 610, and shows media playback at the one or more electronic accessories (e.g., as indicated by outputs 616 and 618). In some embodiments, in response to the input 612, the portable multifunction device 100 begins media playback and the audio associated with the media is output via the one or more electronic accessories (e.g., wearable audio output device 301-1 and wearable audio output device 301-2). In some embodiments, the media output includes spatialized and/or stereo audio and the one or more electronic accessories output the corresponding portions of the audio. For example, the right electronic accessory 301-1 may output a right portion (e.g., right channel) of a media output and a wearable audio output device 301-2 may output a left portion (e.g., left channel) of the media output. In some embodiments, each wearable audio output device 301 detects (e.g., via microphones or other types of sensors) the corresponding audio output and determines based on the detected audio output whether maintenance is recommended for the wearable audio output device 301.

FIG. 6D shows a transition from FIG. 6C (e.g., in response to starting media playback) and shows an indication that maintenance is recommended for the wearable audio output device 301-2. In some embodiments, in response to starting media playback, an operational state of the one or more electronic accessories is detected. In accordance with a determination that the operational state of at least one of the electronic accessories meets one or more criteria (e.g., the audio output is determined to be muffled, modulated, muted, or otherwise distorted), a maintenance recommendation alert may be generated and outputted. In some embodiments, the one or more criteria relate to whether an audio output component (e.g., a speaker, a protective mesh, a fitting component, or other type of audio output component) is clogged, blocked, obstructed, occluded, and/or otherwise impacted by debris. The presence of debris on and/or in the audio output component may negatively affect performance of the audio output component (e.g., muffling, muting, and/or otherwise distorting audio output. The impact of the debris may negatively affect audio output corresponding to media playback and/or negatively affect environmental noise modulation functions (e.g., active noise cancellation and/or active passthrough).

In some embodiments, the operational state of the one or more electronic accessories is detected based on the output of the media (discussed above with respect to FIG. 6C). In some embodiments, the one or more criteria relate to whether the output of the media is distorted. For example, the operational state of the one or more electronic accessories is optionally based on a comparison between the output of the media and a recording of the outputted media. In this example, one or more microphones associated with the one or more electronic accessories (e.g., the microphones 322) detect the outputted media from the one or more electronic accessories and the detected outputted media is compared with reference media data. In this example, based on differences between the reference media data and the detected media output, an operational state of the one or more electronic accessories is determined. In some embodiments, the one or more criteria relate to whether environmental noise modulation outputs are distorted. For example, the operational state of the one or more electronic accessories is optionally based on a comparison between received environmental audio (e.g., received via microphone 322-2 in FIG. 3H) and active noise cancellation outputs (e.g., as described in FIG. 3L).

In some embodiments, as illustrated in FIG. 6D, a maintenance alert 622 is displayed at the portable multifunction device 100. In accordance with some embodiments, the maintenance alert 622 includes an affordance 624 for obtaining more information regarding the maintenance of the one or more electronic accessories. For example, the information optionally concerns and/or includes instructions for disassembly (discussed below with respect to FIG. 6K), cleaning (discussed below with respect to FIG. 6L), and/or reassembly (discussed below with respect to FIG. 6M). The maintenance alert 622 additionally identifies the electronic accessory for which maintenance is recommended. In some embodiments, an indication that maintenance is recommended is output at the electronic accessory for which maintenance is recommended. For example, the maintenance alert is associated with the wearable audio output device 301-2 and an audio alert 620 indicating the maintenance recommendation is output at the wearable audio output device 301-2.

FIG. 6E shows a transition from FIG. 6C (e.g., an alternative to the transition to FIG. 6D) in response to starting media playback, and shows an indication that maintenance is recommended for wearable audio output device 301-1. In some embodiments, in response to starting media playback, an operational state of the one or more electronic accessories is detected. In accordance with a determination that the operational state of at least one of the electronic accessories meets one or more criteria, a maintenance recommendation alert is generated and provided to the user. In some embodiments, the operational state of the one or more electronic accessories is detected based on the output of the media (discussed above with respect to FIG. 6C).

In some embodiments, as illustrated in FIG. 6E, the maintenance alert 628 is displayed at the portable multifunction device 100. The maintenance alert 628 optionally includes an affordance 630 for more obtaining information regarding the maintenance of the one or more electronic accessories. In some embodiments, the maintenance alert 628 is the same as the maintenance alert 622 (FIG. 6D) described above, except that the maintenance alert 628 indicates that maintenance is recommended for the right accessory while the maintenance alert 622 indicates that maintenance is recommended for the left accessory. In some embodiments, an indication that maintenance is recommended is output at the electronic accessory for which maintenance is recommended. For example, FIG. 6E shows wearable audio output device 301-1 providing audio output 626 indicating that maintenance is recommended.

FIG. 6F shows a transition from FIG. 6C (e.g., an alternative to the transition to FIG. 6D or 6E) in response to starting media playback, and shows an indication, via maintenance alert 636, that maintenance is recommended for both of the wearable audio output devices 301. The maintenance alert 636 optionally includes an affordance 638 for more obtaining information regarding the maintenance of the one or more electronic accessories. In some embodiments, the operational state of the one or more electronic accessories is detected based on the media output (discussed above with respect to FIG. 6C). In some embodiments, as illustrated in FIG. 6F, the maintenance alert 636 is displayed at the portable multifunction device 100. In some embodiments, the maintenance alert 636 is the same as the maintenance alert 622 (FIG. 6D) described above, except that the maintenance alert 636 indicates that maintenance is recommended for both accessories while the maintenance alert 622 indicates that maintenance is recommended for the left accessory. In some embodiments, the indication includes an alert output at each of the wearable audio output devices 301. For example, FIG. 6F shows wearable audio output device 301-1 providing audio output 634 indicating that maintenance is recommended and wearable audio output device 301-3 providing audio output 632 indicating that maintenance is recommended.

FIG. 6G shows a wake screen 640 of the portable multifunction device 100 that includes a maintenance recommendation 642 for the right electronic accessory. In some embodiments, the maintenance recommendation 642 is provided in response to a maintenance determination being performed while the portable multifunction device 100 is in a locked state and/or a sleep state. For example, the user causes media to playback at the wearable audio output devices 301 via an input at the wearable audio output devices 301 or at an accessory case for the wearable audio output devices 301, while the portable multifunction device 100 is in a sleep and/or locked state. In some embodiments, the maintenance recommendation 642 includes information regarding which electronic accessory for which maintenance is recommended. In some embodiments, the maintenance recommendation 642 is configured to be responsive to a user selection and, when activated, causes display of instructions for performing maintenance on the one or more electronic accessories.

As used herein, a wake screen (also sometimes called a lock screen or a lock screen user interface) is a user interface that is displayed after the display of device 100 has entered a low power state during which the display is at least partially off. In some embodiments, in the low power state, the display optionally displays an “always on” indicator of a time and/or date and the device displays the wake screen user interface when the device is prompted to come out of the low power state. In some embodiments, optionally in response to a user input and/or in response to a threshold amount of time elapsing, the device enters a locked state in which a password, passcode and/or biometric authentication is required to unlock the device, wherein the device has limited functionality in the locked state and must be unlocked before accessing respective applications and/or data stored on device 100. In some embodiments, the wake screen user interface is displayed regardless of whether the device is in the locked state or has already been unlocked (e.g., the wake screen user interface is displayed upon waking the device before the user accesses a home screen user interface and/or other application user interfaces). In some embodiments, one or more alerts (e.g., system alerts and/or notifications) are displayed on the wake screen user interface, optionally in response to a user input (e.g., a swipe gesture upward in the middle of the display or another gesture). FIG. 6H shows a home screen user interface 606 with an icon 643 corresponding to a settings user interface (e.g., configured to launch a settings application upon activation). FIG. 6H further shows an input 644 detected at the icon 643.

FIG. 6I illustrates a transition from FIG. 6H in response to the input 644, and shows a settings user interface 650 with notification 652 and badge 654 corresponding to the wearable audio output devices 301. In accordance with some embodiments, the settings user interface 650 includes a plurality of controls for various features of the device 100 and/or associated devices (e.g., connectivity settings, notification settings, account settings, sound and haptics settings, and/or other types of settings and/or information). In some embodiments, the badge 654 indicates a number of action items for the user for a respective notification (e.g., associated with the wearable audio output devices 301). In some embodiments, action items include a maintenance recommendation, an update recommendation, a configuration recommendation, and/or other types of action items. For example, the action items optionally include a charging recommendation. In some embodiments, the action items indicate new features and/or features that have not yet been activated and/or used by the user. FIG. 6I further shows input 656 detected at a location corresponding to the notification 652.

FIG. 6J illustrates a transition from FIG. 6I in response to the input 656, and shows an electronic accessory settings user interface 660. In the example of FIG. 6J, the electronic accessory settings user interface 660 includes a maintenance notification 662 indicating that maintenance is recommended for the electronic accessories (e.g., the wearable audio output devices 301). In accordance with some embodiments, the notification 662 includes an affordance 664 for obtaining instructions for performing maintenance on the one or more electronic accessories. The electronic accessory settings user interface 660 optionally includes a plurality of controls for various features for the electronic accessories (e.g., noise control settings, input mapping settings, identification settings, and/or other types of settings and/or information). For example, the electronic accessory settings user interface 660 optionally includes settings for changing a name of the one or more electronic accessories, settings for changing a noise control (e.g., noise cancellation and/or transparency mode) of the one or more electronic accessories, and/or settings for changing the input scheme at each of the one or more electronic accessories. FIG. 6J further shows an input 666 detected at a location corresponding to the affordance 664. As described herein with reference to FIGS. 6K-6M, in some embodiments, the instructions for electronic accessory maintenance are presented in a series of user interfaces (e.g., information cards), including for example a disassembly user interface 670, a cleaning user interface 680, and/or an assembly user interface 690. In some embodiments, more or fewer instructions for electronic accessory maintenance are provided, and the instructions are optionally presented in more or fewer user interfaces (e.g., information cards), than described herein.

FIG. 6K illustrates a transition from FIG. 6J in response to input 666, and shows a user interface 670 with instructions 676 for disassembling an electronic accessory (e.g., the wearable audio output device 301-1 or the wearable audio output 301-2). The disassembly user interface 670 in FIG. 6K includes an exit affordance 672 to close (e.g., cease to display) the instructions for disassembly, a visual aid 674 (e.g., a drawing or animation) to show how to disassemble the electronic accessory, instructions 676 describing how to disassemble the electronic accessory, and an affordance 678 to proceed to the next step in the maintenance process (e.g., to show a subsequent user interface corresponding to the maintenance process).

In some embodiments, the disassembly user interface 670 includes information based on a type of electronic accessory for which maintenance is recommended. In some embodiments, the disassembly user interface 670 includes information based on which electronic accessory of a set of electronic accessories for which maintenance is recommended. For example, if the wearable audio output device 301-1 requires maintenance, the disassembly user interface includes instructions for disassembling a right electronic device without instructions for disassembling a left electronic device. In another example, if the wearable audio output device 301-2 requires maintenance, the disassembly user interface provides instructions for disassembling the left electronic device without providing instructions for disassembling the right electronic device. In some embodiments, the disassembly user interface 670 includes information based on which component of an electronic accessory for which maintenance is recommended. FIG. 6K further shows an input 679 detected at a location corresponding to the affordance 678.

FIG. 6L illustrates a transition from FIG. 6K in response to detecting the input 679, and shows a cleaning user interface 680 with instructions 686 for cleaning the electronic accessory. The cleaning user interface 680 optionally includes an exit affordance 672 to exit (e.g., close) the cleaning user interface 680, a visual aid 684 (e.g., a schematic, image, animation, and/or other type of visual aid) to show how to clean the electronic accessory, an affordance 682 to return to the previous step in the maintenance process (e.g., the disassembly user interface 670), and an affordance 688 to proceed to the next step in the maintenance process (e.g., the assembly user interface 690). FIG. 6L further shows an input 689 detected at a location corresponding to the affordance 688.

In some embodiments, the cleaning user interface 680 includes information based on a type of electronic accessory for which maintenance is recommended. In some embodiments, the cleaning user interface 680 includes information based on which electronic accessory of a set of electronic accessories for which maintenance is recommended. For example, if the wearable audio output device 301-1 requires maintenance, the cleaning user interface includes instructions for cleaning a right electronic device without instructions for cleaning a left electronic device. In another example, if the wearable audio output device 301-2 requires maintenance, the cleaning user interface provides instructions for cleaning the left electronic device without providing instructions for cleaning the right electronic device. In yet another example, when both wearable audio output devices 301 require maintenance, the cleaning user interface provides instructions for cleaning both devices.

FIG. 6M illustrates a transition from FIG. 6L in response to detecting the input 689, and shows instructions 696 for reassembling the electronic accessory. The instructions 696 for assembling the one or more electronic accessories are displayed at an assembly user interface 690. The assembly user interface 690 optionally includes an exit affordance 672 to close the assembly user interface 690, a visual aid 694 (e.g., a schematic, an image, an animation, a video, and/or other type of visual aid) to show how to assemble the electronic accessory, an affordance 692 to return to the previous step in the maintenance process (e.g., the disassembly user interface 680), and/or an affordance 698 to proceed to the next step in the maintenance process (e.g., to complete the maintenance process and cease to show the assembly user interface 690).

In some embodiments, the assembly user interface 690 includes information based on a type of electronic accessory for which maintenance is recommended. In some embodiments, the assembly user interface 690 includes information based on which electronic accessory of a set of electronic accessories for which maintenance is recommended. For example, if the wearable audio output device 301-1 requires maintenance, the assembly user interface includes instructions for assembling a right electronic device without instructions for assembling a left electronic device. In another example, if the wearable audio output device 301-2 requires maintenance, the assembly user interface provides instructions for assembling the left electronic device without providing instructions for assembling the right electronic device. In yet another example, when both wearable audio output devices 301 require maintenance, the assembly user interface provides instructions for assembling both devices.

FIG. 7A shows an alternative trigger condition for determining the operational state of the one or more electronic accessories. In some embodiments, the trigger condition for determining the operational state includes donning of the one or more electronic accessories. For example, in accordance with a determination that (or in response to) at least one of the one or more electronic accessories is being donned and/or has been successfully donned, the operational state of at least one of the one or more electronic accessories is determined. In some embodiments, the operational state of multiple of the one or more electronic accessories is determined in response to one of the one or more electronic accessories being donned. For example, if the left electronic accessory (e.g., wearable audio output device 301-2) was previously donned by the user (e.g., and is currently being worn, and a determination of the operational state was made when the left electronic accessory was donned), and the right electronic accessory is being donned, the operational states of both the left electronic accessory and the right electronic accessory are determined (e.g., the operational state of the left electronic accessory is determined a second time). In some embodiments, only the operational state of the electronic accessory being donned is determined. For example, in response to the right electronic accessory being donned, the operational state of the right electronic accessory is determined. In this example, the operational state(s) of other electronic accessories (e.g., including the left electronic accessory) are not determined in response to detecting the right electronic accessory being donned.

FIG. 7B shows an alternative embodiment of the one or more electronic accessories. As shown in FIG. 7B, the one or more electronic accessories are optionally a single integrated electronic accessory 704 (e.g., a headset, a pair of headphones, or other type of single electronic accessory) worn by user 702, which optionally includes a right earcup 706-1 and/or a left earcup 706-2. In some embodiments, actions (e.g., determinations and operations) such as those described herein as being performed with respect to right electronic accessories (e.g., the wearable audio output device 301-1) may be performed with respect to right earcup 706-1, and actions such as those described herein as being performed with respect to the left electronic accessories (e.g., the wearable audio output device 301-2) may be performed with respect to the left earcup 706-2.

In some embodiments, donning of the single integrated electronic accessory 704 is determined based on data from one or more proximity sensors (e.g., within the right earcup 706-1 and/or left earcup 706-2). In some embodiments, the instructions for maintenance of the one or more electronic accessories (e.g., as described herein with reference to FIGS. 6A-6M) include instructions that are specific to the single integrated electronic accessory 704. For example, the disassembly instructions described herein with reference to FIG. 6K include instructions for disassembling the single integrated electronic accessory 704, the cleaning instructions described herein with reference to FIG. 6L include instructions for cleaning the single integrated electronic accessory 704, and/or the assembly or reassembly instructions described herein with reference to FIG. 6M include instructions for reassembling the single integrated electronic accessory 704 (e.g., instead of instructions related to the wearable audio output devices 301).

FIG. 7C shows an alternative trigger condition for determining the operational state of the one or more electronic accessories. In some embodiments, the trigger condition for determining the operational state includes placing the one or more electronic accessories (e.g., the wearable audio output devices 301) within an electronic accessory case 342. In some embodiments, determining the operational state is performed while the one or more electronic accessories are within the electronic accessory case 342. For example, an audio output is produced at the right electronic accessory and/or the left electronic accessory while inside the electronic accessory case 342. Analogous to the description of FIG. 6E, one or more microphones associated with the one or more electronic accessories detect (e.g., capture and/or record) the outputted audio from the one or more accessories which is compared with reference audio (e.g., to determine differences between the reference audio and the detected audio).

In some embodiments, the one or more electronic accessories include the single integrated electronic accessory 704, one or more speaker devices, and/or other devices configured to output audio. For example, determining the operational state of the single integrated electronic accessory 704 is optionally performed while the single integrated electronic accessory is being placed in (or has been placed in) a headphone case.

FIG. 7D shows an alternative trigger condition for determining the operational state of the one or more electronic accessories. In some embodiments, the trigger condition for determining the operational state includes removing (e.g., disconnected and/or decoupling) the one or more electronic accessories from the electronic accessory case 342. For example, in response to being removed, the one or more electronic accessories may initiate a process to determine the operational state of the one or more electronic accessories. In some embodiments, the determination is initialized but not performed until the one or more electronic accessories are being donned and/or have been donned, and/or the determination is not performed until a predetermined amount of time has elapsed since the one or more electronic accessories were removed from the electronic accessory case 342. In some embodiments, the operational state is determined for whichever ones of the one or more electronic accessories are removed from the electronic accessory case 342 (and optionally donned) (e.g., the operational state is not determined for any of the one or more electronic accessories that remain in the electronic accessory case 342). In some embodiments, operational states are determined for multiple (e.g., all) electronic accessories in response to a single electronic accessory being removed from the electronic accessory case 342.

FIG. 7E shows an alternative maintenance recommendation alert 714 for one or more speakers (e.g., an alternative to the maintenance alert 622 shown in FIG. 6D). In the example of FIG. 7E, the maintenance recommendation alert 714 is displayed over a portion of a control center user interface 712. In some embodiments, the one or more speakers are components of the single integrated electronic accessory 704 (FIG. 7B). For example, a first speaker is positioned within the left earcup 706-2 of single integrated electronic accessory 704, and a second speaker is positioned within the right earcup 706-1 of single integrated electronic accessory 704. In some embodiments, the maintenance recommendation alert 714 is displayed in situations in which an electronic accessory includes more than one speaker (or other type component requiring maintenance).

In some embodiments, maintenance recommendation alert 714 includes a reference 716 to information regarding the maintenance. For example, the information includes maintenance information such as how to disassemble, clean, and/or reassemble the one or more speakers of the single integrated electronic accessory 704 (e.g., analogous to the user interfaces shown and described in FIGS. 6K-6M). In some embodiments, in accordance with a determination that an input is received associated with the reference 716, the information is displayed as a new interface; the maintenance recommendation alert is expanded and the information is displayed within the expanded maintenance recommendation alert; a web browser is opened and the information is displayed within the web browser; and/or other user interfaces configured to display text, audio, and/or visual information are provided.

FIGS. 8A-8C are flow diagrams illustrating method 800 of interacting with an accessory case to perform one or more operations in accordance with some embodiments. Method 800 is performed at a computer system (e.g., the wearable audio output devices 301, the electronic accessory case 342, and/or the portable multifunction device 100). For example, the computer system is optionally an accessory case, one or more accessories that are in communication with the accessory case, and/or a device that is configured to receive audio from the one or more accessories. In some embodiments, the computer system includes one or more movement sensors. Some operations in method 800 are, optionally, combined and/or the order of some operations is, optionally, changed.

As described below, method 800 provides an improved interface for causing respective operations to be performed in response to inputs detected at an accessory case. Providing a means (e.g., a user-device interface) for initiating and/or controlling operations, such as indicating battery status, initiating/confirming pairing, and initiating/confirming resetting, reduces power usage and improves battery life (e.g., by alleviating the need to power a display or power communication circuitry to communicate with a remote display) and allows for a user to not have to switch between multiple devices to interact with the accessory case (e.g., the user need not find/switch to other electronic devices (e.g., a smartphone or tablet) to control the accessory case). Additionally, the number of inputs needed for the user to cause the respective operations may be reduced, the operability of accessory case may be enhanced, and the user-device interface may be more efficient (e.g., by helping the user to achieve an intended outcome and reducing user mistakes when operating/interacting with the electronic accessory case), which, additionally, reduces power usage and improves battery life of the accessory case by enabling the user to use the accessory case more quickly and efficiently.

The computer system detects (802) one or more inputs at an accessory case (e.g., the electronic accessory case 342) that is in communication with one or more accessories (e.g., the wearable audio output devices 301), and the one or more inputs are detected via one or more movement sensors (e.g., the sensors 331 and/or the sensors 351). For example, the one or more movement sensors are one or more inertial measurement units (IMUs), accelerometers, and/or other sensors that detect movement of one or more devices in space) (e.g., one or more movement sensors in the accessory case and/or one or more movement sensors in one or more of the accessories). In some embodiments, the computer system is, or includes, the accessory case and/or the one or more accessories. In some embodiments, the accessory case is in communication with the one or more accessories when the accessory case is communicatively coupled to the one or more accessories (e.g., the accessory case is connected to the one or more accessories via a wireless and/or wired connection). For example, the accessory case may be in communication with the one or more accessories while the one or more accessories are placed in and/or enclosed within the accessory case. In some embodiments, detecting and/or processing the one or more inputs is performed the accessory case and/or the one or more accessories. For example, the one or more inputs at the accessory case may be detected via the one or more movement sensors (of the one or more accessories) and the inputs may be sent to the accessory case for processing to determine whether the one or more inputs are the first type of input or a second type of input. In some embodiments, the one or more movement sensors are components of the accessory case. In some embodiments, the one or more movement sensors are components of the one or more accessories. For example, each of the one or more accessories may include at least one movement sensor.

In some embodiments, the one or more accessories include one or more wearable accessories (e.g., a watch, a headset, headphones, and/or earbuds). In some embodiments, the one or more accessories include one or more wearable audio output devices, such as one or more earbuds and/or one or more headsets. In some embodiments, the accessory case is a wearable audio output case.

As an example, the one or more inputs include a tap gesture, a squeeze gesture, and/or other type of gesture. In some embodiments, the one or more inputs comprise two or more of: a tap gesture, a squeeze gesture, a lid opening gesture, a lid closing gesture, and/or a shake gesture. In some embodiments, the first type of input meets one or more movement criteria (e.g., speed, acceleration, and/or displacement criteria). For example, the one or more movement criteria may include a threshold corresponding to a maximum velocity, acceleration, and/or movement for the input, a threshold corresponding to a mean or mode velocity, acceleration, and/or movement during the input, and/or other types of criteria. In some embodiments, the first type of input meets one or more force criteria. For example, the one or more force criteria may include one or more momentary spikes in force (e.g., one or more tap inputs). In some embodiments, the force one or more criteria include one or more sustained forces (e.g., one or more squeeze inputs).

In some embodiments, the one or more inputs are detected by a sensor other than a physical (e.g., mechanical) button or other type of physical affordance. In some embodiments, the one or more inputs are detected by a sensor other than a touch sensor (e.g., a touch-sensitive surface or touch-sensitive screen). In some embodiments, the one or more inputs are detected by a sensor that is a different location than where the input is applied (e.g., the input is applied on at a first position on a housing and the sensor is arranged behind a second position on the housing). Detecting inputs without requiring a physical button or a touch-sensitive surface, allows for the electronic accessory case to be more compact, more energy efficient, and more easily fabricated. Additionally, being able to detect inputs at arbitrary locations on a housing of the electronic accessory case allows a user to interact with the electronic accessory case more efficiently (e.g., without requiring the user to visually locate a button or touch-sensitive surface). Moreover, detecting inputs using sensors that are also used other purposes (e.g., determining positioning/orientation of the case) allows for a more compact, lower power, and/or simpler case.

In some embodiments, the accessory case is configured to supply power to the one or more accessories (e.g., via the accessory charger 368). In some embodiments, an accessory case includes an internal battery (e.g., the battery 367), and the internal battery is configured to charge one or more accessories (e.g., so that the one or more accessories can be used while separated from the accessory case after being charged). In some embodiments, the accessory case is configured to supply power to the one or more accessories while the one or more accessories are mounted (or otherwise attached) to the accessory case. For example, the one or more accessories may be mechanically and/or electrically coupled with the accessory case. As another example, the one or more accessories may be placed within the accessory case to facilitate charging (e.g., the one or more accessories may dock with the accessory case). Providing power to the one accessories and providing an interface for user inputs improves the functionality of the accessory case provides a more efficient user-device interface by reducing the number of inputs and/or actions needed to provide power and initiating commands.

In some embodiments, the first type of input includes (804) one or more tap inputs (e.g., the input 506 in FIG. 5C). In some embodiments, the one or more tap inputs comprise one or more tap inputs on a housing, an interior, and/or other component of the accessory case. In some embodiments, the first type of input comprises one or more tap inputs and one or more non-tap inputs (e.g., a deep press input, a long press input, a squeeze input, and/or other type of input). For example, the first type of input may include one or more tap inputs followed by a held input (e.g., a squeeze input, a long press input, or other type of held input). In some embodiments, the first type of input consists of one or more tap inputs (e.g., a preset number of tap inputs). In some embodiments, the one or more tap inputs are detected and/or received via one or more touch sensors, one or more accelerometers, one or more inertial measurement units, one or more force sensors, one or more movement sensors, one or more proximity sensors, one or more cameras, one or more light and/or optical sensors, and/or other sensors configured to detect inputs (e.g., tap inputs). Detecting and responding to tap inputs (e.g., directed to a housing of the electronic accessory case) may reduce the number of inputs needed to initiate respective operations and provides an improved user-device interface (e.g., a more intuitive interface).

In some embodiments, the one or more inputs include (806) a first tap input and a second tap input, and the first type of input include two tap inputs detected within a predefined time threshold of one another (e.g., the input 506 in FIG. 5C optionally includes two tap inputs). For example, the predefined time threshold may be 2 seconds, 1 second, 0.5 seconds, 0.2 seconds, 0.1 seconds, or 0.05 seconds. In some embodiments, in accordance with a determination that the first tap input and the second tap input are not detected within the predefined time threshold of one another, the computer system forgoes causing the respective operation to be performed (e.g., the computer system causes a second operation to be performed instead of the respective operation). In some embodiments, the predefined time threshold corresponds to a total amount of time for detection of multiple tap inputs. For example, a timer is initiated in response to detecting a first input and only inputs received before the timer reaches the predefined time threshold are considered to be part of the same gesture as the first input. For example, a respective operation may be based on a number of tap inputs detected within the predefined time threshold. For example, when received within the predefined time threshold, one tap may cause a first operation to be performed, two taps may cause a second operation (e.g., distinct from the first operation) to be performed, and three taps may cause a third operation (e.g., distinct from the first operation and the second operation) to be performed. Detecting and responding to sequences of inputs (e.g., tap inputs directed to a housing of the electronic accessory case) may reduce erroneous operation (e.g., reduces operations initiated in response to inadvertent (false positive) inputs).

In some embodiments, the predefined time threshold corresponds to a time between consecutive tap inputs. For example, a timer for the predefined time threshold may be reset in response to detecting each tap in the sequence of consecutive tap inputs. As an example, the predefined time threshold may be 0.1 seconds. In this example, a 1-tap gesture includes a first tap input without further tap inputs received within 0.1 seconds, a 3-tap gesture includes a first tap input, a second tap input received within 0.1 seconds of the first tap input, and a third tap input received within 0.1 seconds of the second tap input. In this example, the 1-tap gesture may cause a first operation to be performed and the 3-tap gesture may cause a second operation (e.g., different than the first operation) to be performed. The three tap inputs of the 3-tap gesture in this example are not required to all be received within a same 0.1 second period.

In some embodiments, the first type of input includes (808) movement of the accessory case (e.g., the shake input 530 in FIG. 5N) and/or an adjustment to an open-close state of the accessory case (e.g., opening or closing the lid 344 of the electronic accessory case 342). In some embodiments, the movement of the accessory case is detected via an IMU. In some embodiments, the movement of the accessory case corresponds to a shake input (e.g., the one or more inputs comprise a shaking input). In some embodiments, the movement of the accessory case corresponds to a tap input (e.g., the tap input causes a least a portion of the accessory case to move at least a threshold amount). As an example, the one or more inputs may include one or more tap inputs and a shake input. In some embodiments, the adjustment to an open-close state of the accessory case comprises opening the accessory case (e.g., opening a lid, a panel, and/or other component of the accessory case). In some embodiments, the adjustment to an open-close state of the accessory case comprises a sequence of opening and closing the accessory case. In some embodiments, the adjustment to an open-close state of the accessory case comprises closing the accessory case (e.g., closing a lid, a panel, and/or other component of the accessory case). Detecting and responding to case movements and/or adjustments to the case lid may reduce the number of inputs needed to initiate respective operations and allows for a case with less physical buttons and touch-screens, thereby allowing the case to be more compact, lower energy, and/or simpler to manufacture.

In some embodiments, the one or more movement sensors are (810) components of the one or more accessories (e.g., the sensors 331). In some embodiments, the one or more movement sensors include one or more inertial measurement units, accelerometers, gyroscopes, and/or magnetometers. In some embodiments, the determination that the one or more inputs are the first type of input is performed at the one or more accessories. In some embodiments, the one or more inputs are detected at the accessory case and at the one or more accessories. For example, a first input may be detected at the accessory case and a second input may be detected at the one or more accessories. As another example, a first input may be detected at both the accessory case and the one or more accessories. For example, the one or more inputs may be detected at both the accessory case and the one or more accessories when the one or more accessories are within the accessory case. In some embodiments, the input is received directly at the accessory case (e.g., a tap input at the exterior of the accessory case) and is transmitted (e.g., transfer of vibrations and/or motion) from the accessory case to the one or more accessories (e.g., via mechanical and/or physical coupling between the accessory case and the one or more accessories). In some embodiments, the one or more inputs are detected via the one or more movement sensors of the one or more accessories, and are processed (e.g., interpreted and/or mapped to one or more functions and/or operations) at the one or more accessories, an accessory case, and/or a companion device (e.g., a smartphone, a tablet, a personal computer, a smart watch, a virtual-reality headset, an augmented-reality headset, an extended-reality headset, a television, a digital media player, a streaming device, a media source and/or other electronic devices configured to pair with the one or more accessories and/or the accessory case). Detecting and responding to inputs at the electronic accessory case using sensors of the electronic accessories allows for a case with less physical buttons and touch-screens, thereby allowing the case to be more compact, lower energy, and/or simpler to manufacture. Moreover, detecting inputs using accessory sensors that are also used other purposes (e.g., determining positioning/orientation of the accessory) allows for a more compact, lower power, and/or simpler case and/or accessory.

In response to detecting the one or more inputs via the one or more movement sensors (812) and in accordance with a determination that the one or more inputs are a first type of input, the computer system causes (814) a respective operation associated with the one or more accessories and/or the accessory case to be performed in response to detecting the one or more inputs. For example, FIGS. 5C-5D illustrate a battery status operation being performed in response to detecting the input 506.

In some embodiments, the respective operation associated with the one or more accessories and/or the accessory case is performed (or, optionally, caused to be performed) in response to detecting the one or more inputs in accordance with a determination (816) that the one or more accessories and/or the accessory case being in a first configuration. For example, FIGS. 5A-5B illustrate the battery status operation not being performed in response to detecting the input 502 (e.g., due to the lid 344 being in an open state), whereas FIGS. 5C-5D illustrate a battery status operation being performed in response to detecting the input 506 (e.g., in accordance with the lid 344 being in a closed state). Detecting and responding to inputs only while in particular configurations (e.g., the first configuration) reduces erroneous operation (e.g., reduces operations initiated in response to inadvertent (false positive) inputs).

In some embodiments, the respective operation is performed in accordance with a determination that the one or more accessories and/or the accessory case being in the first configuration and the one or more inputs being the first type of input. In some embodiments, the one or more inputs are not detected and/or not processed (e.g., ignored) in accordance with a determination that the one or more accessories and/or the accessory case being in a second configuration when the one or more inputs are detected. In some embodiments, a second set of one or more inputs is detected, and in response to detecting the second set of one or more inputs, in accordance with a determination that the one or more accessories and/or the accessory case being in a second configuration, the computer system forgoes determining whether the second set of one or more inputs is the first type of input and/or forgoes causing the respective operation to be performed in response to detecting the second set of one or more inputs.

In some embodiments, configuration criteria include (1) an accessory case in an open state, (2) an accessory case in a closed state. (3) an accessory case in the open state with one or more accessories within the accessory case, (4) an accessory case in a closed state with one or more accessories within the accessory case, (5) an accessory case in the open state with one or more accessories within a threshold distance of the accessory case, and/or (6) an accessory case in the closed state with the one or more accessories within a threshold distance of the accessory case. The configuration criteria optionally further include one or more accessories paired with one or more electronic devices (e.g., a smartphone, a tablet, a personal computer, a smart watch, a virtual-reality headset, an augmented-reality headset, an extended-reality headset, a television, a digital media player, a streaming device, a media source and/or other electronic devices configured to pair with the one or more accessories and/or the accessory case). In some embodiments, a respective configuration is continuously and/or periodically monitored. For example, the respective configuration may be determined prior to detecting the input (which may be detected via the one or more movement sensors and/or other sensors configured to detect input).

In some embodiments, a respective configuration is monitored in response to detecting at least a portion of an input. For example, in response to detecting an input (e.g., the entire input or a portion of the input) via one or more movement sensors, a computer system may monitor a respective configuration of one or more accessories and/or an accessory case. The detected input or portion thereof may include one or more specified types of input (e.g., a tap input, a movement input, a case-adjustment input, and/or other specified types of input) and/or any other inputs (e.g., non-specified types of input). Further, in some embodiments, the respective configuration may be monitored in response to an input not associated with a respective operation. For example, monitoring of the respective configuration may begin when the accessory case is moved (e.g., picked up), where in this example picking up the accessory case is not associated with a respective operation.

In some embodiments, the respective configuration satisfying configuration criteria may be maintained for at least a portion of the respective operation. For example, a respective configuration satisfying configuration criteria may only be required to initiate some respective operations and the respective configuration may be a configuration that does not satisfy the configuration criteria while the respective operation is performed. Further, in some embodiments, a respective configuration satisfying configuration criteria may be maintained for the entire duration of the respective operation. For example, a respective configuration satisfying configuration criteria must be maintained for an entire duration of some respective operations.

In some embodiments, the first configuration includes (818) the accessory case being in an open state (e.g., the lid 344 of the electronic accessory case 342 being in an open state as shown in FIG. 5G). In some embodiments, an open state of an accessory case includes the accessory case being configured so that a user may view, remove, and/or insert the one or more accessories. For example, a first portion of an accessory case (e.g., a lid, panel, or other type of portion) may be moved away (and/or rotated away) from a second portion of the accessory case such that one or more accessories may be inserted, mounted, attached, or otherwise placed within the accessory case. Detecting and responding to particular inputs only while the accessory case is in an open state reduces erroneous operation (e.g., reduces operations initiated in response to inadvertent (false positive) inputs while the accessory case is in the closed state).

In some embodiments, the first configuration includes (820) at least one of the one or more accessories being within the accessory case (e.g., the wearable audio output devices 301 being within the electronic accessory case 342 as shown in FIG. 5C). In some embodiments, the first configuration includes the one or more accessories being attached or mounted to the accessory case. In some embodiments, the first configuration includes the one or more accessories being mechanically and/or electrically coupled with the accessory case. For example, the accessory case may charge the one or more accessories via the electrical coupling. In some embodiments, one or more accessories are considered to be within the accessory case when the accessory case may be closed with the one or more accessories inside and without removal of the one or more accessories (or other movement of the one or more accessories relative to the accessory case). Detecting and responding to particular inputs only while the one or more accessories are in accessory case reduces erroneous operation (e.g., reduces operations initiated in response to inadvertent (false positive) inputs while the accessories are outside of the case). For operations that require the one or more accessories, detecting and responding to the corresponding inputs only while the one or more accessories are in the case reduces unnecessary processing and corresponding power consumption while the accessories are not available for the operations.

In some embodiments, while the respective operation is being performed, the computer system detects (822) a change in configuration of the one or more accessories and/or the accessory case; and, in response to detecting the change in the configuration of the one or more accessories and/or the accessory case, causes the respective operation to cease to be performed. For example, FIGS. 5G-5J illustrate examples of a pairing operation being canceled due to changes in the configuration (e.g., the lid 344 being closed in FIG. 5J). In some embodiments, if the first configuration of one or more accessories and/or accessory case is not maintained for an entire duration of a respective operation, the respective operation is cancelled, reverted, and/or reversed. For example, after the respective operation ceases to be performed, the one or more accessories and/or the accessory case are in a same state as prior to the start of the respective operation. Causing operations to cease to be performed in response to changes in configuration may reduce erroneous operation (e.g., reduces operations initiated in response to inadvertent (false positive) inputs) and provide users a means for canceling unintended and/or undesired operations.

In some embodiments, the respective operation includes outputting (824) information indicative of a battery status of the one or more accessories and/or the accessory case (e.g., the audio output 508 and/or the status indicator 348 illumination shown in FIG. 5D). In some embodiments, the respective operation comprises providing an output indicating the battery status (e.g., via an image component such as an LED or display and/or via an audio component). In some embodiments, the computer system provides feedback based on the battery status. For example, audio, haptic, and/or visual feedback may be provided based on the battery status. In some embodiments, a parameter of the feedback (e.g., a color of visual feedback, a tone of audio feedback, and/or an intensity of haptic feedback) is based on the battery status. For example, a lower intensity feedback is provided for a lower battery charge and a higher intensity feedback is provided with a higher battery charge. In some embodiments, the battery status corresponds to a level of charge of the accessory case and/or a level of charge of the one or more accessories. In some embodiments, the battery status corresponds to whether the accessory case and/or the one or more accessories are currently charging (e.g., via an external power source). Outputting battery status information provides improved feedback about a state of the one or more accessories and/or the accessory case.

In some embodiments, the respective operation includes initiating (826) a pairing operation involving the one or more accessories and/or the accessory case (e.g., FIGS. 5G-5H illustrate a pairing sequence being initiated in response to the input 514). In some embodiments, the pairing operation is between the accessory case and the one or more accessories. In some embodiments, the pairing operation is between the accessory case and/or the one or more accessories and a companion device. For example, the companion device may be a smartphone, a tablet, a personal computer, a smart watch, a virtual-reality headset, an augmented-reality headset, an extended-reality headset, a television, a digital media player, a streaming device, a media source and/or other electronic devices configured to pair with the one or more accessories and/or the accessory case. In some embodiments, the respective operation comprises initiating the pairing operation. In some embodiments, the respective operation comprises establishing an audio path between the one or more accessories and the accessory case. In some embodiments, the respective operation comprises establishing an audio path between the one or more accessories and/or the accessory case and a companion device. In some embodiments, the respective operation comprises communicatively coupling the one or more accessories and/or the accessory case with a companion device. Providing a means for initiating a pairing operation without requiring an interaction with a physical button or touch screen improves the user-device interface (e.g., enables the pairing operation to be initiated without displaying and/or requiring additional controls).

In some embodiments, communicatively coupling a first device and a second device comprises establishing a wired or wireless connection between the first device and the second device. In some embodiments, the first device and the second device are communicatively coupled via a direct connection, while in other embodiments, the first device and the second device are communicatively coupled via one or more communication networks (e.g., a public broadcast network). For example, communicatively coupling the first and second devices may include forming a wireless peer-to-peer connection (e.g., a direct Wi-Fi connection). In some embodiments, communicatively coupling the first device and the second device comprises pairing the first device and the second device (e.g., exchanging information between the first device and the second device that enable the first device and the second device to communicate with each other). In some embodiments, communicatively coupling the first device and the second device comprises forming an audio path between the first device and the second device. In some embodiments, communicatively coupling the first device and the second device comprises establishing one or more wireless connections and/or one or more wired connections between the first device and the second device. In some embodiments, the first and second devices are communicatively coupled using one or more communication protocols (e.g., a Wi-Fi protocol, a Bluetooth protocol, and/or other type of communication protocol). In some embodiments, the first and second devices are communicatively coupled using respective radio components (e.g., the RF circuitry 108).

In some embodiments, initiating a pairing operation involving the one or more accessories and/or the accessory case includes outputting an indication regarding the operation at the one or more accessories, the accessory case and/or the companion device. The indication may include visual, audio, and/or haptic feedback. The indication may be presented at the beginning of the pairing operation, while the pairing operation is ongoing, and/or at the completion of the pairing operation. The indications associated with various portions of the operation may be the same or distinct. For example, the indication at the beginning of the pairing operation may include a slow pulsing of a status indicator, a fast flashing of the status indicator while the pairing operation is ongoing, and a solid illumination of the status indicator when the pairing operation is complete. In another example, the indication may include audio output indicating the state of the operation (e.g., the operation has begun, the operation is ongoing, and/or the operation has completed).

In some embodiments, successfully pairing the one or more accessories and/or the accessory case with a companion device (e.g., a portable multifunction device) includes enabling wireless data communication between the one or more accessories and/or the accessory case with the companion device, such as wireless media playback, data synchronization between the devices, controlling one device from another device (e.g., starting and/or stopping media playback, and/or changing a volume of media playback), and/or other data that may be communicated between the devices.

In some embodiments, the respective operation includes resetting (828) the one or more accessories and/or the accessory case. For example, FIGS. 5M-5O illustrate the electronic accessory case 342 and the wearable audio output devices 301 being factory reset in response to inputs 526 and 530. In some embodiments, the respective operation comprises initiating a reset for the one or more accessories and/or the accessory case. In some embodiments, resetting one or more accessories and/or an accessory case causes the one or more accessories and/or the accessory case to return to a predefined state. In some embodiments, resetting one or more accessories and/or an accessory case causes the one or more accessories and/or the accessory case to return to a factory default state. The factory default state may be the default state set by a manufacturer. For example, a factory default state may be the same state as when a user first turns on one or more accessories and/or an accessory case. In some embodiments, resetting one or more accessories and/or an accessory case causes the one or more accessories and/or the accessory case to power off and then power on. In some embodiments, resetting a device (e.g., the one or more accessories and/or the accessory case) includes adjusting a software and/or firmware state of the device. In some embodiments, resetting the one or more accessories and/or the accessory case includes outputting an indication regarding the resetting operation at the one or more accessories, the accessory case, and/or the companion device. The indication may include visual, audio, and/or haptic feedback. The indication may be presented at the beginning of the resetting operation, while the resetting operation is ongoing, and/or at the completion of the resetting operation. The indication associated with various portions of the operation may be the same or distinct. For example, the indication at the beginning of the resetting operation may include a slow pulsing of a status indicator, a fast flashing of the status indicator while the resetting operation is ongoing, and a solid illumination of the status indicator when the resetting operation is complete. In another example, the indication may include audio output indicating the state of the operation (e.g., the operation has begun, the operation is ongoing, and/or the operation has completed). Providing a means for initiating a reset operation without requiring an interaction with a physical button or touch screen improves the user-device interface (e.g., enables the reset operation to be initiated without displaying and/or requiring additional controls).

In response to detecting the one or more inputs via the one or more movement sensors (812) and in accordance with a determination that the one or more inputs are not the first type of input, the computer system forgoes (830) causing the respective operation to be performed in response to detecting the one or more inputs. For example, FIGS. 5E-5F illustrate no pairing operation being initiated in response to the input 512 (e.g., a tap input, a squeeze input, or another type of input), whereas FIGS. 5G-5H illustrate a pairing operation being initiated in response to the input 514 (e.g., a tap-and-hold input, a squeeze-and-hold input, or other type of input).

In some embodiments, in accordance with a determination that the one or more accessories and/or the accessory case are not in the first configuration, the computer system forgoes (832) causing the respective operation to performed in response to detecting the one or more inputs (e.g., FIGS. 5A-5B illustrate a battery status operation not being performed in response to the input 502). In some embodiments, the computer system forgoes causing the respective operation to be performed in response to detecting the one or more inputs without determining whether the one or more inputs are the first type of input. In some embodiments, the computer system forgoes determining whether the one or more inputs are the first type of input in accordance with a determination that the one or more accessories and/or the accessory case not being in the first configuration. In some embodiments, the computer system detects the one or more inputs (e.g., the sensors are in an active state), but the computer system does not process and/or analyze the one or more inputs in accordance with the determination that the one or more accessories and/or the accessory case are not in the first configuration. Ignoring inputs and/or forgoing responding to inputs while not in particular configurations (e.g., the first configuration) reduces erroneous operation (e.g., reduces operations initiated in response to inadvertent (false positive) inputs).

In some embodiments, one or more second inputs are detected at an accessory case while the one or more accessories and/or the accessory case is not in the first configuration. For example, the one or more inputs may be ignored while the one or more accessories and/or the accessory case is not in the first configuration. In some embodiments, ignoring the one or more inputs includes forgoing causing the respective operation to be performed. For example, when the accessory case is not in a respective configuration (e.g., a lid of the accessory case is not in a required configuration, a power state of the accessory case is not in a required configuration, and/or the accessory state is not in a required orientation), inputs are detected but the computer system does not cause the respective operation to be performed.

In some embodiments, one or more second inputs at the accessory case are detected and cached (or otherwise stored and/or suspended) while the one or more accessories and/or the accessory case are not in the first configuration. For example, a user gesture that includes a plurality of inputs may be partially performed while the one or more accessories and/or the accessory case are not in the first configuration and partially performed while the one or more accessories and/or the accessory case are in the first configuration. In response to a completion of the user gesture (e.g., while the one or more accessories and/or the accessory case are in the first configuration), the computer system may cause the respective operation to be performed.

In some embodiments, in accordance with a determination that a configuration of the one or more accessories and/or the accessory case does not satisfy one or more configuration criteria, the computer system forgoes (834) detecting inputs at the accessory case (e.g., the input 502 is not detected in FIG. 5A). In some embodiments, when one or more accessories and/or an accessory case does not satisfy the one or more configuration criteria, one or more sensors are inactive (e.g., the one or more sensors are disabled and/or data from the one or more sensors is not processed). For example, one or more movement sensors cease to monitor for inputs at the accessory case. For example, the one or more configuration criteria may include a criterion that the accessory case be open and/or a criterion that the one or more accessories be within the accessory case. In this example, when the accessory case is in a closed state and/or the one or more accessories are outside of the accessory case, the one or more movement sensors cease to detect inputs because the one or more accessories and/or the accessory case do not satisfy the one or more configuration criteria. Ignoring inputs and/or forgoing processing inputs while not in particular configurations (e.g., the first configuration) reduces erroneous operation (e.g., reduces operations initiated in response to inadvertent (false positive) inputs) and may allow lower power operation (e.g., by reducing power to the sensors and/or analysis circuitry while not in the particular configurations).

In some embodiments, the respective operation is a first operation, and, in accordance with a determination that the one or more inputs are a second type of input, distinct from the first type of input, the computer system causes (836) a second operation associated with the one or more accessories and/or the accessory case to be performed in response to detecting the second type of input, wherein the second operation is different than the first operation. For example, FIGS. 5C-5D illustrate a battery status operation being performed in response to the input 506 (e.g., a first type of input, such as a tap or squeeze input) and FIGS. 5M-5O illustrate a reset operation being performed in response to the input 526 (e.g., a second type of input, such as a deep press input, a tap-and-hold input, or other type of input). Detecting and responding to different types of inputs with different operations improves functionality of the electronic accessory case without displaying and/or providing additional controls.

In some embodiments, a second type of input is detected by a different type of sensor than a first type of input. For example, the second type of input may be detected by one or more capacitive touch sensors and/or one or more force sensors. As an example, the first type of input may comprise a tap input and the second type of input may comprise a case-adjustment input (e.g., an adjustment to a lid of the case, a panel of the case, a power supply of the case, and/or other component of the case). In some embodiments, the second type of input is detected by the same type of sensor as for the first type of input. In some embodiments, the first input type and the second input type correspond to differing numbers of a repeated input. For example, the first input type may correspond to a 2-tap input gesture and the second input type may correspond to a 3-tap input.

In some embodiments, in accordance with causing the respective operation to be performed, the computer system outputs (838) first feedback at the one or more accessories and/or the accessory case. For example, FIG. 5H illustrates audio output 516 and the status indicator 348 illumination being output in response to detection of the input 514 in FIG. 5G. In some embodiments, the first feedback is provided via one or more components of the one or more accessories, via one or more components of the accessory case, and/or via one or more components of a companion device. In some embodiments, the first feedback comprises a first type of feedback provided by the one or more accessories and a second type of feedback provided by the accessory case. In some embodiments, the first feedback comprises a first type of feedback provided by the one or more accessories and/or the accessory case and a second type of feedback provided by a companion device. Outputting feedback relating to respective operations (e.g., the first feedback) provides improved feedback about the state of the electronic accessory case and/or the one or more electronic accessories.

In some embodiments, outputting the first feedback comprises providing the first feedback to a user. In some embodiments, the first feedback is visual feedback, audio feedback, and/or haptic feedback. In some embodiments, the feedback is output when the respective operation begins. In some embodiments, the first feedback is output while the respective operation is performed. In some embodiments, the first feedback is output when the respective operation is completed. In some embodiments, the first feedback comprises feedback provided in conjunction with initiating the respective operation, second feedback provided in conjunction with performing the respective operation, and/or third feedback provided in conjunction with completing the respective operation. In some embodiments, a parameter of the first feedback varies based on whether the respective operation is being initiated, performed, or completed.

In some embodiments, feedback is output in response to detecting the one or more inputs. For example, second feedback is provided in response to detecting the one or more inputs and second feedback is provided in accordance with causing the respective operation to be performed. In some embodiments, a first type of feedback is provided in response to detecting the one or more inputs and a second type of feedback is provided in accordance with causing the respective operation to be performed.

For example, feedback may be output while an input and/or series of inputs (e.g., a 3-tap input, a tap and hold input, and/or other types inputs) are directed to an accessory case. For example, an audio output (e.g., a beep, a tone, and/or other type of audio output) is optionally produced at the accessory case and/or the one or more accessories at different times when a tap input is received at the accessory case (e.g., each time or a plurality of times when a tap input is received at the accessory case). In another example, while a tap-and-hold gesture is performed at an accessory case, an audio output (e.g., a beep, a tone, and/or other type of audio output) is, optionally, output at the accessory case and/or one or more accessories. For example, the feedback may change in response to additional portions of a gesture being detected (e.g., 3-tap input) and/or over time. For example, for a 3-tap input gesture, a beep with a first tone may be output at the accessory case and/or the one or more accessories in response to a first tap input received at the accessory case, a beep with a second tone (e.g., distinct from the first tone) is, optionally, output for the second tap, and a beep with a third tone (e.g., distinct from the first and/or the second tone) is, optionally, output for the third tap. In another example, while a tap-and-hold gesture is performed at the accessory case, a tone that increases in pitch over time is, optionally, output by the accessory case and/or the one or more accessories.

In some embodiments, the first feedback includes visual feedback provided via one or more light emitting sources (e.g., provided via the status indicator 348). In some embodiments, the visual feedback is provided at a companion device (e.g., the confirmation interface 529 shown in FIG. 5N). In some embodiments, the first feedback comprises visual feedback as well as audio feedback and/or haptic feedback. In some embodiments, one or more parameters of the visual feedback vary as the respective operation is performed. In some embodiments, one or more parameters of the visual feedback vary as subsequent inputs are detected and/or subsequent operations are performed. Outputting visual feedback relating to respective operations provides improved feedback about the state of the electronic accessory case and/or the one or more electronic accessories.

In some embodiments, the first feedback includes haptic feedback (e.g., provided by the tactile output generator(s) 357 of the electronic accessory case 342). In some embodiments, the first feedback comprises haptic feedback as well as audio feedback and/or visual feedback. In some embodiments, different types of haptic feedback are outputted for different operations. The different types of haptic feedback may include different haptic patterns and/or different intensities of the haptic feedback. For example, a first type of haptic feedback includes a first haptic feedback pattern, and a second type of haptic feedback includes a second haptic feedback pattern distinct from the first haptic feedback pattern. In this example, the first haptic feedback pattern may be a sequence of short haptic pulses and the second haptic feedback pattern may be a sequence of long haptic pulses. In another example, the first type of haptic feedback includes a first intensity of haptic feedback, and the second type of haptic feedback includes a second intensity of haptic feedback distinct from the first intensity of haptic feedback (e.g., the second intensity is greater than the first intensity). Outputting haptic feedback relating to respective operations provides improved feedback about the state of the electronic accessory case and/or the one or more electronic accessories (e.g., informing the user of the state of the device(s) without requiring the user to view the device(s)).

In some embodiments, the first feedback includes audio feedback (e.g., the audio output 508 in FIG. 5D). In some embodiments, the first feedback comprises audio feedback as well as haptic feedback and/or visual feedback. In some embodiments, different types of audio feedback (e.g., audio feedback with different volume and/or audio waveform) are outputted for different operations. In some embodiments, the audio feedback is outputted at a speaker of the one or more accessories and/or at a speaker of the accessory case. Outputting audio feedback relating to respective operations provides improved feedback about the state of the electronic accessory case and/or the one or more electronic accessories (e.g., informing the user of the state of the device(s) without requiring the user to view or hold the device(s)).

In some embodiments, the respective operation is a first type of operation, and the first feedback is a first type of feedback. In accordance with a determination that the one or more inputs are a second type of input distinct from the first type of input, the computer system causes (840) a second operation associated with the one or more accessories and/or the accessory case to be performed in response to detecting the second type of input, where the second operation is distinct from the first operation. For example, FIGS. 5G-5H illustrate the audio output 516 being output in response to detecting the input 514 (e.g., a first type of input), whereas FIGS. 5M-5N illustrate the audio output 528 being output in response to detecting the input 526 (e.g., a second type of input). In accordance with causing the second operation to be performed, the computer system outputs second feedback at the one or more accessories and/or the accessory case, where the second feedback is different than the first feedback. In some embodiments, the first feedback and the second feedback comprise different types of feedback. For example, the first feedback may be visual feedback and the second feedback may be audio feedback. In some embodiments, the first feedback and the second feedback comprise a same type of feedback (e.g., with one or more distinct parameters). For example, the first feedback may have a first frequency of audio feedback and the second feedback may have a second frequency of audio feedback. Outputting different types of feedback relating to different operations provides improved feedback about the state of the electronic accessory case and/or the one or more electronic accessories.

In some embodiments, the first feedback comprises first visual feedback at the accessory case (e.g., a first type of illumination by the status indicator 348), the second feedback comprises second visual feedback at the accessory case (e.g., a second type of illumination by the status indicator 348), and the second visual feedback is different than the first visual feedback. In some embodiments, visual feedback includes one or more lights or display regions configured to blink (e.g., at various intensities and/or intervals) and/or configured to change color. In some embodiments, visual feedback is provided at one or more display components (e.g., a display component of the accessory case, the one or more accessories, and/or a companion device). Visual feedback may include one or more display graphics, symbols, short animations, or other visual representations that indicate which operation is being, or has been, performed and/or the state of one or more accessories and/or accessory case. In some embodiments, a first visual feedback ceases to be output in accordance with a determination that a second visual feedback is being outputted. For example, a feedback being output may be replace with different feedback in accordance with a determination that a different operation is being performed. In some embodiments, output of the second visual feedback overrides output of the first visual feedback (e.g., if the second operation is performed before the first visual feedback finishes). As an example, feedback corresponding to an operation may be ceased (e.g., overridden or cut short) in response to detecting a new input and providing feedback corresponding to the new input. Outputting different types of visual feedback relating to different operations provides improved feedback about the state of the electronic accessory case and/or the one or more electronic accessories.

In some embodiments, the one or more inputs are part of an input sequence (842), and the first part of the input sequence is consistent with the first type of input (e.g., the inputs 526 and 530 are part of an input sequence mapped to a factory reset operation). After detecting the first part of the input sequence, the computer system detects a second part of the input sequence that is not consistent with the first type of input (e.g., ceasing to detect the one or more inputs); and, in response to detecting the second part of the input sequence, forgoes performing the respective operation (e.g., the determination that the one or more inputs are not the first type of input includes detecting the first part of the input sequence that is consistent with the first type of input and detecting a second part of the input sequence that is not consistent with the first type of input). In some embodiments, the one or more inputs comprise an input sequence, where the first part of the input sequence is consistent with the first type of input. After the detecting the first part of the input sequence, a second part of the input sequence may be detected. If the second part of the input sequence is not consistent with the first type of input, performing the respective operation may be forgone. Forgoing the respective operation may include not starting (e.g., initiating) the respective operation, cancelling the respective operation while it is in progress, and/or reverting the respective operation if it has completed. For example, the first part of the input sequence may be a tap and hold input and the second part of the input sequence may be a release input (e.g., the tap and hold input is no longer received or detected). In this example, in accordance with a determination that the release input is not consistent with the first type of input (e.g., a tap and hold input) the respective operation is forgone, canceled, and/or reverted. As another example, the first part of the input sequence may include one or more tap inputs, and the respective operation is caused to be performed in accordance with a determination that the first part of the sequence of inputs has been detected and/or received. In this example, if the second part of the input sequence is not consistent with the first type of input, such as receiving no further tap inputs, receiving further tap inputs that do not correspond with a respective operation (e.g., receiving an invalid 4-tap sequence), and/or not receiving further tap inputs within a preset threshold amount of time, the respective operation is forgone, canceled, and/or reverted. In some embodiments, if the second part of the input sequence is not maintained for an entire duration of a respective operation, the respective operation is cancelled, reverted, and/or reversed. For example, after the respective operation ceases to be performed, the one or more accessories and/or the accessory case are in a same state as prior to the start of the respective operation. Causing operations to cease to be performed in response to incomplete input sequences may reduce erroneous operation (e.g., reduces operations initiated in response to inadvertent (false positive) inputs) and provide users a means for canceling unintended and/or undesired operations.

It should be understood that the particular order in which the operations in FIGS. 8A-8C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 900) are also applicable in an analogous manner to method 800 described above with respect to FIGS. 8A-8C. For example, the inputs, operations, and feedback described above with reference to method 800 optionally have one or more of the characteristics of the inputs, operations, and feedback described herein with reference to other methods described herein (e.g., method 900). For brevity, these details are not repeated here.

FIGS. 9A-9B are flow diagrams illustrating method 900 of providing maintenance recommendations for one or more wearable devices in accordance with some embodiments. Method 900 is performed at a computer system (e.g., the wearable audio output devices 301, the electronic accessory case 342, and/or the portable multifunction device 100). For example, the computer system is optionally an accessory case, one or more accessories that are in communication with the accessory case, and/or a device that is configured to receive audio from the one or more accessories. In some embodiments, the computer system includes one or more audio output components (e.g., speakers) and one or more audio input components (e.g., microphones). In some embodiments, the computer system is associated with a set of components (e.g., one or more optical or audio output modules) of one or more wearable devices (e.g., a set of earbuds, a set of earcups of a pair of headphones, or a set of optical modules of a head mounted display). Some operations in method 900 are, optionally, combined and/or the order of some operations is, optionally, changed.

As described below, method 900 provides an improved means of detecting operational states of components of one or more wearable devices and an improved interface for presenting corresponding maintenance alerts. Detecting operational states of the component(s) of the wearable device(s) enables accurate and timely maintenance alerts to be presented to a user, thereby reducing unnecessary user action (e.g., if the user is notified to perform maintenance when it isn't necessary) and improving performance (e.g., as opposed to the user continuing to use the device without performing the maintenance).

The computer system detects (902) an operational state of a respective component (e.g., an operation state that changes based on a state of physical maintenance of a portion of the respective device) of a set of components (e.g., one or more speakers) of one or more wearable devices (e.g., the wearable audio output devices 301 or the single integrated electronic accessory 704). In some embodiments, the one or more wearable devices comprise one or more wearable audio output devices (e.g., earbuds, headset, and/or headphones). For example, the set of wearable devices includes a set of wearable audio output devices and/or other types of wearable devices that may require maintenance. In some embodiments, the one or more wearable devices includes a first wearable device (e.g., a left wearable audio output device) and a second wearable device (e.g., a right wearable audio output device). In some embodiments, the operational state for the first and/or the second component are detected concurrently (e.g., simultaneously). In some embodiments, detecting the operational state of a first component and/or the second component is performed continuously and/or periodically. In some embodiments, the first component is a component of a first wearable device of the one or more wearable devices (e.g., a first earbud) and the second component is a component of a second wearable device of the one or more wearable devices (e.g., a second earbud). In some embodiments, the first component and the second component are components of a same wearable device (e.g., the first component corresponds to a first speaker of the wearable device and the second component corresponds to a second speaker of the wearable device).

In some embodiments, the respective operational states are detected in response to a user donning (e.g., inserting in and/or mounting to the ear) the corresponding wearable device (e.g., as illustrated in FIGS. 7A-7B). In some embodiments, detecting the operational states is performed during normal operation of the set of wearable devices (e.g., during music playback and/or other audio content playback). For example, detecting the operational states may be performed without configuring the one or more wearable devices into a calibration operation mode. In some embodiments, detecting the operational states is performed while the one or more wearable devices are in a case, a dock, and/or other storage device for the one or more wearable devices.

In some embodiments, the operational state of the respective component is detected in response to a user request (e.g., a user request to check functionality of the set of wearable devices). In some embodiments, the operational states are detected in accordance with a determination that a specified amount of time has elapsed since the last time maintenance was performed at the first and/or second wearable devices and/or the operational state was detected at the first and/or second wearable devices.

In some embodiments, a first operational state is detected by the first wearable device (e.g., via one or more sensors of the first wearable device) of the set of wearable devices and a second operational state is detected by the second wearable device (e.g., via one or more sensors of the second wearable device). In some embodiments, in accordance with the determination that the first operational state meets one or more criteria, the alert is generated with an indication that maintenance is recommended for the one or more wearable devices. In some embodiments, in accordance with the determination that the second operational state meets one or more criteria, the alert is generated with an indication that maintenance is recommended for the one or more wearable devices.

In some embodiments, detecting the operational state of the respective component occurs when the respective wearable device is in a predefined configuration, including the one or more wearable devices being worn by a user, or docked and/or stored with a case, a dock and/or other storage solutions. The one or more wearable devices may forgo detecting the operational state of the respective component when not in the predefined configuration.

In some embodiments, detecting the operational state of the respective component includes comparing (904) one or more audio test signals outputted via a respective wearable device of the one or more wearable devices with one or more previously-recorded audio signals. In some embodiments, detecting the operational state of the respective component includes comparing one or more audio test signals outputted via a respective wearable device of the one or more wearable devices with corresponding source audio signals (e.g., the audio properties provided by a media source are compared with corresponding captured audio). In some embodiments, the one or more audio test signals include one or more tones, pulses, and/or other types of audio output. As an example, the one or more audio test signals and the previously-recorded audio signals may be stored as audio data. The audio data may be stored at the one or more wearable devices, a case associated with the one or more wearable devices, a companion device, and/or other devices associated with the one or more wearable devices. The previously-recorded audio signal(s) may include captured audio (e.g., captured by the respective wearable device and/or another device) of previously output audio test signals outputted by the respective wearable device. For example, the respective wearable device may include one or more audio drivers for outputting the one or more audio test signals and may also include one or more microphones for capturing (e.g., recording) the one or more audio test signals outputted by the one or more audio drivers. Comparing detected audio outputs with audio test signals may improve accuracy in identifying when maintenance is required and/or recommended (e.g., as compared to identifying when maintenance is required based on analysis of the detected audio outputs without the corresponding audio test signals).

In some embodiments, determining the operational state of the respective component includes comparing the one or more audio test signals (e.g., captured at the respective wearable device) with one or more recorded audio test signals. In some embodiments, the operational state is determined based on differences between the one or more audio test signals and the one or more recorded audio test signals. For example, the operational state may be considered operational (e.g., no maintenance recommended) in accordance with a determination that the differences meet one or more criteria; and the operational state may be considered maintenance recommended in accordance with the determination that the differences do not meet the one or more criteria. For example, the differences may correspond to differences in volume, differences in pitch, differences in tone, differences in frequency, and/or other types of audio differences.

In some embodiments, the respective component is, or includes, a mesh component (906) configured to reduce foreign matter intrusion into a respective wearable device of the one or more wearable devices (e.g., the component shown being detached from the earbud in FIG. 6K). In some embodiments, the mesh covering is configured to protect an audio driver (e.g., a speaker) from foreign objects (e.g., earwax, dust, hair, and/or other types of foreign objects). In some embodiments, the respective component is, or includes, an eartip (e.g., the eartip 334). In some embodiments, the respective component is, or includes, an earcup (e.g., the earcup 706-1). Providing maintenance alerts for cleaning a mesh enables the user to maintain device performance (e.g., by removing and cleaning the mesh) without the user to possess technical skills and/or knowledge regarding the wearable devices, or requiring the user to have particular tools for disassembling the wearable devices.

In some embodiments, the set of components are (910) components of a same wearable device (e.g., the single integrated electronic accessory 704). For example, the set of components comprise a set of two or more speakers on a same device. In some embodiments, the one or more wearable devices comprise a single wearable device (e.g., a headset, a head-worn device, or other type of wearable device). In some embodiments, a first wearable device includes the first component and the second component, and a second wearable device includes a third component of the set of components and a fourth component of the set of components. In some embodiments, in accordance with a determination that respective operational states of the first and the second components meet the one or more criteria, concurrent alerts are generated for the first and second components. For example, concurrent alerts may be output by the first and second components. In some embodiments, the concurrent alerts are separate alerts. In some embodiments, a single alert identifying both components is generated. In some embodiments, in accordance with a determination that respective operational states of the third and the fourth components meet the one or more criteria, concurrent alerts are generated for the third and fourth components. In some embodiments, the alert indicates a corresponding wearable device and indicates which component of the corresponding wearable device for which maintenance is recommended. In some embodiments, the alert indicates each of the components for which maintenance is recommended (optionally and the corresponding wearable device(s)). Detecting operational states and providing corresponding alerts for different components of a set of components for a same wearable device (e.g., independently) allows for more accurate notifications (e.g., indicating the particular component for which maintenance is recommended and/or required) and enables the user to address only the corresponding components (e.g., rather than all of the components).

In response to detecting the operational state of the respective component (912) and in accordance with a determination that the operational state of a first component meets one or more criteria without a determination that the operational state of a second component meets the one or more criteria, the computer system generates (914) an alert with an indication that maintenance is recommended for the first component (e.g., the maintenance alert 622 in FIG. 6D) without generating an alert with an indication that maintenance is recommended for a second component.

In response to detecting the operational state of the respective component (912) and in accordance with a determination that the operational state of the second component meets the one or more criteria without a determination that the operational state of the first component meets the one or more criteria, the computer system generates (916) the alert with an indication that maintenance is recommended for the second component (e.g., the maintenance alert 628 in FIG. 6E) without generating an alert with an indication that maintenance is recommended for the first component.

In some embodiments, in response to detecting the operational state of the respective component and in accordance with a determination that an operational state of the first component meets the one or more criteria and a determination that an operational state of the second component meets the one or more criteria, the computer system generates (918) the alert with an indication that maintenance is recommended for the first component and the second component (e.g., the maintenance alert 636 in FIG. 6F). In some embodiments, the alert indicates for which components and/or wearable devices maintenance is recommended. For example, the alert may state that the speaker(s) on the left earbud and/or right earbud require cleaning. In some embodiments, in response to detecting the operational state of the respective component, in accordance with a determination that the operational state of the first component does not meet the one or more criteria and a determination that the operational state of the second component does not meet the one or more criteria, forgoing generating the alert. Providing alerts that indicate whether maintenance is recommended and/or required for some or all of the components allows for more accurate notifications (e.g., indicating the particular component(s) for which maintenance is recommended and/or required) and enables the user to address only the corresponding components. Such alerts provide improved feedback about the state of the wearable device(s).

In some embodiments, the alert includes (920) instructions regarding performing maintenance for the respective component (e.g., at least some of the instructions shown in FIGS. 6K-6M). For example, the maintenance instructions may include a step-by-step walkthrough of the maintenance process. For example, the step-by-step walkthrough may include audio instructions, an animation, a video, text-based instructions, and/or other presentations of instructions to the user. As another example, the maintenance instructions may include disassembly, cleaning, assembly, and/or other maintenance instructions. In some embodiments, the alert includes a reference that enables access to a set of maintenance instructions (e.g., a hyperlink, an app code, a QR code, or other type of reference). Providing instructions regarding performing maintenance for the respective component provides improved feedback to the user (e.g., concisely and accurately identifying the issue(s) and how to address them).

In some embodiments, the instructions regarding performing maintenance include instructions for disassembly of one of the one or more wearable devices (e.g., the disassembly user interface 670 and/or the instructions 676). For example, the disassembly instructions may include a step-by-step walkthrough of the disassembly process. For example, the step-by-step walkthrough may include audio instructions, an animation, a video, text-based instructions, and/or other presentations of instructions to the user. In some embodiments, the disassembly instructions regarding of the one or more wearable devices are interactive. For example, the user may tap on one or more components of the respective wearable device to display information regarding disassembly of that component. In some embodiments, the disassembly instructions are accessible regardless of whether maintenance is recommended. For example, the disassembly instructions are published online and the alert includes a link to the online publication. Providing instructions regarding disassembly of the wearable devices provides improved feedback to the user (e.g., concisely and accurately identifying the issue(s) and how to address them) and allows the user to perform the maintenance without requiring additional resources.

In some embodiments, the instructions regarding performing maintenance include instructions for cleaning the respective component (e.g., the cleaning user interface 680 and/or the instructions 686). For example, the instructions for cleaning of the one or more wearable devices may include a step-by-step walkthrough of the cleaning process. For example, the step-by-step walkthrough may include audio instructions, an animation, a video, text-based instructions, and/or other presentations of instructions to the user. In some embodiments, the cleaning instructions are interactive. For example, the user may tap on one or more components of the respective wearable device to display information regarding cleaning that component. In some embodiments, the cleaning instructions are accessible regardless of whether maintenance is recommended. For example, the cleaning instructions are published online and the alert includes a link to the online publication. Providing instructions regarding cleaning the component(s) of the wearable devices provides improved feedback to the user (e.g., concisely and accurately identifying the issue(s) and how to address them) and allows the user to perform the maintenance without requiring additional resources.

In some embodiments, the instructions regarding performing maintenance include instructions for assembling the one or more wearable devices (e.g., the assembly user interface 690 and/or the instructions 696). For example, the instructions for assembling (e.g., re-assembling) the one or more wearable devices may include a step-by-step walkthrough of the assembly process (e.g., for reassembling the device after the device has been at least partially disassembled). For example, the step-by-step walkthrough may include audio instructions, an animation, a video, text-based instructions, and/or other presentations of instructions to the user. In some embodiments, the assembly instructions are interactive. For example, the user may tap on one or more components of the respective wearable device to display information regarding assembling that component. In some embodiments, the assembly instructions are accessible regardless of whether maintenance is recommended. For example, the assembly instructions are published online and the alert includes a link to the online publication. Providing instructions regarding assembly (e.g., re-assembly) of the wearable devices provides improved feedback to the user (e.g., concisely and accurately identifying the issue(s) and how to address them) and allows the user to complete the maintenance without requiring additional resources.

In some embodiments, the computer system outputs (922) the alert at a companion device communicatively coupled to at least one of the one or more wearable devices (e.g., the maintenance recommendation 642 in FIG. 6G). In some embodiments, the companion device is a smart phone, a smart watch, a tablet, a virtual-reality headset, a personal computer, and/or other type of device capable of providing information to a user. In some embodiments, the alert comprises a visual alert, an audio alert, and/or a haptic alert. For example, the alert output at the companion device optionally includes a visual notification, one or more audio outputs, one or more haptic outputs, and/or other types of outputs. In some embodiments, the alert is output at the one or more wearable devices and at the companion device. In some embodiments, the companion device controls and/or is controlled by the one or more wearable devices. For example, the companion device may control the volume or playback state of the media played at the one or more wearable devices. In another example, the one or more wearable devices may control the volume and/or playback state of the media played at the companion device. Outputting the alert at a companion device provides improved feedback about the state of the wearable device(s) (e.g., by utilizing the display and/or compute power of the companion device to provide more detailed and easier to understand alerts).

In some embodiments, outputting the alert at the companion device includes outputting (924) the alert via a settings user interface (e.g., settings user interface 650 in FIG. 6I) of the companion device. In some embodiments, the settings user interface is displayed at a display of the companion device. In some embodiments, a settings user interface is displayed at the companion device and the settings user interface includes the alert. The settings user interface may include various settings and parameters associated with the companion device and/or devices communicatively coupled with the companion device (e.g., settings and parameters associated with the one or more wearable devices). For example, the settings user interface includes various settings and parameters that may be adjusted by a user. Outputting alerts via a settings user interface provides improved feedback about the state of the wearable device(s) (e.g., by providing alerts in an expected and/or intuitive location) and may reduce the number of inputs needed for the user to find and view the alerts.

In some embodiments, outputting the alert via the settings user interface includes (926) displaying an icon corresponding to the alert (e.g., the badge 654 in FIG. 6I). In some embodiments, the icon is a badge showing a number of items that require user attention. For example, when maintenance is recommended for a first wearable device, an icon with the number 1 may be displayed. In another example, when maintenance is recommended for both the first wearable device and the second wearable device, an icon with the number 2 may be displayed. In some embodiments, the icon is displayed in a section with settings associated with the one or more wearable devices. For example, the settings user interface may include a section and/or a selectable affordance associated with the one or more wearable devices. The badge may be displayed with and/or on top of the section and/or selectable affordance. Displaying an icon corresponding to the alert provides improved feedback about the state of the wearable device(s) (e.g., by providing a graphical representation of the alert).

In some embodiments, outputting the alert via the settings user interface includes (928) displaying a selectable element corresponding to the alert (e.g., the notification 652 in FIG. 6I), and, in response to a user selection of the selectable element, causing display of a user interface with settings for the one or more wearable devices (e.g., the electronic accessory settings user interface 660 in FIG. 6J). As an example, the selectable element corresponding to the alert may be displayed separately from a selectable element associated with the one or more wearable devices. The selectable element corresponding to the alert may be grouped with “action item” elements (e.g., the alert may be displayed in an action items section of the user interface). Each action item element may correspond to an item or action that awaits (e.g., requires) user interaction and/or input. Displaying a selectable element corresponding to the alert provides feedback about the state of the wearable device(s) and allows the alert to be viewed without displaying additional controls and/or requiring additional inputs.

In some embodiments, outputting the alert at the companion device includes (930) outputting the alert on a wake screen of the companion device (e.g., the maintenance recommendation 642 in FIG. 6G). In some embodiments, the alert is a notification displayed on a wake screen of a companion device. For example, the notification may indicate the respective component and/or be selectable to display instructions regarding maintenance of the respective component. In some embodiments, the alert is information displayed as a widget on the wake screen. For example, the information displayed in the widget may indicate which respective wearable device requires maintenance. In some embodiments, the alert is displayed as a user interface element overlaid on the wake screen of the companion device or as part of the wake screen. In some embodiments, the alert is presented on a wake screen (e.g., a lock screen) of the companion device if (e.g., in accordance with a determination that) the alert is generated while the companion device is in a sleep mode and/or locked, and the alert is presented in a settings user interface if (e.g., in accordance with a determination that) the alert is generated while the companion device is in an active state and/or unlocked. Outputting alerts via a wake screen provides improved feedback about the state of the wearable device(s) and may reduce the number of inputs needed for the user to view and/or interact with the alerts and/or maintenance information.

In some embodiments, the computer system outputs (932) the alert at the one or more wearable devices (e.g., audio alert 620 in FIG. 6D). For example, the alert may be output at the respective wearable device for which the maintenance is recommendation. As another example, the alert may be output at all of the one or more wearable devices (e.g., irrespective of whether each wearable device has a maintenance recommendation). In some embodiments, the outputted alert comprises a visual, audio, and/or haptic alert. In some embodiments, the outputted alert comprises a set of tones, beeps, and/or pulses. In some embodiments, the outputted alert comprises verbal information including one or more words that indicate the operational state and/or include verbal instructions for performing the recommended maintenance. Outputting alerts via the wearable device(s) enables the alerts to be presented to the user without requiring that the user switch to a second device thereby providing improved feedback about the wearable device(s) and reducing the number of inputs needed to receive the alerts and/or maintenance information.

In some embodiments, the alert is output at the one or more wearable devices in accordance with a determination that (934) the one or more wearable devices are being worn by a user (e.g., based on data from the placement sensors 324). In some embodiments, in accordance with a determination that the one or more wearable devices are not being worn by the user, the computer system forgoes outputting the alert at the one or more wearable devices. In some embodiments, in accordance with the determination that the one or more wearable devices are not being worn by the user, the alert is output by a different device (e.g., a companion device, a case for the one or more wearable devices, and/or another type of device). In some embodiments, the alert information is stored, and the alert is output in accordance with a determination that (e.g., in response to) the one or more wearable devices being worn by the user. For example, the alert is outputted only when at least one of the one or more wearable devices is being worn. Only output alerts at the wearable device(s) while the wearable device(s) are being worn enables more efficient (e.g., lower power) operation of the wearable device(s) (e.g., by reducing a number of generated and/or outputted alerts that would not be received by the user).

In some embodiments, the determination the one or more wearable devices are being worn by the user is based on (936) the one or more wearable devices meeting one or more donning criteria that indicate that the one or more wearable devices have been placed in a respective physical arrangement relative to a respective portion of a body of a person (e.g., that the one or more wearable devices are on, in, over, or near one or more ears and/or eyes of the person). In some embodiments, the one or more donning criteria include a criterion that the one or more wearable devices be removed from a case, dock, and/or other storage device. In some embodiments, the one or more donning criteria include an orientation criterion, a movement criterion (e.g., raised up towards a user's ears and/or head), and/or a proximity criterion (e.g., a proximity sensor indicating that the wearable device(s) are near or inserted in a user's ears). In some embodiments, the determination is based on data from one or more proximity sensors, one or more movement sensors (e.g., one or more IMUs). Only output alerts at the wearable device(s) while the wearable device(s) are being worn in a particular physical arrangement enables more efficient (e.g., lower power) operation of the wearable device(s) (e.g., by reducing a number of generated and/or outputted alerts that would not be received by the user).

It should be understood that the particular order in which the operations in FIGS. 9A-9B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 800) are also applicable in an analogous manner to method 900 described above with respect to FIGS. 9A-9B. For example, the components, user interfaces, and alerts described above with reference to method 900 optionally have one or more of the characteristics of the components, user interfaces, and alerts described herein with reference to other methods described herein (e.g., method 800). For brevity, these details are not repeated here.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at a computer system:
detecting one or more inputs at an accessory case that is in communication with one or more accessories, wherein the one or more inputs are detected via one or more movement sensors; and
in response to detecting the one or more inputs via the one or more movement sensors:
in accordance with a determination that the one or more inputs are a first type of input, causing a respective operation associated with the one or more accessories and/or the accessory case to be performed in response to detecting the one or more inputs; and
in accordance with a determination that the one or more inputs are not the first type of input, forgoing causing the respective operation to be performed in response to detecting the one or more inputs.

2. The method of claim 1, wherein the respective operation associated with the one or more accessories and/or the accessory case is performed in response to detecting the one or more inputs in accordance with a determination that the one or more accessories and/or the accessory case being in a first configuration.

3. The method of claim 2, further comprising:
while the respective operation is being performed, detecting a change in configuration of the one or more accessories and/or the accessory case; and
in response to detecting the change in the configuration of the one or more accessories and/or the accessory case, causing the respective operation to cease to be performed.

4. The method of claim 2, wherein the first configuration includes the accessory case being in an open state.

5. The method of claim 2, wherein the first configuration includes at least one of the one or more accessories being within the accessory case.

6. The method of claim 2, further comprising, in accordance with a determination that the one or more accessories and/or the accessory case are not in the first configuration, forgoing causing the respective operation to performed in response to detecting the one or more inputs.

7. The method of claim 1, further comprising, in accordance with a determination that a configuration of the one or more accessories and/or the accessory case does not satisfy one or more configuration criteria, forgoing detecting inputs at the accessory case.

8. The method of claim 1, wherein the first type of input comprises one or more tap inputs.

9. The method of claim 1, wherein the one or more inputs include a first tap input and a second tap input, and wherein the first type of input comprises two tap inputs detected within a predefined time threshold of one another.

10. The method of claim 1, wherein the first type of input includes:
movement of the accessory case; and/or
an adjustment to an open-close state of the accessory case.

11. The method of claim 1, wherein the one or more movement sensors are components of the one or more accessories.

12. The method of claim 1, wherein the respective operation is a first operation, and the method further comprises:
in accordance with a determination that the one or more inputs are a second type of input, distinct from the first type of input, causing a second operation associated with the one or more accessories and/or the accessory case to be performed in response to detecting the second type of input, wherein the second operation is different than the first operation.

13. The method of claim 1, wherein the respective operation comprises outputting information indicative of a battery status of the one or more accessories and/or the accessory case.

14. The method of claim 1, wherein the respective operation comprises initiating a pairing operation involving the one or more accessories and/or the accessory case.

15. The method of claim 1, wherein the respective operation comprises resetting the one or more accessories and/or the accessory case.

16. The method of claim 1, wherein the accessory case is configured to supply power to the one or more accessories.

17. The method of claim 1, further comprising, in accordance with causing the respective operation to be performed, outputting first feedback at the one or more accessories and/or the accessory case.

18. The method of claim 17, wherein the first feedback comprises visual feedback provided via one or more light emitting sources.

19. The method of claim 17, wherein the respective operation is a first operation, wherein the first feedback is a first type of feedback, and wherein the method further comprises:
in accordance with a determination that the one or more inputs are a second type of input distinct from the first type of input, causing a second operation associated with the one or more accessories and/or the accessory case to be performed in response to detecting the second type of input, wherein the second operation is distinct from the first operation; and
in accordance with causing the second operation to be performed, outputting second feedback at the one or more accessories and/or the accessory case, wherein the second feedback is different than the first feedback.

20. The method of claim 19, wherein the first feedback comprises first visual feedback at the accessory case, and wherein the second feedback comprises second visual feedback at the accessory case, and the second visual feedback is different than the first visual feedback.

21. The method of claim 17, wherein the first feedback comprises haptic feedback.

22. The method of claim 17, wherein the first feedback comprises audio feedback.

23. The method of claim 22, wherein the audio feedback is outputted at a speaker of the one or more accessories and/or at a speaker of the accessory case.

24. The method of claim 1, wherein the one or more inputs are part of an input sequence, and wherein a first part of the input sequence is consistent with the first type of input; and
the method further comprises:
after detecting the first part of the input sequence, detecting a second part of the input sequence that is not consistent with the first type of input; and
in response to detecting the second part of the input sequence, forgoing performing the respective operation.

25. A computer system, comprising:
one or more processors; and
memory storing one or more programs, wherein the one or more programs are configured to be executed by the one or more processors, the one or more programs including instructions for:
detecting one or more inputs at an accessory case that is in communication with one or more accessories, wherein the one or more inputs are detected via one or more movement sensors; and
in response to detecting the one or more inputs via the one or more movement sensors:
in accordance with a determination that the one or more inputs are a first type of input, causing a respective operation associated with the one or more accessories and/or the accessory case to be performed in response to detecting the one or more inputs; and
in accordance with a determination that the one or more inputs are not the first type of input, forgoing causing the respective operation to be performed in response to detecting the one or more inputs.

26. A computer-readable storage medium storing one or more programs, the one or more programs comprising instructions that, when executed by a computer system, cause the computer system to:
detect one or more inputs at an accessory case that is in communication with one or more accessories, wherein the one or more inputs are detected via one or more movement sensors; and
in response to detecting the one or more inputs via the one or more movement sensors:
in accordance with a determination that the one or more inputs are a first type of input, cause a respective operation associated with the one or more accessories and/or the accessory case to be performed in response to detecting the one or more inputs; and
in accordance with a determination that the one or more inputs are not the first type of input, forgo causing the respective operation to be performed in response to detecting the one or more inputs.

27-46. (canceled)
